(19) United States
(12) Patent Application Publication
(10) Pub. No.: US 2023/0305709 A1
(43) Pub. Date: Sep. 28, 2023

(54) FACILITATING IMPROVED USE OF STOCHASTIC ASSOCIATIVE MEMORY

(71) Applicant: Intel Corporation, Santa Clara, CA (US)

(72) Inventors: Dipanjan Sengupta, Hillsboro, OR (US); Mariano Tepper, Portland, OR (US); Sourabh Dongaonkar, Portland, OR (US); Chetan Chauhan, Folsom, CA (US); Jawad Khan, Portland, OR (US); Theodore Willke, Portland, OR (US); Richard Coulson, Portland, OR (US)

(21) Appl. No.: 18/040,145

(22) PCT Filed: Sep. 15, 2020
(86) PCT No.: PCT/US2020/050928

§ 371 Date: Jan. 31, 2023

(51) Int. Cl. G06F 3/06

(52) U.S. Cl. CPC G06F 3/0611; G06F 3/0673; G06F 3/0659

(57) ABSTRACT

Methods, apparatus, systems, and articles of manufacture are disclosed to facilitate improved use of stochastic associative memory. Example instructions cause at least one processor to: generate a hash code for data to be stored in a stochastic associative memory (SAM); compare the hash code with centroids of clusters of data stored in the SAM; select a first one of the clusters corresponding to a first one of the centroids that is closest to the hash code; determine whether a selected number of hash codes stored in the SAM exceeds a threshold; in response to the selected number exceeding the threshold: query a controller for sizes of the clusters; and determine, based on the query, that a second one of the clusters includes an unbalanced size; and select a third one of the clusters to associate with a second number of hash codes corresponding to the second one of the clusters.

### FIELD OF THE DISCLOSURE

This disclosure relates generally to computational memory, and, more particularly, to facilitating improved use of stochastic associative memory.

### BACKGROUND

Content-based similarity search, or simply similarity search, is a key technique that underpins machine learning (ML) and artificial intelligence (AI) applications. In performing a similarity search, e.g., similarity search in a database of high-dimensional vectors and a query vector of the same dimension, query data, such as data indicative of an object (e.g., an image) is used to search the database to identify other data indicative of similar objects (e.g., similar images). Memory devices often provide access to memory using matrix operations. Memory matrix operations have multiple applications in various settings, such as in the fields of AI and ML. In such operations, a device may manipulate data in rows and columns.

### BRIEF DESCRIPTION OF THE DRAWINGS

FIG. 1 is a block diagram of an example compute device for performing similarity search acceleration using column-read enabled memory.

FIG. 2 is a schematic illustration depicting the example memory media of FIG. 1.

FIG. 3 is a schematic illustration depicting an example dual in-line memory module (DIMM) implemented in the compute device of FIG. 1.

FIG. 4 illustrates an example stochastic associative search.

FIG. 5 is a diagram illustrating a random sparse lifting (RSL) data and control flow similarity search pipeline that may be implemented using the memory media of the compute device of FIG. 1.

FIG. 6 is a diagram of an algorithmic pipeline for random sparse lifting (RSL) and a mathematical equation for performing RSL that may be implemented using the compute device of FIG. 1.

FIG. 7 is a diagram of a hardware mapping of stages of the RSL pipeline of FIG. 6.

FIG. 8 is a block diagram of a first example implementation of the memory management controller of FIG. 1.

FIG. 9 is a block diagram of a second example implementation of the memory management controller of FIG. 1

FIG. 10 is a block diagram of an example implementation of the memory controller of FIG. 1.

FIG. 11 is a diagram of a random sparse lifting (RSL) data and control flow similarity search pipeline with clustering that may be implemented using the memory of the compute device of FIG. 1.

FIG. 12 is a diagram illustrating a random sparse lifting (RSL) data and control flow similarity search pipeline with clustering and cluster balancing that may be implemented using the memory of the compute device of FIG. 1.

FIG. 13 is a flowchart representative of machine-readable instructions which may be executed to implement the memory management controller of FIGS. 1 and/or 8 to execute read and/or write instructions from the processor of FIG. 1.

FIG. 14 is a flowchart representative of machine-readable instructions which may be executed to implement the memory management controller of FIGS. 1 and/or 8 to execute read and/or write instructions from the processor of FIG. 1.

FIG. 15 is a flowchart representative of machine-readable instructions which may be executed to implement the memory controller of FIGS. 1 and/or 10 to execute a query request.

FIG. 16 is a flowchart representative of machine-readable instructions which may be executed to implement the memory management controller of FIGS. 1 and/or 9 to store data in the memory media of FIG. 1 with clustering.

FIG. 17 is a flowchart representative of machine-readable instructions which may be executed to implement the memory management controller of FIGS. 1 and/or 9 to search for data in the memory media of FIG. 1 with clustering.

FIG. 18 is a flowchart representative of machine-readable instructions which may be executed to implement the memory management controller of FIGS. 1 and/or 9 to re-balance the memory media of FIG. 1.

FIG. 19 is a flowchart representative of machine-readable instructions which may be executed to implement the memory management controller of FIGS. 1 and/or 9 to re-balance an unbalanced cluster in the memory media of FIG. 1.

FIG. 20 is a flowchart representative of machine-readable instructions which may be executed to implement the memory management controller of FIGS. 1 and/or 9 to re-balance the memory media of FIG. 1.

FIG. 21 is a flowchart representative of machine-readable instructions which may be executed to implement the memory controller of FIGS. 1 and/or 10 to store data in the memory media of FIG. 1.

FIG. 22 is a flowchart representative of machine-readable instructions which may be executed to implement the memory controller of FIGS. 1 and/or 10 to handle hash code comparisons offloaded from the memory management controller.

FIG. 23 is a block diagram of an example processor platform structured to execute the instructions of FIGS. 13, 14, 15, 16, 17, 18, 19, and/or 20 to implement the example memory management controller of FIG. 1, the example memory management controller of FIG. 8, and/or the example memory management controller of FIG. 9.

FIG. 24 is a block diagram of an example processor platform structured to execute the instructions of FIGS. 21 and/or 22 to implement the example memory controller of FIGS. 1 and/or 10.

FIG. 25 is a block diagram of an example software distribution platform to distribute software (e.g., software corresponding to the example computer readable instructions of FIGS. 13, 14, 15, 16, 17, 18, 19, and/or 20) to client devices associated with third parties such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

FIG. 26 is a block diagram of an example software distribution platform to distribute software 4, e.g., software corresponding to the example computer readable instructions of FIGS. 21 and/or 22) to client devices associated with third parties such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers)

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real-world imperfections. As used herein “substantially real time” refers to occurrence in a near instantaneous manner recognizing there may be real world delays for computing time, transmission, etc. Thus, unless otherwise specified, “substantially real time” refers to real time +/−1 second, for example.

### DETAILED DESCRIPTION

Memory devices that facilitate similarity searches conventionally allow for row addressable (e.g., row-wise) data manipulation (e.g., searches and/or indexing) or column addressable (e.g., column-wise) data manipulation. Such memory devices keep two sets of data, one normal and the other transposed and when the normal dataset is updated, the entire transposed copy needs to be updated, which is extremely cumbersome. To handle the size of such datasets and similarity searches on such datasets, the memory devices are partitioned (e.g., clustered). However, conventional techniques to partition such datasets are computationally costly and burdensome on computing system performance. Moreover, these attempts require expensive hardware to accelerate the clustering-related operations.

Additionally, such attempts to partition large-scale databases to accelerate similarity search do not constrain the size of the clusters. As such, these techniques result in clusters that are unbalanced in size (e.g., amount of data allocated to each cluster). For example, clusters partitioned by conventional techniques are not advantageous for most real-life use-cases. These techniques suffer from performance slowdowns when accessing large clusters. Because of the nature of similarity search, queries of databases clustered by conventional techniques are more likely to access larger clusters than smaller ones. Thus, conventional techniques severely affect system latency.

Examples disclosed herein include memory cells that can be accessed by rows and/or by columns. As such, examples disclosed herein facilitate vastly improved algorithms for databases, similarity search, and genomics, among others. An example column access disclosed herein facilitates new algorithms that access 1/1000^{th} of the data as those using conventional memory (e.g., conventional dynamic random-access memory (DRAM)). Thus, examples disclosed herein improve the performance of computing devices by an order of magnitude over conventional techniques,

Additionally, examples disclosed herein do not require two sets of data (e.g., one normal and the other transposed) thus improving memory capacity by two times and reducing latency of memory related operations. Examples disclosed herein accelerate clustering-related operations and introduce new algorithms that work in conjunction with a stochastic associative memory to accelerate both indexing and searching in a database.

Examples disclosed herein control the latency of a computing system and ensure a consistent performance across different queries, Because the query performance of stochastic associative memory-related operations depends linearly on the size of the clusters, examples disclosed herein ensure that no cluster in a database exceeds a prescribed size, ensuring a consistently fast latency. Examples disclosed herein accelerate similarity search systems and ensure that latency does not drop below a pre-specified level, For example, the pre-specified level is a configurable parameter by a database administrator. Examples disclosed herein optimize the amount data being transferred from memory to the host, enabling state-of-the-art performance (e.g., 10-100 of thousands of queries per second).

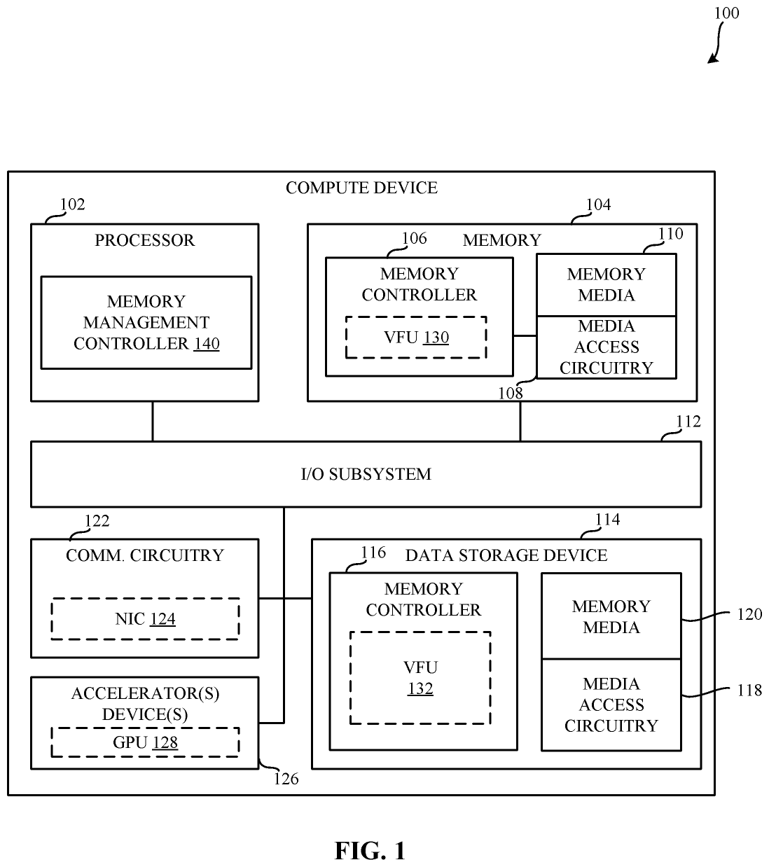

FIG. 1 is a block diagram of an example compute device 100 for performing similarity search acceleration using column-read enabled memory. The example compute device 100 includes an example processor 102, an example memory 104, an example input/output (I/O) subsystem 112, an example data storage device 114, example communication circuitry 122, and example one or more accelerator devices 126. The memory 104 of FIG. 1 includes an example memory controller 106, example media access circuitry 108. and example memory media 110. In some examples, the memory controller 106 of the memory 104 includes an example vector function unit (VFU) 130. The data storage device 114 includes an example memory controller 116, example media access circuitry 118, and example memory media 120. In some examples, the memory controller 116 includes an example VFU 132. In some examples, the communication circuitry 122 includes an example network interface controller (NIC) 124. In some examples, one or more of the one or more accelerator devices 126 include an example graphics processing unit (GPU) 128. In the example of FIG. 1, the processor 102 includes an example memory management controller 140.

In other examples disclosed herein, the compute device 100 may include other and/or additional components. In some examples, the compute device 100 is in communication with components such as those commonly found in association with a computer (e.g., a display, peripheral devices, etc.). The term “memory,” as used herein in reference to performing similarity search acceleration, may refer to the memory 104 and/or the data storage device 114, unless otherwise specified. As explained in more detail herein, media access circuitry 108, 118 (e.g., any circuitry or device configured to access and operate on data in the corresponding memory media 110, 120) connected to a corresponding memory media 110, 120 (e.g., any device or material that data is written to and read from) may access (e.g., read) individual columns (e.g., bits) of vectors for use in performing similarity searches, also referred to as “stochastic associative searches” (SAS). As such, the memory 104 operates as a “stochastic associative memory” (e.g., is designed to enable the efficient performance of stochastic associative searches). As a stochastic associative memory, the memory 104 allows both row and column-wise reads with similar read latency. Additionally, the memory 104 allows for highly efficient and fast searching through a very large database of records and finding similar records to a given query key (e.g., a query record).

In the illustrated example of FIG. 1, the memory media 110 of the example of FIG. 1 includes a three dimensional (3D) cross point architecture that has data access characteristics that differ from other memory architectures (e.g., dynamic random access memory (DRAM)), such as enabling access to one bit per tile and incurring little to no time delays between reads or writes to the same partition or other partitions. In operation, the example media access circuitry 108 is configured to make efficient use (e.g., in terms of power usage and speed) of the architecture of the memory media 110, such as by accessing multiple tiles in parallel within a given partition. In some examples disclosed herein, the media access circuitry 108 may utilize scratch pads (e.g., relatively small, low latency memory) to temporarily retain and operate on data read from the memory media 110 and broadcast data read from one partition to other portions of the memory 104 to enable calculations (e.g., matrix operations) to be performed in parallel within the memory 104. Additionally, in the example of FIG. 1, instead of sending read or write requests to the memory 104 to access matrix data, the processor 102 and/or the memory management controller 140 may send a higher-level request (e.g., a request for a macro operation, such as a request to return a set of N search results based on a search key). As such, many compute operations, such as stochastic associative searches can be performed in memory (e.g., in the memory 104 or in the data storage device 114), with minimal usage of the bus (e.g., the I/O subsystem 112) to transfer data between components of the compute device 100 (e.g., between the memory 104, data storage device 114, the processor 102, and/or the memory management controller 140).

In some examples, the media access circuitry 108 is included in the same die as the memory media 110. In other examples, the media access circuitry 108 is on a separate die but in the same package as the memory media 110. In yet other examples, the media access circuitry 108 is in a separate die and separate package but on the same dual in-line memory module (DIMM) or board as the memory media 110.

The processor 102 may be implemented as any device or circuitry (e.g., a multi-core processor(s), a microcontroller, and/or other processor or processing/controlling circuit) capable of performing operations described herein, such as executing an application (e.g., an artificial intelligence related application that may utilize stochastic associative searches). In some examples disclosed herein, the processor 102 may be implemented as, be coupled to, or include a field-programmable gate array (FPGA), an application specific integrated circuit (ASIC), reconfigurable hardware or hardware circuitry, or other specialized hardware to facilitate performance of the functions described herein. Additionally, the memory management controller 140 may be implemented as any device or circuitry (e.g., a multi-core processor(s), a microcontroller, and/or other processor or processing/controller circuit) capable of performing operations described herein.

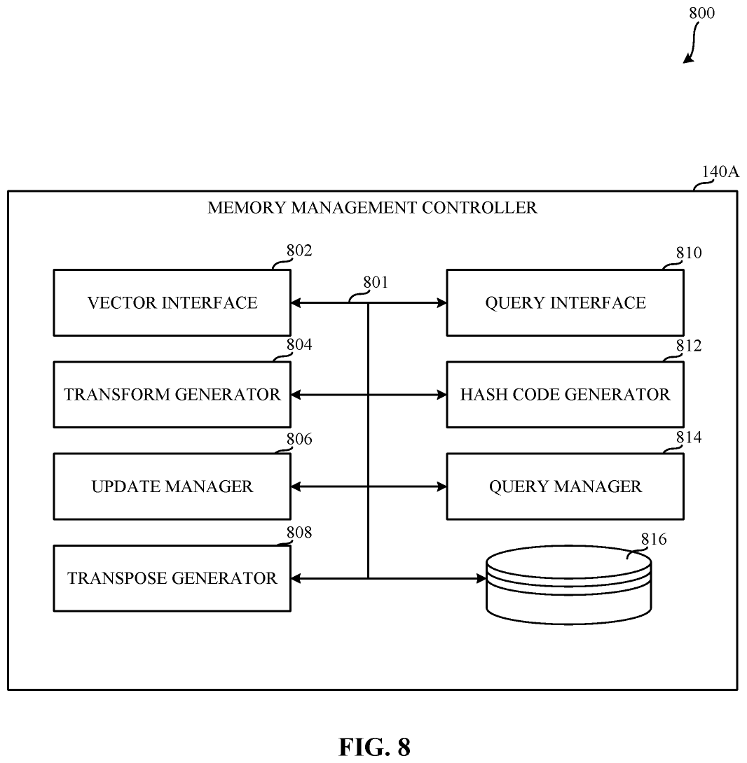

For example, in a first implementation, the memory management controller 140 facilitates efficient searches of a stochastic associative memory (e.g., the memory media 110). In examples disclosed herein, the first implementation of the memory management controller 140, in response to obtaining a database vector, processes the database vector using a stored sparse projection matrix. In this manner, the first implementation of the memory management controller 140 enables efficient updates, additions, deletions, modifications, etc., of a stochastic associative memory in a row-wise and/or a column-wise manner. Additional description of the first implementation of the memory management controller 140 is described below, in connection with FIG. 8.

In a second implementation, the memory management controller 140 manages indexing data into and/or querying of data in the memory 104 and/or the data storage device 114. In examples disclosed herein, the memory management controller 140 performs searches (e.g., queries) in Hamming space with binary codes. Additionally, the second implementation of the memory management controller 140 clusters memory (e.g., the memory 104, the data storage device 114) and simultaneously computes cluster representatives (e.g., centroids) in Hamming space. Additionally, the second implementation of the memory management controller 140 maintains balanced clusters in memory (e.g., the memory 104, the data storage device 114) by re-balancing clusters in memory when needed. For example, the second implementation of the memory management controller 140 bounds the binary hash codes in memory (e.g., the memory 104, the data storage device 114) within respective clusters, utilizing re-balancing methods and algorithms, where each cluster includes equal and/or approximately equal (e.g., within a threshold) numbers of binary hash codes. In examples described herein, bounding binary hash codes in memory (e.g., the memory 104, the data storage device 114) is defined as limiting the size of clusters by removing binary hash codes from oversized and/or unbalanced clusters and assigning them to a different cluster, otherwise bounding the binary hash codes in a particular cluster space in memory (e.g., the memory 104, the data storage device 114).

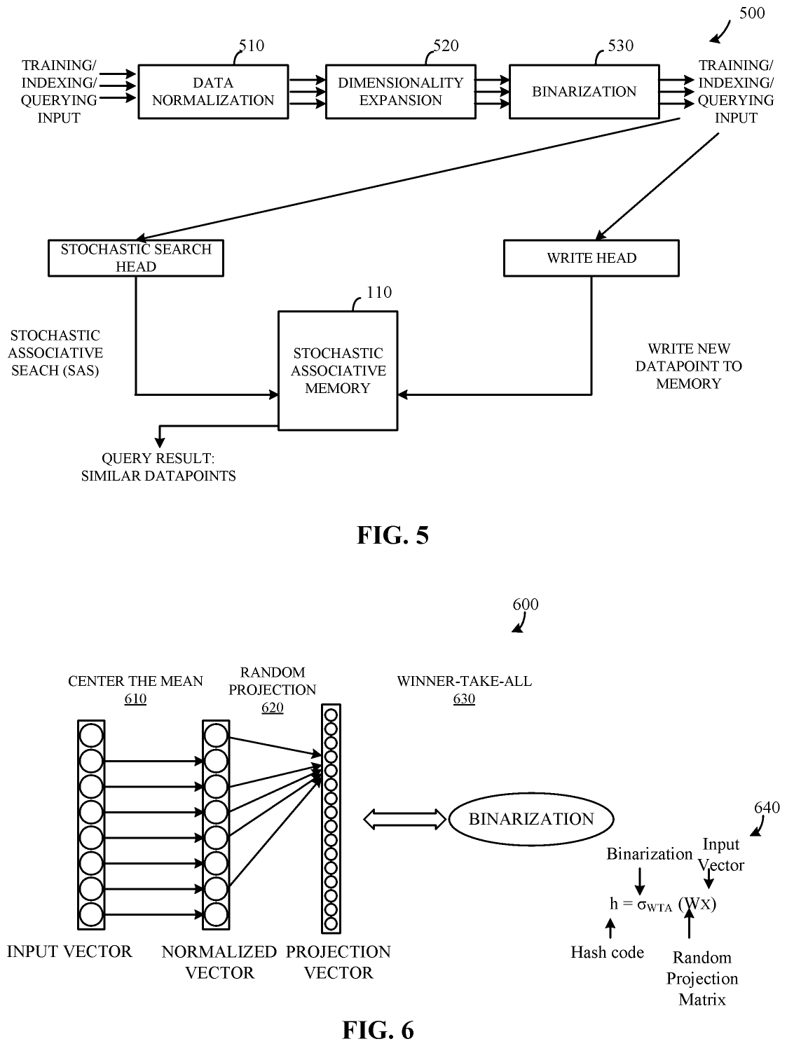

In examples disclosed herein, the memory (e.g., the memory 104, the data storage device 114, etc.) includes hash codes to be clustered. However, examples disclosed herein are not limited thereto. For example, the second implementation of the memory management controller 140 can add data to the clusters a posteriori. The example hash codes are generated either with RSL and/or Procrustean orthogonal sparse hashing (POSH). Additional detail of the memory management controller 140 is discussed in connection with at least FIGS. 5, 6, 7, 8, 9, 11, 12, 13, 14, 15, 16, 17, 18, 19, and 20.

The memory 104, which may include a non-volatile memory (e.g., a far memory in a two-level memory scheme), includes the memory media 110 and the media access circuitry 108 (e.g., a device or circuitry, such as a processor, application specific integrated circuitry (ASIC), or other integrated circuitry constructed from complementary metal-oxide- semiconductors (CMOS) or other materials) underneath (e.g., at a lower location) and coupled to the memory media 110. The media access circuitry 108 is also connected to the memory controller 106, which may be implemented as any device or circuitry (e.g., a processor, a co-processor, dedicated circuitry, etc.) configured to selectively read from and/or write to the memory media 110 in response to corresponding requests (e.g., from the processor 102 and/or the memory management controller 140 which may be executing an artificial intelligence related application that uses stochastic associative searches to recognize objects, make inferences, and/or perform related. computational operations). As described above, in some examples disclosed herein, the memory controller 106 may include the example VFU 130 Which may be implemented as any device or circuitry (e.g., dedicated circuitry, reconfigurable circuitry, ASIC, FPGA, etc.) capable of offloading vector-based tasks from the processor 102 (e.g., comparing data read from specific columns of vectors stored in the memory media 110, determining Hamming distances between the vectors stored in the memory media 110 and a search key, sorting the vectors according to their Hamming distances, etc.).

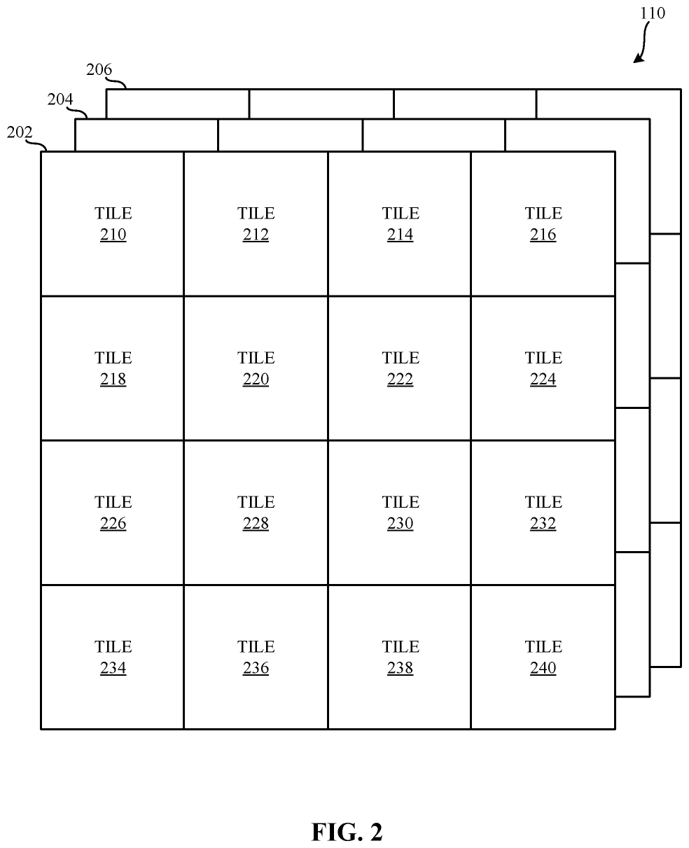

Referring briefly to the illustrated example of FIG. 2, the memory media 110 of FIG. 2 includes a tile architecture, also referred to herein as a cross point architecture (e.g., an architecture in which memory cells sit at the intersection of word lines and bit lines and are individually addressable and in which bit storage is based on a change in bulk resistance), in which each memory cell (e.g., tile) 210, 212, 214, 216, 218, 220, 222, 224, 226, 228, 230, 232, 234, 236, 238, 240 is addressable by an x parameter and a y parameter (e.g., a column and a row). The memory media 110 includes multiple partitions, each of which includes the tile architecture. The partitions may be stacked as layers 202, 204, 206 to form a three-dimensional cross point architecture (e.g., INTEL® 3D XPOINT™ memory, INTEL® OPTANIE™ memory). Unlike conventional memory devices, in which only fixed-size multiple-bit data structures (e.g., byte, words, etc.) are addressable, the media access circuitry 108 is configured to read individual bits, or other units of data, from the memory media 110 at the request of the memory controller 106, which may produce the request in response to receiving a corresponding request from the processor 102. The example description of FIG. 2 similarly applies to the memory media 120.

Referring back to the illustrated example of FIG. 1, the memory 104 may include non-volatile memory and volatile memory. The non-volatile memory may be implemented as any type of data storage capable of storing data in a persistent manner (e.g., a memory capable of storing data even if power is interrupted to the non-volatile memory). For example, the non-volatile memory may be implemented as one or more non-volatile memory devices. The non-volatile memory devices may include one or more memory devices configured in a cross point architecture that enables bit-level addressability (e.g., the ability to read from anchor write to individual bits of data, rather than bytes or other larger units of data), and are illustratively embodied as 3D cross point memory. In some examples disclosed herein, the non-volatile memory may additionally include other types of memory, including any combination of memory devices that use chalcogenide phase change material (e.g., chalcogenide glass), ferroelectric transistor random-access memory (FeTRAM), nanowire-based non-volatile memory, phase change memory (PCM), memory that incorporates memristor technology, Magnetoresistive random-access memory (MRAM) or Spin Transfer Torque (STT)-MRAM. The volatile memory may be implemented as any type of data storage capable of storing data while power is supplied to the volatile memory. For example, the volatile memory may be implemented as one or more volatile memory devices, and is periodically referred to hereinafter as volatile memory with the understanding that the volatile memory may be embodied as other types of non-persistent data storage in other embodiments. The volatile memory may have an architecture that enables bit- level addressability, similar to the architecture described above.

In the illustrated example of FIG. 1, processor 102 and the memory 104 are communicatively coupled to other components of the compute device 100 via the I/O subsystem 112, which may be implemented as circuitry and/or components to facilitate input/output operations with the processor 102 and/or the memory 104 and other components of the compute device 100. For example, the I/O subsystem 112 may be implemented by and/or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples disclosed herein, the 110 subsystem 112 may form a portion of a system-on-a-chip (SoC) and be incorporated, along with one or more of the processor 102, the memory 104, and other components of the compute device 100, in a single chip.

In the illustrated example of FIG. 1, the data storage device 114 may be implemented as any type of device configured for short-term or long-term storage of data such as, for example, memory devices and circuits, memory cards, hard disk drives, solid-state drives, or other data storage device. In the illustrative example of FIG. 1, the data storage device 114 includes a memory controller 116, similar to the memory controller 106, memory media 120 (also referred to as “storage media”), similar to the memory media 110, and media access circuitry 118, similar to the media access circuitry 108. Further, as described above, the memory controller 116 may also include the example VFU 132 similar to the VFU 130. The data storage device 114 may include a system partition that stores data and/or firmware code for the data storage device 114 and/or one or more operating system partitions that store data files and/or executables for operating systems.

In the illustrated example of FIG. 1, the communication circuitry 122 may be implemented as any communication circuit, device, or collection thereof, capable of enabling communications over a network between the compute device 100 and another device. The communication circuitry 122 may be configured to use any one or more communication technology (e.g., wired or wireless communications) and associated protocols (e.g., Ethernet, Bluetooth®, WiFi®, WiMAX, etc.) to affect such communication.

In some examples, as described above, the illustrative communication circuitry 122 includes the example NIC 124, which may also be referred to as a host fabric interface (HFI). The NIC 124 may be implemented as one or more add-in-boards, daughter cards, network interface cards, controller chips, chipsets, or other devices that may be used by the compute device 100 to connect with another compute device. In some examples, the NIC 124 may be embodied as part of a system-on-a-chip (SoC) that includes one or more processors or included on a multichip package that also contains one or more processors. In some examples disclosed herein, the NIC 124 may include a local processor (not shown) and/or a local memory (not shown) that are both local to the NIC 124. In such examples, the local processor of the NIC 124 may perform one or more of the functions of the processor 102. Additionally or alternatively, in such examples, the local memory of the NIC 124 may be integrated into one or more components of the compute device 100 at the board level, socket level, chip level, and/or other levels. The one or more accelerator devices 126 may be embodied as any device(s) or circuitry capable of performing a set of operations faster than the general-purpose processor 102. For example, as described above, the accelerator device(s) 126 may include the example GPU 128, which may be implemented as any device or circuitry (e.g., a co-processor, an ASIC, reconfigurable circuitry, etc.) capable of performing graphics operations (e.g., matrix operations) faster than the processor 102.

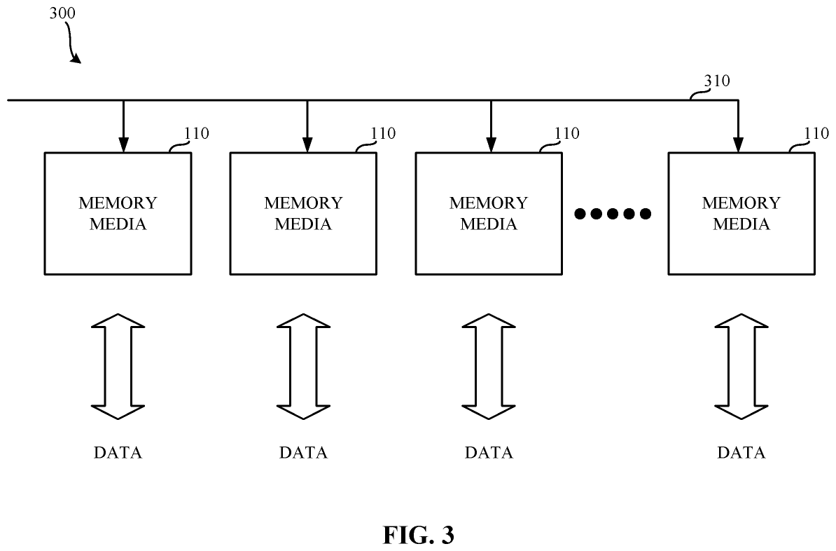

FIG. 3 is a schematic illustration depicting an example dual in-line memory module (DIMM) 300 implemented in the compute device 100 of FIG. 1. The compute device 100, in some examples, may utilize the DIMM architecture 300. In the architecture 300, multiple dies of the memory media 110 are connected with a shared command address bus 310. As such, in operation, data is read out in parallel across all of the memory media 110 connected to the shared command address bus 310. Data may be laid out across the memory media 110 in a configuration to allow reading the same column across all of the connected dies of the memory media 110.

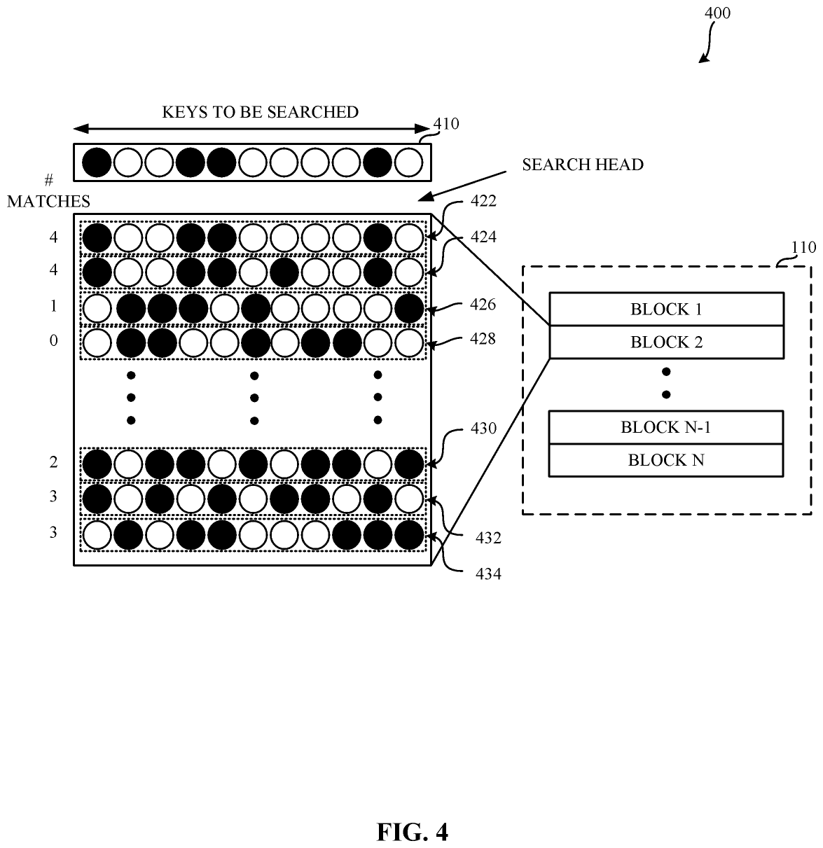

FIG. 4 illustrates an example stochastic associative search 400. In the illustrated example of FIG. 4, the processor 102 (e.g., the memory management controller 140) may perform a stochastic associative search 400 to facilitate efficient searching through a large database of records and finding similar records to a given query record (key). in the example of FIG. 4, the stochastic associative search 400 and other processes are described herein as being performed in the memory 104 (e.g., performing a stochastic associative search of the memory 104). However, it should be understood that the processes could alternatively or additionally be performed in the data storage device 114 (e.g., performing a stochastic associative search of the data storage device 114), depending on the particular implementation. Given that the memory media 110 allows both row and column-wise reads with similar read latency, the memory media 110 is particularly suited to enabling efficient stochastic associative searches. As described in more detail herein, to utilize the characteristics of the memory media 110 to perform efficient (e.g., accelerated, using less power and time than would otherwise be consumed) stochastic associative searches, the processor 102 (e.g., the memory management controller 140) writes database elements (e.g., records, vectors, rows, etc.) to the memory media 110 in binary format (e.g., ones and zeros) as hash codes (e.g., sequences of values produced by a hashing function), that are sparse (e.g., have more zeros than ones). Subsequently, in performing a search, individual binary values of an example search key 410 are compared to the corresponding binary values in the database elements (e.g., vectors) 422, 424, 426, 428, 430, 432, 434 stored in the blocks of the memory media 110. The memory controller 106 determines the number of matching binary values between the search key 410 and each database element (e.g., vector), which is representative of a Hamming distance between the search key 410 and each database element (e.g., vector). The database elements (e.g., vectors) having the greatest number of matches (e.g., lowest Hamming distance) are the most similar results (e.g., the result set) for the stochastic associative search 400.

In an example operation, the processor 102 (e.g., the memory management controller 140) stores elements in the memory media 110 as binary vectors using row write operations, For a given stochastic associative search, the processor 102 (e.g., the memory management controller 140) formats a search query using a hash encoding that matches the hash encoding used to produce the binary format of the vectors in the database. In at least some examples disclosed herein in which the VFU 130 is not present, the processor 102 (e.g., the memory management controller 140) sends a block column read request to the memory controller 106 to read specified columns (e.g., the columns corresponding to the set bits (bits having a value of one) in search key 410). The processor 102 (e.g., the memory management controller 140) subsequently ranks the top matching rows (e.g., vectors) based on the number of set bits matching for the column data that was read. The processor 102 (e.g., the memory management controller 140) subsequently identifies N similar rows for the application requesting the search results, where N is a pre-defined and configurable value.

In at least some examples disclosed herein in which the VFU 130 is present, an example operation may proceed as follows. The processor 102 (e.g., the memory management controller 140) may send an instruction to the memory controller 106 to perform a macro operation (e.g., return top N results based on a given search key 410). Subsequently, the memory controller 106 sends a block column read request to the media access circuitry 108 to read, from the memory media 110, the columns corresponding to the set bits in the search key 410, The VFU 130 in the memory controller 106 subsequently ranks and sorts the N matching rows (e.g., vectors) based on the number of set bits matching the column data that was read, and the memory controller 106 subsequently sends, to the processor 102, data indicative of the top N matching rows (e.g., vectors) as the search results.

FIG. 5 is a diagram illustrating a random sparse lifting (RSL) data and control flow similarity search pipeline 500 that may be implemented by the processor 102 and/or the memory management controller 140 of the compute device 100 of FIG. 1. For example, the processor 102 and/or the memory management controller 140 may execute the RSL data and control flow similarity search pipeline 500 to per-form one or more searches of the memory media 110 and/or the memory media 120. FIG. 6 is a diagram of an example algorithmic pipeline 600 for random sparse lifting (RSL) and an example mathematical equation 640 for performing RSL that may be implemented using the compute device 100 of FIG. 1. For example, the algorithmic pipeline 600 for RSL and/or the mathematical equation 640 for performing RSL may be implemented by the processor 102 and/or the memory management controller 140.

As used herein, RSL refers to a similarity search algorithm (e.g., an algorithm that finds a subset of objects that are similar to a given query from a specific dataset) that increases the dimension of input data rather than decrease and/or reduce the dimension of input data. The RSL similarity search algorithm described herein is based on biological evidence from a fruit fly's olfactory circuit whose function is to associate odors with similar tags. For example, each odor is initially represented as a 50-dimensional feature vector of firing rates (e.g., a temporal averages of odors). To associate each odor with a tag involves three operations: normalization to center the mean of the feature vector, dimension expansion of the feature vector from 50 dimensions to 2,000 dimensions, and winner-takes-all (WTA) competition, which is a result of a strong inhibitory feedback coming from an inhibitory neuron, to silence all but five percent of the 2,000 dimensions representing an odor. Similar to the fruit fly, the example RSL algorithm disclosed herein utilizes a form of the above-mentioned three operations to perform a similarity search on a query data set. The operation of the RSL data and control flow similarity search pipeline 500 is described in further detail below in connection with the combined discussion of FIGS. 5 and 6.

Referring now to FIGS. 5 and 6, the algorithmic pipeline 600 which may be utilized by the compute device 100 (e.g., the processor 102 and/or the memory management controller 140) for performing RSL and the mathematical equation 640 for performing RSL are shown. In RSL, the compute device 100 (e.g., the processor 102 and/or the memory management controller 140) takes an input vector x (e.g., a d-dimensional floating point vector, a database vector, etc.) and operates in a manner similar to the olfactory system of the drosophila melanogaster (the fruit fly). In the example operation 510, 610, the compute device 100 (e.g., the processor 102 and/or the memory management controller 140) performs data normalization. In doing so, the compute device 100 (e.g., the processor 102 and/or the memory management controller 140) normalizes input data to add invariance to specific deformations (e.g., translations, rotations, sheer stress, etc.). For example, the compute device 100 (e.g., the processor 102 and/or the memory management controller 140) may determine the mean of the values in input data (e.g., in an input data vector) and remove (e.g., subtract) the mean from the values. In a subsequent operation 520, 620, the compute device 100 (e.g., the processor 102 and/or the memory management controller 140) performs dimensionality expansion. In doing. so, the compute device 100 (e.g., the processor 102 and/or the memory management controller 140) randomly projects the normalized input data to a higher dimensional space D where D is greater than d (e.g., 20 to 40 fold increase in dimensionality). By randomly projecting the normalized input data to a higher dimensional space, the computer device 100 (e.g., the processor 102 and/or the memory management controller 140) ensures that each element in the higher-dimensional projection vector receives and sums relatively few elements from the input vector, as shown in FIG. 6. The procedure can be formalized as matrix multiplication of input vector x and a binary sparse projection matrix W of dimension (D×d). The compute device 100 (e.g., the processor 102 and/or the memory management controller 140) provides instructions to the memory controller 106 to store the random sparse projection matrix W (also referred to as the model parameter) in memory (e.g., the memory 104 and/or the data storage device 114) to be used for subsequent queries.

In a subsequent operation 530, 630, the compute device 100 (e.g., the processor 102 and/or the memory management controller 140) binarizes the projection vector to produce a hash code using a winner-take-all (WTA) strategy in which only a small fraction of top entries (e.g., largest values) in the projection vector (e.g., 5% of D) are set to one and the rest are set to zero. Preferably, the hash-code is a locality-sensitive hash. By executing the RSL pipeline, the compute device 100 (e.g., the processor 102 and/or the memory management controller 140) efficiently leverages the unique features (e.g., the ability to read individual columns) of the memory media (e.g., the memory media 110 and/or the memory media 120) to accelerate a similarity search on a large scale database (e.g., order of a billion elements) without losing the accuracy of the results. Specifically, by executing the RSL pipeline, the compute device 100 (e.g., the processor 102 and/or the memory management controller 140) generates sparse binary hash codes that are a distance preserving transformation from input to Hamming space. The memory controller 106 determines Hamming distances between hash codes to approximate the Euclidean distance between the data points that produced the hash codes. Further, by generating the sparse binary hash codes, the compute device 100 (e.g., the processor 102 and/or the memory management controller 140) reduces the number of memory read operations that would otherwise be required because of the relatively few ones compared to zeros in the hash codes, and information is contained only in the set bits (e.g., the bits set to one) in the binary hash codes. As such, the binary hash code satisfies all of the requirements of the stochastic associative search and can benefit from the in-memory binary search acceleration provided by the memory 104.

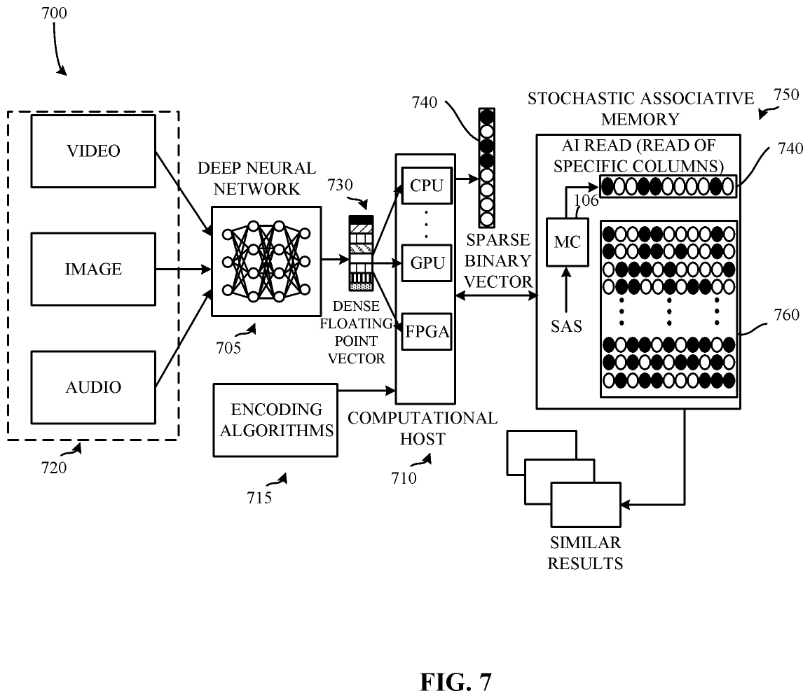

FIG. 7 is a diagram of a hardware mapping 700 of stages of the RSL pipeline 500 and 600 of FIGS. 5 and 6. The hardware mapping 700 includes a deep neural network (DNN) 705. In some examples, the DNN 705 is pre-trained to obtain an input dataset 720 and output dense floating point vectors 730 based on features of the input dataset 720. The input dataset 720 may include image data, video data, audio data, etc. For example, in operation, the example DNN 705 obtains an image. In such an example, the example DNN 705 applies functions (e.g., activations, etc.) to the data in the input image that generate outputs indicative of features of the image. For example, the DNN 705 generates or builds derived values of feature vectors (e.g., representative of features in input dataset 720) that are to be informative and non-redundant to facilitate the generation of a random sparse projection matrix (W). As used herein, a feature vector is an n-dimensional array (e.g., a dense floating point vector 730) of features that represent some image, video, audio, etc. For example, a feature could be a shape in the input image, descriptive colors of video, frequency of audio, etc. The example DNN 705 reduces raw input data (e.g., the input dataset 720) into more manageable groups (e.g., features) for processing, while describing the original input dataset 720 with sufficient completeness and accuracy. In the hardware mapping 700, an example computational host 710 generates a random sparse projection matrix W by executing the RSL data and control flow similarity search pipeline 500 and/or the algorithmic pipeline 600. By executing the RSL data and control flow similarity search pipeline 500 and/or the algorithmic pipeline 600, the computational host 710 (e.g., the processor 102 and/or the memory management controller 140) transforms the example input dataset 720 from example floating point vectors 730 to high-dimensional sparse binary hash codes 740. As shown in FIG. 7, the transformation of floating point vectors 730 to high-dimensional sparse binary hash codes 740 is performed by the computational host 710. For example, the computational host 710 can be implemented by a central processing unit (CPU) (e.g., the processor 102 and/or the memory management controller 140), a GPU (e.g., the (WI 128), an FPGA, and/or other circuitry. The computational host 710 generates the binary hash codes 740 based on encoding algorithms 715 (e.g., FruitFly, POSH, KNN-POSH, PQ, etc.). Subsequently, the computational host 710 stores the binary hash codes 740 (e.g., the sparse binary hash codes) and the projection matrix W in a stochastic associative memory (e.g., the memory media 110 and/or the memory media 120). The same sparse projection matrix W is also used during indexing to generate binary hash codes for new elements added to the database. Query processing involves the computational host 710 retrieving the stored matrix W and performing the above three operations to generate the sparse binary code to be used for searching (e.g., the search key 410 of FIG. 4), The computational host 710 (e.g., the memory controller 106) compares the query hash code (e.g., the search key 410) with example database hash codes 760 (e.g., the vectors 422, 424, 426, 428, 430, 432, 434) and calculates the pair-wise Hamming distances (e.g., based on the matching bits, as described above). The comparison, in the illustrated example of FIG. 7, is performed in the stochastic associative memory 750 (e.g., in the memory 104 and/or the data storage device 114). Further, in the illustrated example of FIG. 7, the stochastic associative memory 750 (e.g., the memory 104 and/or the data storage device 114) at least partially sorts the database hash codes 760 (e.g., the vectors 422, 424, 426, 428, 430, 432, 434) based on the Hamming distances and returns the indices of the closest matching vectors 422, 424, 426, 428, 430, 432, 434 (e.g., the closest matching N vectors)

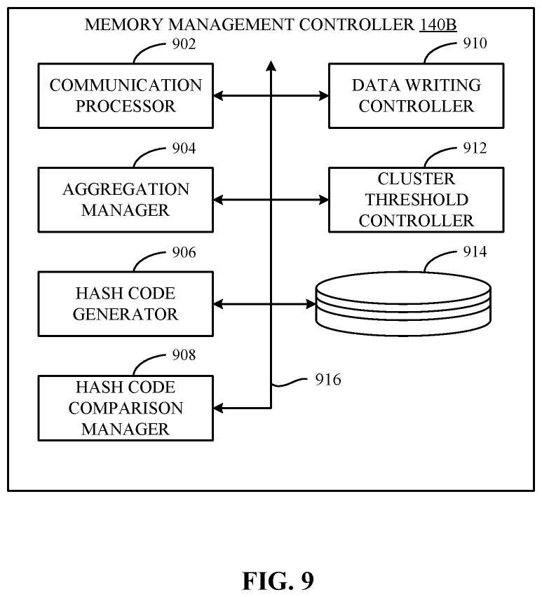

FIGS. 8 and 9 illustrate example implementations of the example memory management controller 140 of FIG. 1. For example, FIG. 8 is an example block diagram of the memory management controller 140A of FIG. 1 to facilitate similarity search in the memory 104 and/or the data storage device 114 of FIG. 1. In another example, FIG. 9 is an example block diagram of the memory management controller 140B to partition the data in the memory 104 and/or the data storage device 114 of FIG. 1 into clusters. The example diagram of FIG. 9 can be included in the example diagram of FIG. 8. Additionally, and/or alternatively, the example diagram of FIG. 8 can be included in the example diagram of FIG. 9. In examples disclosed herein, the memory management controller 140 of FIG. 1 may implement the example memory management controller 140A of FIG. 8, the memory management controller 14013 of FIG. 9, and/or any combination of the memory management controller 140A and the memory management controller 140B.

FIG. 8 is an example block diagram of the memory management controller 140A of FIG. 1. In the example of FIG. 8, the memory management controller 140A includes an example vector interface 802, an example transform generator 804, an example update manager 806, an example transpose generator 808, an example query interface 810, an example hash code generator 812, an example query manager 814, and an example data store 816. In the example illustrated in FIG. 8, any of the vector interface 802, the transform generator 804, the update manager 806, the transpose generator 808, the query interface 810, the hash code generator 812, the query manager 814, and/or the data store 816 may communicate via an example communication interface 801. The example communication interface 801 may be implemented using any suitable wired and/or wireless communication device and/or method. For example, the communication interface 801 may be any suitable communication technology (e.g., wired and/or wireless communications) operating using any suitable associated protocols that allow the components of the memory management controller 140A to communicate with one another. For example, the communication interface 801 may be implemented as Ethernet, Bluetooth®, Wi--WiMAX, a hardware data bus, among others to effect such communication.

In the example illustrated in FIG. 8, the vector interface 802 is configured to communicate with other components of the processor 102 and/or the I/O subsystem 112 to obtain a database vector for storage in the memory 104 and/or the memory media 110 of FIG. 1. In this manner, the vector interface 802 may, in response to a write instruction, obtain the corresponding database vector. In examples disclosed herein, the database vector may contain bits and/or bytes of data associated with corresponding addresses to be stored in the memory 104 and/or memory media 110. Further, in examples disclosed herein, the memory management controller 1404 (or the memory management controller 140) may include an application programming interface (API) configured to be operable by a user of the compute device 100. In this manner, such a user may utilize the API to initiate an insertion (e.g., a write, an update, etc.) to the memory media 110, a query (e.g., a read) of the memory media 110, etc. In examples disclosed herein, the database vector may indicate to write a new row and/or column in the memory media 110, overwrite a row and/or column in the memory media 110, delete and/or otherwise remove a row and/or column in the memory media 110, etc.

Upon obtaining a database vector, the vector interface 802 may transmit the database vector to the transform generator 804 for further processing. In the illustrated example, the vector interface 802 is implemented using a hardware interface (e.g., a data bus) that communicates with other components of the processor 102 and/or the memory 104. In some examples, the vector interface 802 facilitates wired communication via an Ethernet network. In other examples disclosed herein, any other type of wired and/or wireless transceiver (e.g., a WiFi radio) may additionally or alternatively be used to implement the vector interface 80.2,

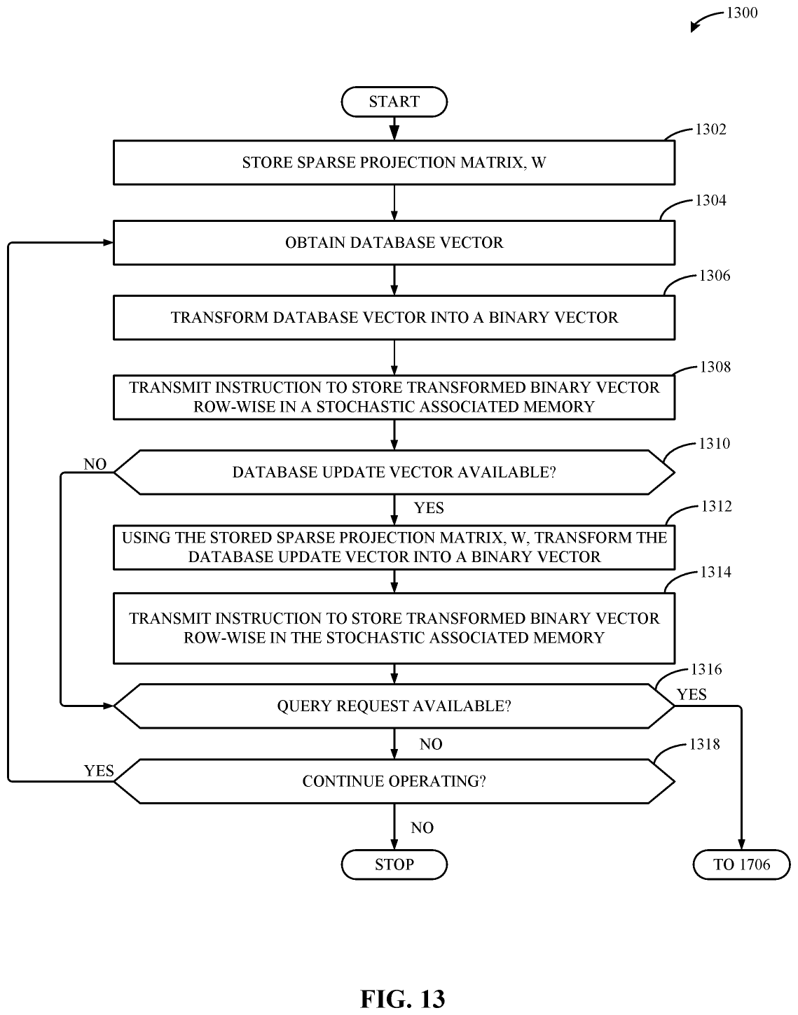

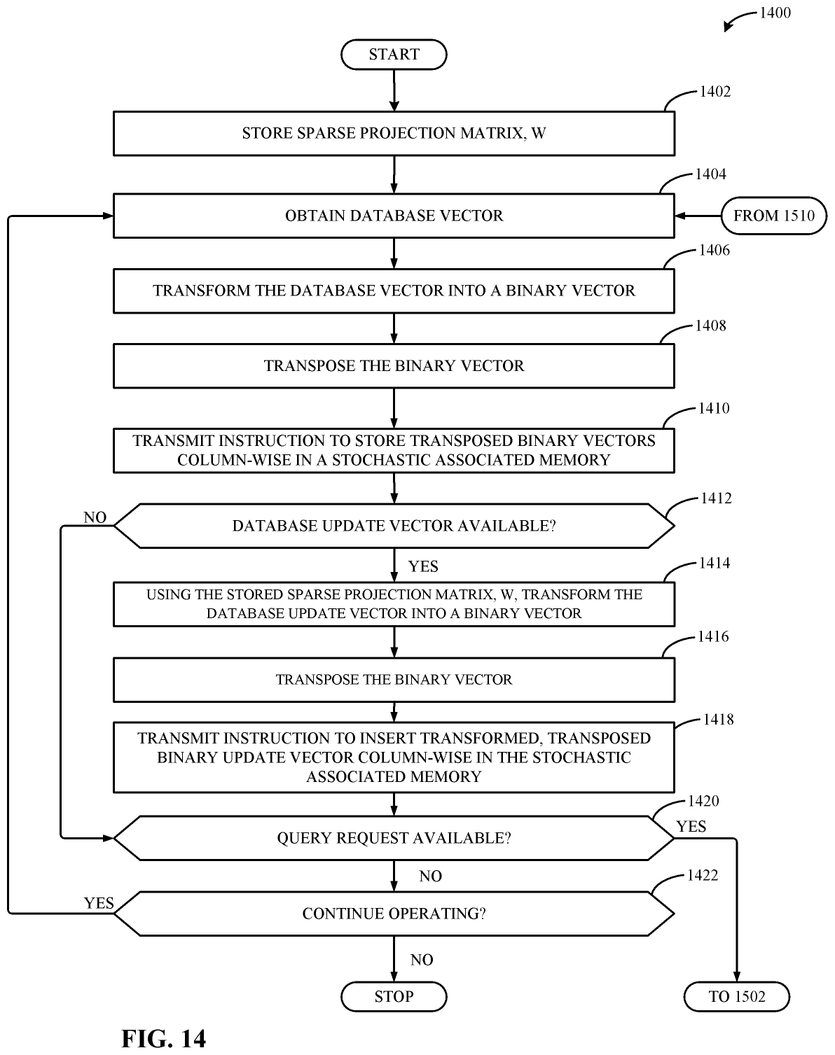

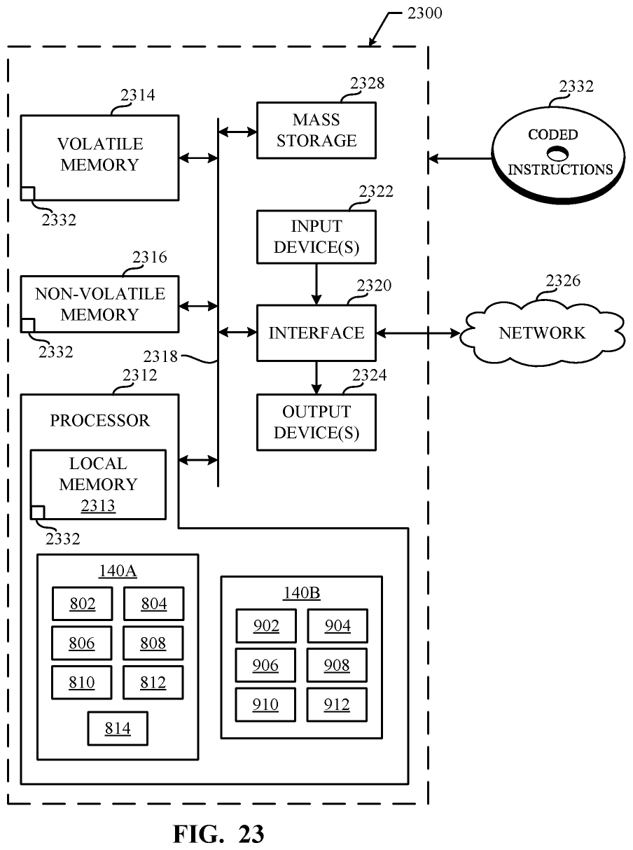

In some examples, the example vector interface 802 implements example means for interfacing, or example interfacing means. The interfacing means is implemented by executable instructions such as that implemented by at least block 1304 of FIG. 13 and/or at least block 1404 of FIG. 14. The executable instructions of blocks 1304 of FIG. 13 and/or block 1404 of FIG. 14 may be executed on at least one processor such as the example processor 2312 of FIG. 23. In other examples, the interfacing means is implemented by hardware logic, hardware implemented state machines, logic circuitry, and/or any other combination of hardware, software, and/or firmware.

In FIG. 8, the example transform generator 804 is configured to obtain the database vector from the vector interface 802. The transform generator 804 performs a transformation on the database vector to transform the database vector into a binary vector (e.g., a sparse binary vector, a dense binary vector). For example, the transform generator 804 may use a binarization method such as RSL to transform the database vector into a binary vector (e.g., a sparse binary vector or a dense binary vector). An example illustrating RSL is described above, in connection with FIGS. 5, 6, and/or 7. As such, the transform generator 804 is configured to store the resulting sparse projection matrix, W, used in transforming the database vector in the data store 816. In examples disclosed herein, the sparse projection matrix, W, may be stored in the data store 816 prior to the transform generator 804 transforming the database vector. Additionally, the transform generator 804 is configured to transmit an instruction to the memory controller 106 to store the resulting binary vector (e.g., a sparse binary vector or a dense binary vector, the transformed database vector) in a stochastic associative memory (e.g., in the memory media 110) in a row-wise manner.

In some examples disclosed herein, the instruction transmitted. by the transform generator 804 to the memory controller 106 may indicate to store the resulting binary vector (e.g., a sparse binary vector, a dense binary vector, the transformed database vector) in a previously deleted row of the memory media 110, in the next open (e.g., un-written) row of the memory media 110, etc., based on whether the database vector indicates to write a new row and/or column in the memory media 110, overwrite a row and/or column in the memory media 110, delete and/or otherwise remove a row and/or column in the memory media 110, etc.

In some examples disclosed herein, the memory management controller 1404 may indicate to the transpose generator 808 to transpose the binary vector (e.g., a sparse binary vector or a dense binary vector) prior to transmitting an instruction to store the resulting binary vector (e.g., the sparse binary vector, the dense binary vector, the transformed database vector) in a stochastic associative memory (e.g., in the memory media 110). In such an operation, the transform generator 804 is configured to transmit an instruction to store (e.g., insert) the resulting transposed binary vector (e.g., a sparse binary vector, a dense binary vector, the transformed transposed database vector) in a stochastic associative memory (e.g., in the memory media 110) in a column-wise manner.

In operation, the transform generator 804, and more generally the memory management controller 140A of FIG. 1, facilitates efficient updates of the memory media 110. For example, in the event subsequent database vectors are obtained from the processor 102 for writing in the memory media 110, the transform generator 804 may use the same sparse projection matrix, W, previously generated and/or otherwise stored. For example, the binarization method such as RSL depends on the sparse projection matrix, W, and, as such, the transform generator 804 can utilize a previous generated sparse projection matrix to efficiently (e.g., computationally inexpensive, less processing power, etc.) update the memory media 110. In the event the transform generator 804 obtains a subsequent database vector (e.g., a database update vector) the transform generator 804 transmits an instruction to the memory controller 106 to store the resulting binary vector (e.g., the sparse binary vector, the dense binary vector, the transformed database vector) in the memory media 110. In examples disclosed herein, the instruction transmitted by the transform generator 804 to the memory controller 106 may indicate to store the resulting binary vector (e.g., the sparse binary vector, the dense binary vector, the transformed database update vector) in a previously deleted row of the memory media 110, in the next open (e.g., un-written) row of the memory media 110, etc., based on whether the database update vector indicates to write a new row and/or column in the memory media 110, overwrite a row and/or column in the memory media 110, delete and/or otherwise remove a row and/or column in the memory media 110, etc. The example transform generator 804 of the illustrated example of FIG. 8 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field. programmable logic device(s) (FPLD(s)), digital signal processor(s) (DSP(s)), etc.

Additionally, in some examples disclosed herein, the instruction transmitted by the transform generator 804 may indicate to delete the bits in the memory media 110 based on the resulting binary vector (e.g., the sparse binary vector, the dense binary vector, the transformed database vector) and/or the resulting transposed binary vector (e.g., the sparse binary vector, the dense binary vector, the transformed transposed database vector). In such an example, the instruction transmitted by the transform generator 804 may indicate to add an additional bit to each vector in the memory media 110, thus marking Whether the corresponding vector has been deleted or is active. Therefore, upon deletion, the marked bit is to be changed.

In some examples, the example transform generator 804 implements example means for transforming, or example transforming means. The transforming means is implemented by executable instructions such as that implemented by at least blocks 1302, 1306, 1308, 1312, 1314 of FIG. 13 and/or at least blocks 1402, 1404, 1410, 1414, 1418 of FIG. 14. The executable instructions of blocks 1302, 1306, 1308, 1312, 1314 of FIG. 13 and/or blocks 1402, 1404, 1410, 1414. 1418 of FIG. 14 may be executed on at least one processor such as the example processor 2312 of FIG. 23. in other examples, the transforming means is implemented by hardware logic, hardware implemented state machines, logic circuitry, and/or any other combination of hardware, software, and/or firmware.

In the example illustrated in FIG. 8, the example update manager 806 is configured to determine whether a database vector is obtained. For example, the update manager 806 is configured to determine whether an update to the memory media 110 (e.g., an update and/or otherwise subsequent database vector) is obtained. In examples disclosed herein, the database update vector (e.g., an update and/or otherwise subsequent database vector) may indicate to write a new row and/or column in the memory media 110, overwrite a row and/or column in the memory media 110, delete and/or otherwise remove a row and/or column in the memory media 110, etc. In the event the update manager 806 determines an update to the memory media 110 (e.g., an update and/or otherwise subsequent database vector) is obtained, the update manager 806 transmits the update and/or otherwise subsequent database vector to the transform generator 804 for subsequent processing. The example update manager 806 of the illustrated example of FIG. 8 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)). etc.

In some examples, the example update manager 806 implements example means for updating, or example updating means. The updating means is implemented by executable instructions such as that implemented by at least block 1310 of FIG. 13 and/or at least block 1412 of FIG. 14. The executable instructions of blocks 1310 of FIG. 13 and/or 1410 of FIG. 14 may be executed on at least one processor such as the example processor 2312. of FIG. 23. In other examples, the updating means is implemented by hardware logic, hardware implemented state machines, logic circuitry, and/or any other combination of hardware, software, and/or firmware.

In some examples disclosed herein, prior to the transform generator 804 transmitting an instruction to store the resulting binary vector (e.g., the sparse binary vector, the dense binary vector, the transformed database vector) in a stochastic associative memory (e.g., in the memory media 110) in a column-wise manner, the example transpose generator 808 is configured to transpose the binary vector (e.g., the sparse binary vector, the dense binary vector). For example, the transpose generator 808 may invoke logic circuity to adjust a data structure of the binary vector (e.g., the sparse binary vector, the dense binary vector). For example, in response to identifying that the data structure of the binary vector (e.g., the sparse binary vector, the dense binary vector) is a vector, a matrix, etc., the logic circuitry of the transpose generator 808 can transpose such a data structure. The example transpose generator 808 of the illustrated example of FIG. 8 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), etc.

In some examples, the example transpose generator 808 implements example means for transposing, or example transposing means. The transposing means is implemented by executable instructions such as that implemented by at least blocks 1408 and 1416 of FIG. 14. The executable instructions of blocks 1408 and 1416 of FIG. 14 may be executed on at least one processor such as the example processor 2312 of FIG. 23, In other examples, the transposing means is implemented by hardware logic, hardware implemented state machines, logic circuitry, and/or any other combination of hardware, software, and/or firmware.

In the example illustrated in FIG. 8, the query interface 810 is configured to determine whether a query request (e.g., a read request) is obtained. For example, a query((e.g., a read request) may be transmitted to the memory management controller 140A to identify bit(s) and/or byte(s) of data currently stored in the memory media 110. In the event the query interface 810 determines that query request (e.g., a read request) is obtained and/or otherwise available, the query interface 810 facilitates the processing of query request (e.g., the read request) within the memory management controller 140 of FIG. 1 and/or the memory management controller 140B of FIG. 9 for further processing. The example query interface 810 of the illustrated example of FIG. 8 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), etc.

In some examples, the example query interface 810 implements example means for querying, or example querying means. The querying means is implemented by executable instructions such as that implemented by at least block 1316 of FIG. 13 and/or at least block 1420 of FIG. 14. The executable instructions of block 1316 of FIG. 13 and/or block 1420 of FIG. 14 may be executed on at least one processor such as the example processor 2312. of FIG. 23. In other examples, the querying means is implemented by hardware logic, hardware implemented state machines, logic circuitry, and/or any other combination of hardware, software, and/or firmware.

In the example of FIG. 8, the hash code generator 812 is configured to, in response to the query interface 810 indicating that a query request is available, obtain the query vector. Additionally, the hash code generator 812 transforms the query vector into a binary vector (e.g., a sparse binary vector, a dense binary vector). Preferably, the example hash code generator 812 uses a locality-sensitive hash function, where the hash code generator 812 generates a hash such that similar query vectors are assigned the same hash code with high probability. In particular, a distance-preserving embedding may be used. In examples disclosed herein, the hash code generator 812. may use the stored sparse projection matrix, W, to transform the query vector associated with the query request into a binary vector (e.g., a sparse binary vector, a dense binary vector). The example hash code generator 812 of the illustrated example of FIG. 8 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), etc.

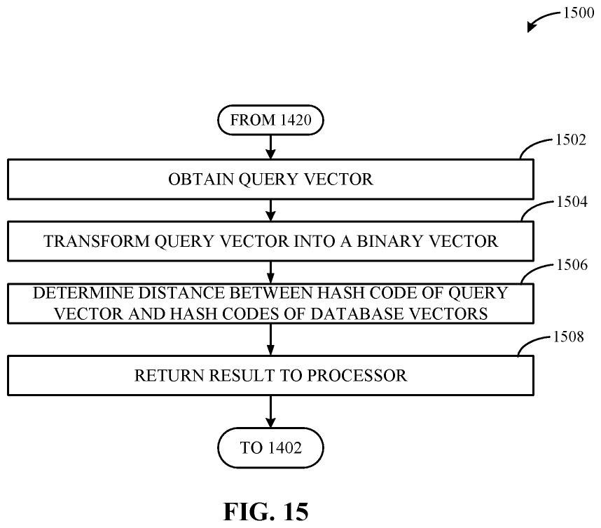

In some examples, the example hash code generator 812 implements example means for determining hash distance, or example determining hash distance means. The determining hash distance means is implemented by executable instructions such as that implemented by at least blocks 1502 and 1504 of FIG. 15. The executable instructions of blocks 1502 and 1504 of FIG. 15 may be executed on at least one processor such as the example processor 2312 of FIG. 23. In other examples, the determining hash distance means is implemented by hardware logic, hardware implemented state machines, logic circuitry, and/or any other combination of hardware, software, and/or firmware.

In the example of FIG. 8, the query manager 814 is configured to determine the hash code for the rows in the memory media 110 that correspond to the set bits in the query vector (e.g., a vector obtained in the query request). In examples disclosed herein, the hash code generator 812 determines the hash code for the rows in the memory media 110 that correspond to the set bits in the query vector (e.g., a vector obtained in the query request) in the event the transpose generator 808 transposes the database vector prior to storage in the memory media 110. In this manner, the query manager 814 determines the distance between the hash code of the query vector (e.g., a vector obtained in the query request) and the database vector (e.g., the rows in the memory media 110 that correspond to the set bits in the query vector). For example, the query manager 814 may calculate the Hamming distance between the hash code of the query vector (e.g., a vector obtained in the query request) and the database vector (e.g., the rows in the memory media 110 that correspond to the set bits in the query vector). The query manager 814 is configured to return such a resulting Hamming distance to the data store 816. The example query manager 814 of the illustrated example of FIG. 8 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), etc.

In some examples, the example query manager 814 implements example means for query managing, or example query managing means. The query managing means is implemented by executable instructions such as that implemented by at least blocks 1506 and 1508 of FIG. 15, The executable instructions of blocks 1506 and 1508 of FIG. 15 may be executed on at least one processor such as the example processor 2312 of FIG. 23. In other examples, the query managing means is implemented by hardware logic, hardware implemented state machines, logic circuitry, and/or any other combination of hardware, software, and/or firmware.

In the example, of FIG. 8, the data store 816 is configured to store database vectors obtained by the vector interface 802, query vectors obtained by the query interface 810, and/or any suitable set of data utilized by the memory management controller 140A. For example, the data store 816 may store the transposed database vector generated by the transpose generator 808, the sparse projection matrix, W, generated by the memory management controller 140A, etc. The example data store 816 of the illustrated example of FIG. 8 may be implemented by any device for storing data such as, for example, flash memory, magnetic media, optical media, etc. Furthermore, the data stored in the example data store 816 may be in any data format such as, for example, binary data, comma delimited data, tab delimited data, structured query language (SQL) structures, etc.

In some examples, the example data store 816 implements example means for storing, or example storing means. In other examples, the storing means is implemented by hardware logic, hardware implemented state machines, logic circuitry, and/or any other combination of hardware, software, and/or firmware.

FIG. 9 is an example block diagram of the memory management controller 140 of FIG. 1. In the example of FIG. 9, the memory management controller 140 includes an example communication processor 902, an example aggregation manager 904, an example hash code generator 906, an example hash code comparison manager 908, an example data writing controller 910, an example cluster threshold controller 912, and an example data store 914. In the example illustrated in FIG. 9, any of the communication processor 902, the aggregation manager 904, the hash code generator 906, the hash code comparison manager 908, the data writing controller 910, the cluster threshold controller 912, and/or the data store 914 may communicate via an example communication interface 916. The example communication interface 916 may be implemented using any suitable wired and/or wireless communication device and/or method. For example, the communication interface 916 may be any suitable communication technology (e.g., wired and/or wireless communications) operating using any suitable associated protocols that allow the components of the memory management controller 140B to communication with one another. For example, the communication interface 916 may be implemented as Ethernet, Bluetooth®, Wi-Fi®, WiMAX, a hardware data bus, among others to effect such communication.

In the illustrated example of FIG. 9, the example communication processor 902 is implemented by a network interface controller. In additional or alternative examples, the communication processor 902 can be implemented by one or more analog or digital circuit(s), logic circuits, programmable processor(s), programmable controller(s), GPU(s). DSP(s), ASIC(s). PLD(s) and/or FPLD(s). In some examples, the communication processor 902 can be implemented as any communication circuit, device, or collection thereof, capable of enabling communications over a network between the memory management controller 140 and other components of the compute device 100 and/or another device. The communication processor 902 may be configured to use any one or more communication technology (e.g., wired or wireless communications) and associated protocols (e.g., Ethernet, Bluetooth®, Wi-Fi®, WiMAX, etc.) to affect such communication.

In the illustrated example of FIG. 9, the example communication processor 902 functions as a network interface configured to communicate with other devices in one or more networks (e.g., other devices coupled to the I/O subsystem 112, etc.) with a designated physical and data link layer standard (e.g., Ethernet or Wi-Fi). For example, the communication processor 902 identifies data in memory (e.g., the memory 104, the data storage device 114, etc.).

In the illustrated example of FIG. 9, the communication processor 902 identifies data in memory by interfacing with a memory controller and/or other device functioning to control the memory (e.g., the memory controller 106, the VFU 130, etc.). For example, the communication processor 902 queries the memory controller 106 regarding the amount of data stored in the memory media 110. The communication processor 902 can then communicate the amount of data in the memory to the aggregation manager 904 so that the memory can be partitioned.

In the illustrated example, of FIG. 9, after the memory is partitioned, the communication processor 902 monitors for data to be stored in and/or searched for in the memory. For example, the communication processor 902 can actively poll other components of the compute device 100 (e.g., other components of the processor 102, the communication circuitry 122, the one or more accelerator devices 126, etc.) for data to be indexed and/or data to be searched for in the memory. Additionally, the communication processor 902 can passively monitor other components by providing a time period during which the communication processor 902 will accept data to be indexed and/or data to be searched for in memory. In some examples, the communication processor 902 accepts data to be stored in and/or searched for in the memory at any time.

In some examples, other components communicating with the communication processor 902 can include information regarding whether data is to be stored in or searched for (e.g., a query) in the memory. For example, the communication processor 902 obtains information corresponding to indexing. The indexing information informs the communication processor 902 that the data corresponds to index data to be stored in the memory. Alternatively, the communication processor 902 obtain information corresponding to querying. The querying information informs the communication processor 902 that the data corresponds to query data to be searched for in the memory.

In the illustrated example of FIG. 9, after monitoring for data to be stored in and/or searched for in the memory, the communication processor 902 determines whether data has been received and/or otherwise obtained by the communication processor 902. In response to determining, based on indexing information, that index data to be stored in the memory has been received, the communication processor 902 forwards the index data to the hash code generator 906. Additionally or alternatively, the communication processor 902 stores the index data in the data store 914.

In the illustrated example of FIG. 9, in response to determining, based on the querying information, that query data to be searched for in the memory has been received, the communication processor 902 forwards the query data to the hash code generator 906. Additionally, or alternatively, the communication processor 902 stores the query data in the data store 914. In the case of a query, after the memory controller associated with the memory to be searched (e.g., the memory controller 106) identifies the results of the query, the communication processor 902 returns the results (e.g., similar data to the query) to the querying device (e.g., the querier).

In the illustrated example of FIG. 9, after data has been indexed and/or searched for in the memory, the communication processor 902 determines whether to continue operating. For example, the communication processor 902 determines not to continue operating if there is no additional data to be stored in anchor searched for in the memory. Alternatively, the communication processor 902 determines to continue operating if there is additional data to be stored in and/or searched for in the memory, In the event that additional data becomes available to be stored in and/or searched for in the memory after operation has ceased, the communication processor 902 can re-engage the other components of the memory management controller 140.

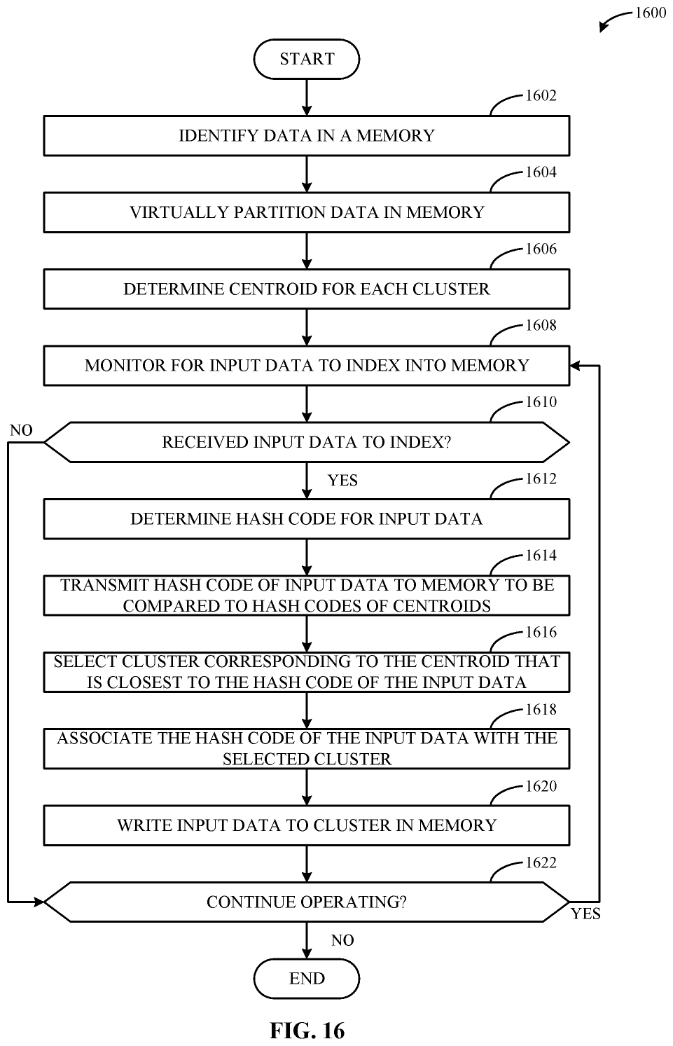

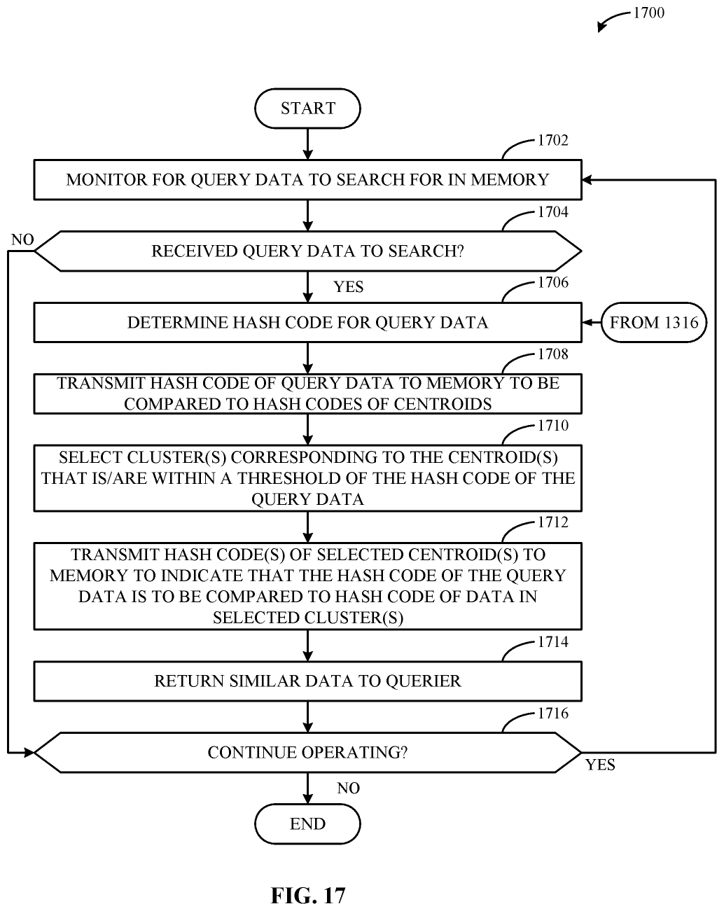

In some examples, the example communication processor 902 implements example means for processing communications, or example communication processing means. The communication processing means is implemented by executable instructions such as that implemented by at least blocks 1602, 1608, 1610, and 1622 of FIG. 16 and/or at least blocks 1702, 1704, 1714, and 1716 of FIG. 17, The executable instructions of blocks 1602, 1608, 1610, and 1622 of FIG. 16 and/or blocks 1702, 1704, 1714, and 1716 of FIG. 17 may be executed on at least one processor such as the example processor 2312 of FIG. 23. In other examples, the communication processing means is implemented by hardware logic, hardware implemented state machines, logic circuitry, and/or any other combination of hardware, software, and/or firmware.

In the illustrated example of FIG. 9, the aggregation manager 904 is implemented by a controller. In additional or alternative examples, the aggregation manager 904 can be implemented by one or more analog or digital circuit(s), logic circuits, programmable processor(s), programmable controller(s), GPU(s), DSP(s), ASIC(s), PLD(s) and/or FPLD(s). The aggregation manager 904 manages one or more clusters of memory.

In the illustrated example of FIG. 9, the aggregation manager 904 virtually partitions the data in the memory (e.g., the memory 104, the data storage device 114, etc.). That is, based on the data identified in the memory by the communication processor 902, the aggregation manager 904 determines groupings of the data in the memory (e.g., the memory 104, the data storage device 114, etc.) but does not actually separate the data in the memory (e.g., the memory 104, the data storage device 114, etc.) In this manner, the aggregation manager 904 virtually partitions the data in the memory. For example, the aggregation manager 904 virtually partitions the memory into clusters according to a clustering algorithm such as K-means clustering. In additional or alternative examples, the aggregation manager 904 can virtually partition the memory into clusters according to other clustering algorithms such as fuzzy C- means clustering, hierarchical clustering, etc. The aggregation manager 904 then stores the assignment of which data is associated with each cluster in the data store 914.

In the illustrated example of FIG. 9, after virtually partitioning the memory into clusters, the aggregation manager 904 determines a centroid for each cluster. In examples disclosed herein, the centroid is a representative of the cluster. The aggregation manager 904 determines a centroid for a cluster by applying an aggregation operator to hash codes of data assigned to the cluster. For example, the aggregation manager 904 determines the mean, the medium, the center of mass, and/or any other measure of center of the hash codes of data assigned to a cluster to determine the centroid of the cluster. In this manner, the aggregation manager 904 determines the centroid in Hamming space. In additional or alternative examples, the aggregation manager 904 determines the centroids for clusters on an incremental basis based on the number of quanta of data assigned to the cluster. After determining centroids for the clusters, the aggregation manager 904 stores the centroids (e.g., hash values) in the data store 914 and/or the memory (e.g., the memory 104).

In the illustrated example of FIG. 9, after index data has been added a cluster of memory, the aggregation manager 904 associates the hash code of the index data with the cluster. For example, the aggregation manager 904 applies an aggregator operator to the hash codes of the data associated with the cluster including the newly indexed data. In this manner, the aggregation manager 904 maintains cluster centroids in Hamming space while allowing the stochastic associative memory to be amenable to fast searches. After associating the hash code of the index data with the cluster, the aggregation manager 904 stores the updated centroid in the data store 914.

Given the size of modem databases (e.g., on the order of billions of entries), the search speed of traditional techniques using stochastic associative memories is not enough to cope with current throughput demands (e.g., on the order of tens/hundreds of thousands of searches per second). Contrary to traditional techniques, examples disclosed herein handle the throughput demands by partitioning the database into clusters that each have an associated representative. As such, examples disclosed herein include a state-of-the-art technique to search stochastic associative memories.

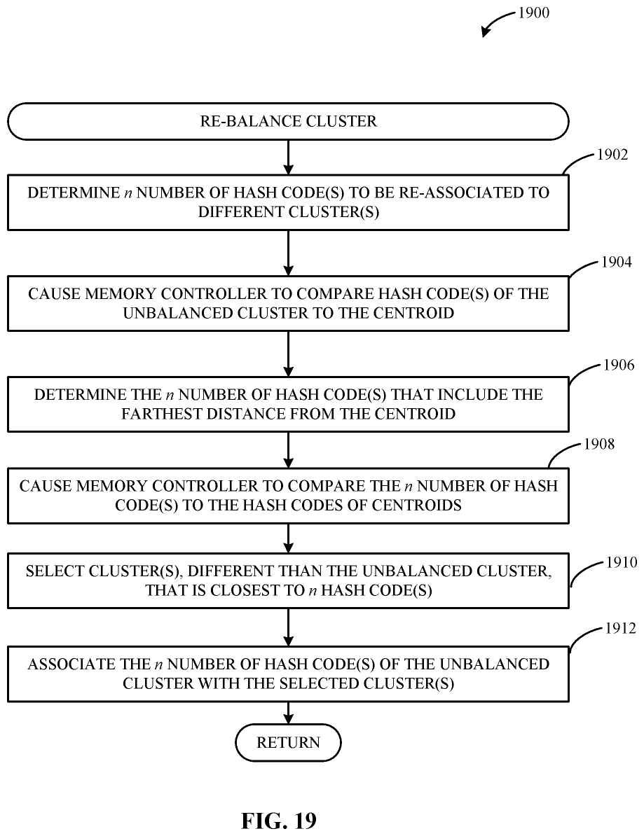

In some examples, the example aggregation manager 904 implements example means for aggregating, or example aggregating means. The aggregating means is implemented by executable instructions such as that implemented by at least blocks 1604, 1606, and 1618 of FIG. 16 and/or at least block 1912 of FIG. 19. The executable instructions of blocks 1604, 1606, and 1618 of FIG. 16 and/or block 1912 of FIG. 19 may be executed on at least one processor such as the example processor 2312 of FIG. 23. In other examples, the aggregating means is implemented by hardware logic, hardware implemented state machines, logic circuitry, and/or any other combination of hardware, software, and/or firmware.

In the illustrated example of FIG. 9, the hash code generator 906 is implemented by a controller. In additional or alternative examples, the hash code generator 906 can be implemented by one or more analog or digital circuit(s), logic circuits, programmable processor(s), programmable controller(s), GPU(s), DSP(s), ASIC(s), PLD(s) and/or FPLD(s). The hash code generator 906 generates hash codes for index data to be stored in memory and/or query data to be searched for in memory. After generating a hash code for index data and/or query data, the hash code generator 906 transmits the hash code to the hash code comparison manager 908. In some examples, the hash code generator 906 stores the hash codes for index data and/or query data in the data store 914.

In the illustrated example of FIG. 9, the hash code generator 906 generates hash codes for data by transforming index data and/or query data in floating-point format into binary hash codes such that the Hamming distance between hash codes reflects their similarity in the input space. For example, as described above, the hash code generator 906 may generate hash codes with RSL and/or POSH. \Arid e the RSL pipeline described above provides acceleration for similarity search using the stochastic associative memory (e.g., the memory media 110), using POSH to adapt (e.g., optimize) the projection matrix W retains the benefits of RSL while increasing the accuracy of the search results. The POSH technique utilizes machine learning to adapt the projection matrix W to provide an improved data transformation for dimensionality expansion. By converting data into binary hash codes, the hash code generator 906 enables the use of stochastic associative memories to search through a database. For example, hashing techniques have proven to be highly performant alternatives for traditional similarity search techniques.

In some examples, the example hash code generator 906 implements example means for generating hash codes, or example hash code generating means. The hash code generating means is implemented by executable instructions such as that implemented by at least block 1612 of FIG. 16 and/or at least block 1706 of FIG. 17. The executable instructions of block 1612 of FIG. 16 and/or block 1706 of FIG. 17 may be executed on at least one processor such as the example processor 2312 of FIG. 23. In other examples, the hash code generating means is implemented by hardware logic, hardware implemented state machines, logic circuitry, and/or any other combination of hardware, software, and/or firmware.

In the illustrated example of FIG. 9, the hash code comparison manager 908 is implemented by a controller. In additional or alternative examples, the hash code comparison manager 908 can be implemented by one or more analog or digital circuit(s), logic circuits, programmable processor(s), programmable controller(s), GPU(s), DSP(s), ASIC(s), PLD(s) and/or FPLD(s). The hash code comparison manager 908 manages comparison of hash codes to one or more centroids and/or one or more hash codes of data stored in the memory.

In the illustrated example of FIG. 9, the hash code comparison manager 908 offloads hash code comparisons to memory. For example, the hash code comparison manager 908 offloads hash code comparisons to the memory controller 106. Alternatively, the example hash code comparison manager 908 offloads hash code comparisons to the VFU 130. In the example of FIG. 9, during both an indexing operation and a querying operation, the hash code comparison manager 908 transmits the hash code of the data to the memory (e.g., the memory 104, the data storage device 114, etc.) where it is to be compared to the hash codes of the centroids.

In the illustrated example of FIG. 9, during an indexing operation, after the component to which the hash code comparison was offloaded indicates the distances between the hash code and the centroids, the hash code comparison manager 908 selects the cluster correspond to the centroid that is closest to the hash code of the index data. For example, the hash code comparison manager 908 selects the centroid according to a k-nearest-neighbor function. In some examples, after selecting a cluster, the hash code comparison manager 908 stores the centroid associated with the selected cluster in the data store 914.

In the illustrated example of FIG. 9, during a querying operation, after the component to which the hash code comparison was offloaded indicates the distances between the hash code and the centroids, the hash code comparison manager 908 selects the cluster(s) corresponding to the centroids that is/are within a threshold of the hash code of the query data. For example, after the component to which the hash code comparison was offloaded compares the hash code of the query data against the centroids of the memory (e.g., the memory 104, the data storage device 114, etc.), the hash code comparison manager 908 selects a small subset of the clusters within which to further explore. For example, the hash code comparison manager 908 selects the centroid(s) according to a k-nearest-neighbor function. For example, the threshold can correspond to a tolerance for how specific the search is to be. For example, the threshold represents a tradeoff between accuracy (e.g., specificity) and search speed. The optimal operating point (e.g., the optimal threshold) varies depending on the application and can be chosen (e.g., set) according to user requirements. In some examples, after selecting the one or more cluster(s), the hash code comparison manager 908 stores the centroid(s) associated with the selected cluster(s) in the data store 914. After the search space is narrowed (e.g., by selecting one or more centroid(s)), the hash code comparison manager 908 transmits the hash codes of the selected centroids to the memory to indicate that the hash code of the query data is to be compared to the hash codes of the data in the selected clusters.

In some examples, the hash code comparison manager 908 handles hash code comparisons locally at the memory management controller 140. For example, for both indexing operations and querying operations, the hash code comparison manager 908 determines the distance between a hash code of data and the hash codes of the centroids. For example, the hash code comparison manager 908 can determine the Hamming distance between the index data and/or the query data and the centroids. In such examples, the hash code comparison manager 908 stores the distances between the hash code data and the hash codes of the centroids in the data store 914. In additional or alternative examples, other measures of distance can be utilized.

In such examples where the hash code comparison manager 908 handles hash code comparisons locally at the memory management controller 140, after having selected. clusters within which to search for the query data, the hash code comparison manager 908 determines the distance between the hash code of the query data and the hash codes of the data in the selected clusters. By preliminarily selecting the clusters within which to search for the query data, the hash code comparison manager 908 limits the search space for query results. In this manner, the hash code comparison manager 908 ensures the queries of stochastic associative memory have consistently low latency and improve the performance of the compute device 100. For example, the hash code comparison manager 908 takes the union of the hash codes in the data in the selected clusters and retrieves the most similar elements in this set. For example, the hash code comparison manager 908 determines the Hamming distance between the query data and the hash codes of the data in the selected clusters. In such examples, the hash code comparison manager 908 stores the distances between the query data and the hash codes of the data in the selected clusters in the data store 914. In additional or alternative examples, other measures of distance can be utilized.

In some examples, the example hash code comparison manager 908 implements example means for managing hash code comparisons, or example hash code comparison management means. The hash code comparison management means is implemented by executable instructions such as that implemented by at least blocks 1614, and 1616 of FIG. 16 and/or at least blocks 1708, 1710, and 1712 of FIG. 17 and/or at least blocks 1904, 1908, and 1910 of FIG. 19, The executable instructions of blocks 1614, and 1616 of FIG. 16, blocks 1708, 1710, and 1712 of FIG. 17, and/or blocks 1904, 1908, and 1910 of FIG. 19 may be executed on at least one processor such as the example processor 2312 of FIG. 23. In other examples, the hash code comparison management means is implemented by hardware logic, hardware implemented state machines, logic circuitry, and/or any other combination of hardware, software, and/or firmware.

In the illustrated example of FIG. 9, the data writing controller 910 is implemented by a controller. In additional or alternative examples, the data writing controller 910 can be implemented by one or more analog or digital circuit(s), logic circuits, programmable processor(s), programmable controller(s), GPU(s), DSP(s), ASIC(s), PLD(s) and/or FPLD(s). During an indexing operation, after the hash code comparison manager 908 selects the cluster corresponding to the centroid that is closest to the hash code of the index data, the data writing controller 910 writes the index data to the selected cluster in memory (e.g., the memory 104, the data storage device 114). For example, the data writing controller 910 indicates to the memory controller 106 to store the index data in the memory media 110.

In some examples, the example data writing controller 910 implements example means for writing data, or example data writing means. The data writing means is implemented by executable instructions such as that implemented by at least block 1620 of FIG. 16. The executable instructions of block 1620 of FIG. 16 may be executed on at least one processor such as the example processor 2312 of FIG. 23. In other examples, the data writing means is implemented by hardware logic, hardware implemented state machines, logic circuitry, and/or any other combination of hardware, software, and/or firmware.

In the illustrated example of FIG. 9, the cluster threshold controller 912 is implemented by a controller. In additional or alternative examples, the cluster threshold controller 912 can be implemented by one or more analog or digital circuit(s), logic circuits, programmable processor(s), programmable controller(s), GPU(s), DSP(s), ASIC(s), PLD(s) and/or FPLD(s). In the example of FIG. 9, the example cluster threshold controller 912 is configured to monitor clusters in the memory media 110 to maintain the balanced nature of the clusters in the memory 104. For example, the cluster threshold controller 912 bounds the data stored in memory (e.g., memory 104 and/or data storage device 114) to facilitate low latency similarity searches of the memory (e.g., memory 104 and/or data storage device 114). For example, by bounding the data stored in memory (e.g., memory 104 and/or data storage device 114), clusters of hash codes are balanced and can easily be searched under the same amount of time. Therefore, the example cluster threshold controller 912 ensures and/or maintains the sizes of clusters to be even and/or balanced.

In the illustrated example of FIG. 9, the example cluster threshold controller 912 monitors the sizes of the clusters and/or the number of write elements (e.g., write operations) received by the example communication processor 902 to determine when re-balancing is to occur. For example, the cluster threshold controller 912 re-balances clusters when a certain threshold is met (e.g., a re-balance threshold, a cluster size threshold, etc.). In some examples, the threshold corresponds to a number of indexing data (e.g., write hash codes) input to the memory management controller 140. In other examples, the threshold corresponds to the sizes of the clusters in memory. In some examples, the cluster threshold controller 912 stores the threshold. value in the data store 914.

To monitor the number of indexing data input to the memory management controller 140, the example cluster threshold controller 912 includes a counter (e.g., a hash code counter) that monitors and/or counts the number of hash codes generated by the example hash code generator 906. The number of hash codes generated by the example hash code generator 906 is dependent upon the number of write operations received by the example communication processor 902. Therefore, in some examples, the counter of the cluster threshold controller 912 monitors and/or counts the number of write operations received at the communication processor 902.

In the illustrated example of FIG. 9, the example cluster threshold controller 912 waits until the counter value exceeds a threshold number of write operations and/or generated hash codes. In some examples, the threshold number of write operations and/or generated hash codes is determined by the layout of the memory 104, such as the number of tiles in the memory media 110 that are available, the number of dies of the memory media 110, etc. In some examples, when the threshold number of write operations is met and/or exceeded, a re-balancing operation is triggered, and the counter is reset. In examples disclosed herein, the re-balancing operation includes re-associating hash codes with clusters in a manner that balances the clusters.

In other examples, the cluster threshold controller 912 determines to re-balance the clusters when one or more clusters include an unbalanced size (e.g., include a number of associated hash codes that exceed a balanced number of associated hash codes). In examples disclosed herein, the balanced number of associated hash codes is determined based on the number of initial clusters and the number of hash codes stored in memory (e.g., the memory 104, the data storage device 114, etc.).

In an example first operation of the cluster threshold controller 912, the cluster threshold controller 912 monitors the number of write elements input to memory 104 (e.g., the memory 104, the data storage device 114, etc.). The example cluster threshold controller 912 initializes the hash code counter to zero and begins monitoring the write operations sent to the memory (e.g., the memory 104, the data storage device 114, etc.). For example, the cluster threshold controller 912 receives notifications from the communication processor 902 corresponding to a write operation. In other examples, the cluster threshold controller 912 queries the communication processor 902 for write operation information. Each time the example cluster threshold controller 912 determines a new write operation was received, the example cluster threshold controller 912 increments the hash code counter.

In some examples, the cluster threshold controller 912 determines when the hash code counter meets the re-balance threshold. In some examples, the re-balance threshold is set (e.g., defined, determined, etc.) based on the architecture of the memory (e.g., the memory 104, the data storage device 114, etc.). For example, the re-balance threshold may be a size corresponding to a number of memory cells in a cross-point architecture. In other examples, the re-balance threshold may be a size corresponding to the number of entries in a cache memory architecture. When the hash code counter meets the re-balance threshold, a re-balance operation is triggered. In some examples, the re-balance threshold is stored in the data store 914.

The example cluster threshold controller 912 instructs the example communication processor 902 to send a notification to the example memory controller 106 to analyze the clusters in memory (e.g., the memory 104, the data storage device 114, etc.) to determine if any clusters are unbalanced. For example, the memory controller 106 and/or VFU 130 may analyze the number of hash codes in each cluster and return the numbers to the cluster threshold controller 912 via the communication processor 902. In some examples, the hash code comparison manager 908 sends the notification to analyze the sizes of the clusters in memory (e.g., the memory 104, the data storage device 114). In some examples, the number of hash codes in each cluster is stored in the data store 914.

The example cluster threshold controller 912 compares the sizes of clusters the numbers of associated hash codes in the clusters) to each other to determine if any cluster is unbalanced. Additionally and/or alternatively, the example cluster threshold controller 912 compares the sizes of clusters to a balanced number to determine if any of the clusters are unbalanced. When the example cluster threshold controller 912 determines one or more clusters are unbalanced, the cluster threshold controller 912 triggers the hash code comparison manager 908 to transmit an instruction to the memory controller 106 to compare the hash codes of the unbalanced cluster to the centroid of the unbalanced cluster. The example memory controller 106 and/or VFU 130 returns the distances, based on the comparison, to the cluster threshold controller 912. In some examples, the hash code(s) having the longest (e.g., farthest) distance in Hamming space from the centroid are re-associated to a new centroid, depending on the number of hash codes that need to be re-associated. Determining the values of the hash code(s) corresponding to the unbalanced cluster that include the farthest distance in Hamming space from the centroid improves the efficiency of the RSL pipeline (e.g., RSL pipeline 500 and/or 600) when searching clusters in memory (e.g., memory 104 and/or data storage device 114) by forcing clusters to include proximately close hash codes in Hamming distance. The cluster threshold controller 912 determines n number of hash codes of the unbalanced cluster that are to be re- associated based on a balanced number. The example cluster threshold controller 912 determines n number of hash codes based on a difference between a total number of hash codes associated with the unbalanced cluster and the balanced size. For example, if the balanced number equals 10 hash codes, and the unbalanced cluster has 12 hash codes, the example cluster threshold controller 912 determines n equals two hash codes. In such an example, the cluster threshold controller 912 identities the values (e.g., the binary values) of then number of hash code(s) (e.g., two hash codes) that are farthest from the centroid and associates the n number of hash code(s) with a cluster corresponding to the centroid that is second closest to the hash code. Determining the n number of hash codes to be re-associated based on a difference between the total number of hash codes in the unbalanced cluster and the balanced number improves the efficiency of the compute device 100 when rebalancing the clusters in memory 104 by enabling a simplistic approach to the problem of unbalanced clusters.

In an example second operation of the cluster threshold controller 912, the example cluster threshold controller 912 monitors the number of associated hash codes per cluster to determine if re-balancing is to be triggered. The example cluster threshold controller 912 determines the number of hash codes that equal a balanced cluster size. For example, during an initial partitioning of the memory media 110, a number of clusters are generated based on the number of hash codes in the memory media 110 and the type of memory architecture. In some examples, if 1000 hash codes are stored in the memory (e.g., the memory 104, the data storage device 114, etc.) and 10 clusters are generated, then each of the 10 clusters should include 100 associated hash codes, where 100 is equal to the balanced number of associated hash codes. In examples where the memory (e.g., the memory 104, the data storage device 114, etc.) stores more hash codes over time (e.g., 5000 hash codes), the number of hash codes per cluster may increase, but the clusters will remain balanced (e.g., 500 hash codes per cluster, where 10 clusters were generated in the initial partitioning).

The example cluster threshold controller 912 may query the memory (e.g., the memory 104, the data storage device 114, etc.) via the example communication processor 902 and the example memory controller 106 and/or 116 to determine the size of the clusters in the memory (e.g., the memory 104, the data storage device 114, etc.). In some examples, the cluster threshold controller 912 queries the memory (e.g., the memory 104, the data storage device 114, etc.) periodically and/or aperiodically. For example, the cluster threshold controller 912 queries the memory media 110 when the hash code counter meets the re-balance threshold, when a time threshold is met (e.g., when a period of time, defined by an operator of the compute device 100, is met), etc.

During querying of the memory (e.g., the memory 104, the data storage device 114, etc.), the example cluster threshold controller 912 determines that one or more of the clusters of hash codes are unbalanced. For example, referring to the above example of the memory media 110 having 10 clusters with 100 associated hash codes, the cluster threshold controller 912 determines one of the 10 clusters includes 110 associated hash codes, but the remaining nine clusters include 100 associated hash codes, and, thus, the clusters are considered unbalanced.

The example cluster threshold controller 912 instructs the example memory controller 106 and/or 116 via the example communication processor 902 to provide Hamming distances of the hash codes associated with the centroid corresponding to the unbalanced cluster. Additionally and/or alternatively, the example hash code comparison manager 908 transmits instructions to compare the hash codes to the centroid of the unbalanced cluster. The example cluster threshold controller 912 may then select a number of hash codes (e.g., 10 hash codes) with the greatest distances from the centroid to be re-associated.

In some examples, after selection of the number of hash codes, the cluster threshold controller 912 provides the hash codes to the hash code comparison manager 908 for transmitting the selected hash codes to the memory controller 106 to compare to hash codes of centroids in the memory (e.g., the memory 104, the data storage device 114, etc.). In some examples, the cluster threshold controller 912 informs the hash code comparison manager 908 of the unbalanced cluster, such that the memory controller 106 does not perform the comparison with the hash codes of the unbalanced cluster.

The example hash code comparison manager 908 provides the Hamming distances to the cluster threshold controller 912 and the example cluster threshold controller 912 selects the cluster(s) corresponding to the centroid(s) that is/are closest to the selected hash codes. In some examples, the closest centroid(s) to the selected hash codes are the second closest and/or even third closest (e.g., because the closest centroid is the unbalanced centroid). In some examples, the hash code comparison manager 908 stores the Hamming distances in the example data store 914.

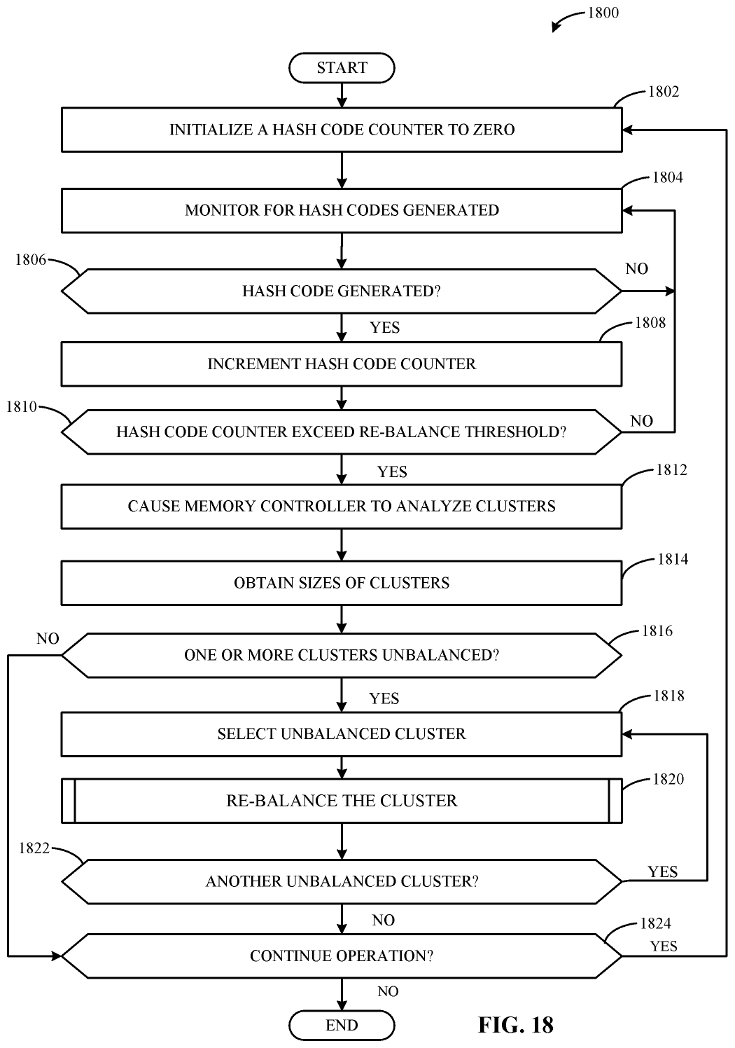

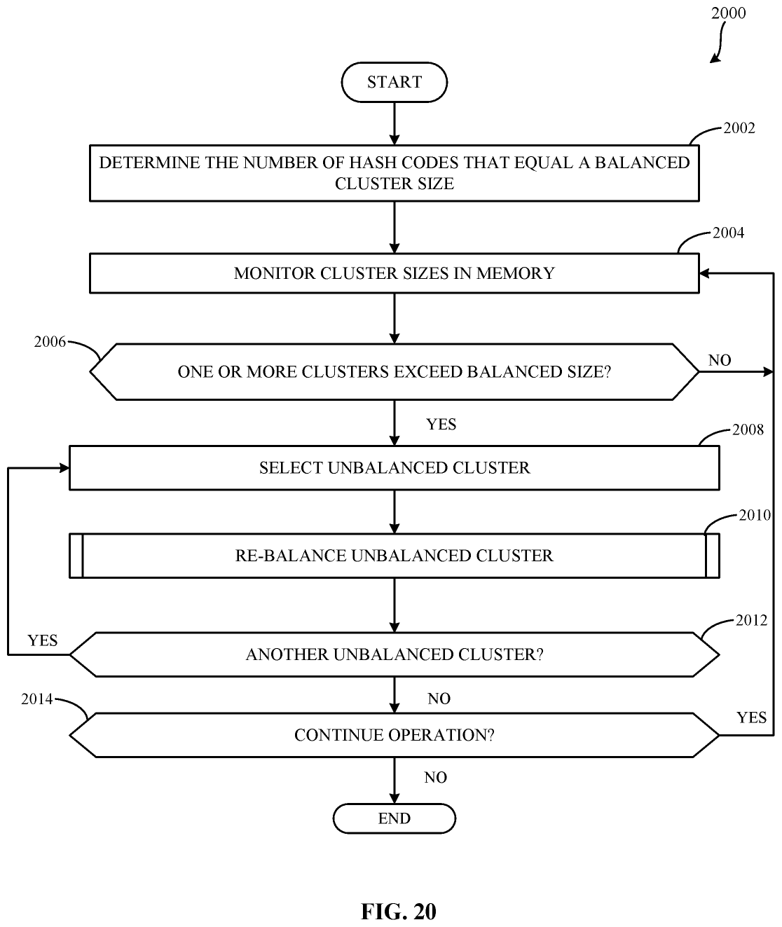

101261 In some examples, the example cluster threshold controller 912 implements example means for controlling cluster sizes, or example cluster size controlling means. The cluster size controlling means is implemented by executable instructions such as that implemented by at least blocks 1802, 1804, 1806, 1808, 1810, 1812, 1814, 1816, 1818, 1820, 1822, and 1824 of FIG. 18, at least blocks 1902, 1904, 1906, 1908, 1910, and 1912 of FIG. 19, and/or at least blocks 2002, 2004, 2006, 2008, 2010, 2012, and 2014 of FIG. 20. The executable instructions of blocks 1802, 1804, 1806, 1808, 1810, 1812, 1814, 1816, 1818, 1820. 1822, and 1824 of FIG. 18, blocks 1902, 1904. 1906, 1908, 1910, and 1912 of FIG. 19, and/or at blocks 2002, 2004, 2006, 2008, 2013, 2012, and 2014 of FIG. 20 may be executed on at least one processor such as the example processor 2312 of FIG. 23. In other examples, the cluster size controlling means is implemented by hardware logic, hardware implemented state machines, logic circuitry, and/or any other combination of hardware, software, and/or firmware.

In the illustrated example of FIG. 9, the data store 914 is configured to store data. For example, the data store 914 stores one or more files indicative of index data, query data, one or more assignments of which data is associated with each cluster, one or more centroids (e.g., hash codes of representative of clusters), one or more updated centroids, the hash codes for index data, the hash codes for query data, one or more centroids associated with one or more selected clusters, threshold values for triggering a re-balancing operation of the memory, hash codes to be re-associated to new clusters, distances in Hamming space of hash codes of an unbalanced cluster to the centroid of the unbalanced cluster, etc. In some examples, the data store 914 additionally, stores one or more files indicative of one or more distances between the hash code data and the hash codes of one or more centroids and/or one or more distances between the query data and the hash codes of the data in one or more selected clusters.

In the illustrated example of FIG. 9, the data store 914 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The example data store 914 may additionally or alternatively be implemented by one or more double data rate (DDR) memories, such as DDR, DDR2, DDR3, DDR4, mobile DDR (mDDR), etc. The example data store 914 may additionally or alternatively be implemented by one or more mass storage devices such as hard disk drive(s), compact disk drive(s), digital versatile disk drive(s), solid-state disk drive(s), etc. While in the illustrated example the data store 914 is illustrated as a single database, the data store 914 may be implemented by any number and/or type(s) of databases. Furthermore, the data stored in the data store 914 may be in any data format such as, for example, binary data, comma delimited data, tab delimited data, structured query language (SQL) structures, etc.

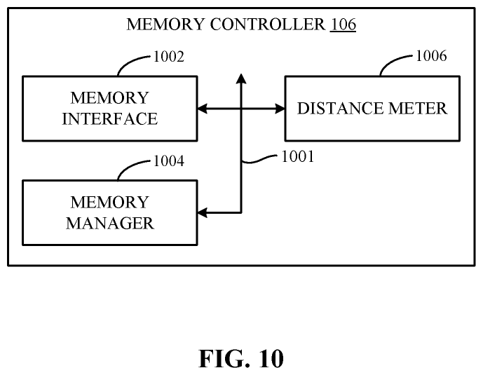

FIG. 10 is an example block diagram of the memory controller 106 of FIG. 1 In the example of FIG. 10, the memory controller 106 includes an example memory interface 1002, an example memory manager 1004, and an example distance meter 1006. In the example illustrated in FIG. 10, any of the memory interface 1002, the memory manager 1004, and/or the distance meter 1006 may communicate via an example communication interface 1001. The example communication interface 1001 may be implemented using any suitable wired and/or wireless communication device and/or method. For example, the communication interface 1001 may be any suitable communication technology (e.g., wired and/or wireless communications) operating using any suitable associated protocols that allow the components of the memory controller 106 to communicate with one another. For example, the communication interface 1001 may be implemented as Ethernet, Bluetooth®, WiMAX, a hardware data bus, among others to effect such communication.

In the example illustrated in FIG. 10, the example memory interface 1002 is configured to determine whether an instruction to store a binary vector is obtained from the memory management controller 140. For example, the memory interface 1002 is configured to determine whether an instruction to store a binary vector resulting from the transform generator 804 of FIG. 8 is obtained from the memory management controller 140A of FIG. 8, In the event the memory interface 1002 determines an instruction to store a binary vector is obtained from the memory management controller 140 (e.g., the memory management controller 140A), the memory interface 1002 indicates to the memory manager 1004 to store the binary vector into a stochastic associative memory (e.g., the memory media 110 of FIG. 1).

In addition, the example memory interface 1002 is configured to determine whether an instruction to insert a transformed, transposed database update vector obtained is obtained from the memory management controller 140. For example, the memory interface 1002. is configured to determine whether an instruction to insert a transformed, transposed database update vector resulting from the transform generator 804 of FIG. 8 is obtained from the memory management controller 140A of FIG. 8. In the event the memory interface 1002 determines an instruction to insert a transformed, transposed database update vector is obtained from the memory management controller 140 (e.g., the memory management controller 140A), the memory interface 1002 indicates to the memory manager 1004 to store the transformed, transposed database update vector into a stochastic associative memory (e.g., the memory media 110 of FIG. 1).

In the illustrated example of FIG. 10, additionally or alternatively, the memory interface 1002 is configured to facilitate indexing and/or querying of data in a stochastic associative memory (e.g., the memory media 110 of FIG. 1). For example, the memory interface 1002 monitors for hash codes corresponding to data to be stored in and/or searched for in the stochastic associative memory, Upon determining that the memory controller 106 has received one or more hash codes of data, the memory interface 1002 transmits and/or otherwise indicates to the distance meter 1006, the one or more hash codes of the data. In the illustrated example of FIG. 10, after the distance meter 1006 determines the distance between the one or more hash codes and the hash codes of the centroids of the clusters of the stochastic associative memory, the memory interface 1002 transmits the distances between the one or more hash codes of data and the hash codes of the centroids to the memory management controller 140 (e.g., the memory management controller 140B),

In the illustrated example, of FIG. 10, the memory interface 1002 additionally determines whether the memory controller 106 has received a selection of clusters within which to search for query data (e.g., indicative of a querying operation). In response to receiving such a selection, the memory interface 1002 forwards centroids of the selected clusters to the distance meter 1006. After the distance meter 1006 has determined the distance between the one or more hash codes of the query data and the hash codes of the data in the selected clusters, the memory interface 1002 transmits the distances to the memory management controller 140 (e.g., the memory management controller 140B).

In the illustrated example of FIG. 10, in response to determining that the memory controller 106 has not received a selection of clusters within which to search for query data (e.g., indicative of an indexing operation), the memory interface 1002 monitors for and determines whether the memory controller 106 has received an instruction to store index data. For example, the memory interface 1002 can monitor the memory management controller 140 (e.g., the memory management controller 140B). In response to receiving such an instruction, the memory interface 1002 forwards the index data to be stored to the memory manager 1004.

In the illustrated example of FIG. 10, the memory interface 1002 determines whether an instruction to determine numbers of hash codes associated with clusters is received. For example, the memory interface 1002 monitors for and determines Whether the memory controller 106 has received an instruction to analyze clusters. In response to receiving such an instruction, the memory interface 1002 forwards the instruction to the memory manager 1004.

In the illustrated example of FIG. 10, the memory interface 1002 determines whether an instruction to compare hash codes of an unbalanced cluster to the centroid of the unbalanced cluster is received. For example, the memory interface 1002 monitors for and determines whether the memory controller 106 has received an instruction to compute distances of all the hash codes corresponding to an unbalanced cluster to the centroid of the unbalanced cluster. In response to receiving such an instruction, the memory interface 1002 forwards the instruction to the distance meter 1006.

In the illustrated example of FIG. 10, the memory interface 1002 determines whether to continue operating. For example, the memory interface 1002 determines not to continue operating if there is no additional data to be stored in and/or searched for in the stochastic associative memory. Alternatively, the memory interface 1002 determines to continue operating if there is additional data to be stored in and/or searched for in the stochastic associative memory. In the event that additional data becomes available to be stored in and/or searched for in the memory after operation has ceased, the memory interface 1002 can re-engage the other components of the memory controller 106.

The example memory interface 1002 of the illustrated example of FIG. 10 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), etc.

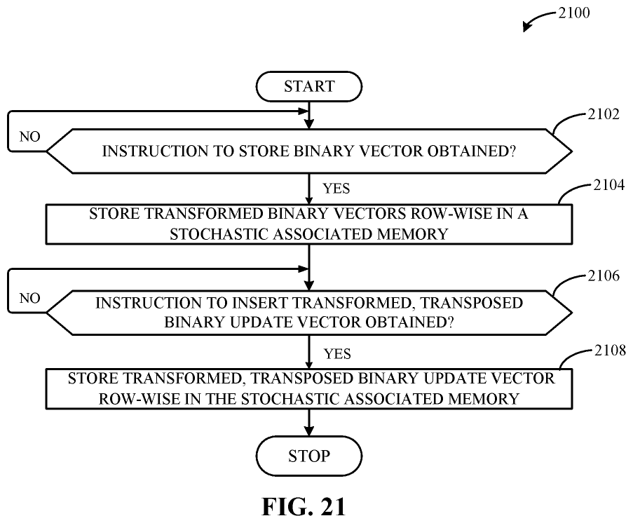

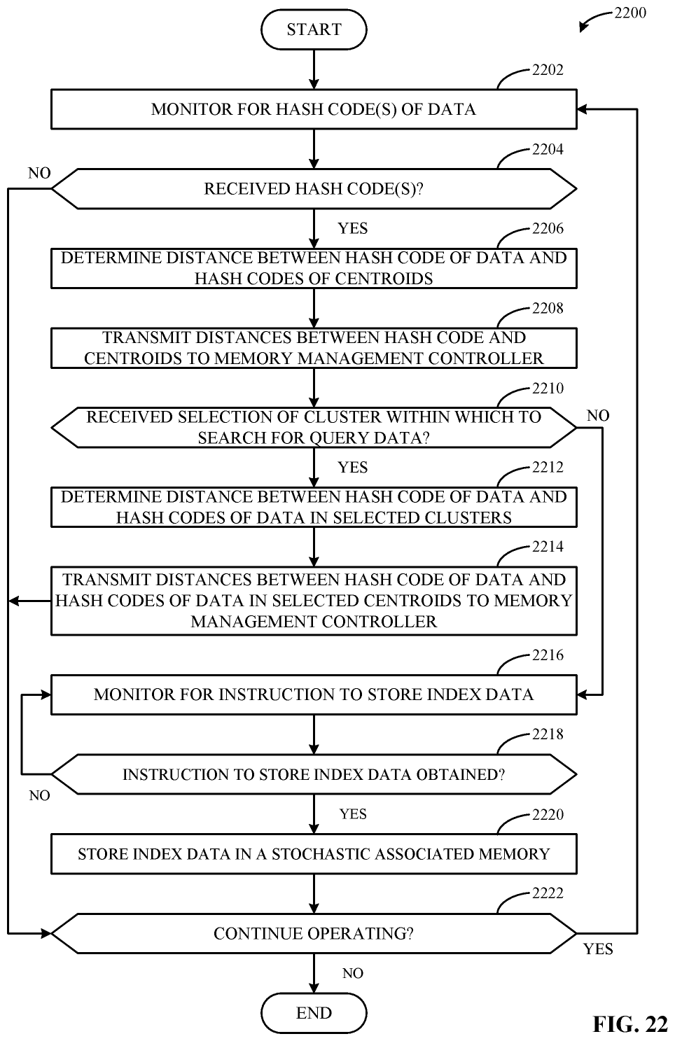

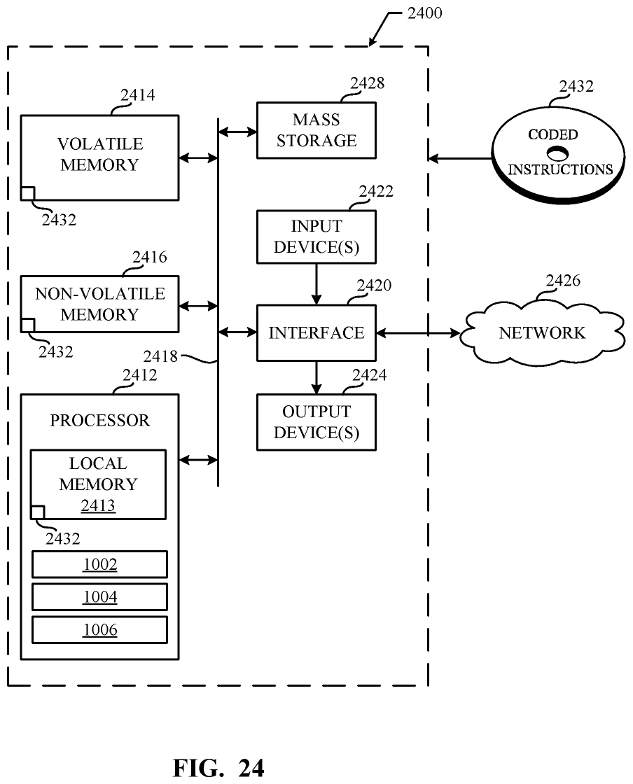

In some examples, the example memory interface 1002 implements example means for interfacing with memory, or example memory interfacing means. The memory interfacing means is implemented by executable instructions such as that implemented by at least blocks 2102 and 2106 of FIG. 21 and/or at least blocks 2202, 2204, 2208, 2210, 2214, 2216, 2218, and 2222 of FIG. 22. The executable instructions of blocks 2102 and 2106 of FIG. 21 and/or blocks 2202, 2204, 2208, 2210, 2214, 2216, 2218, and 2222 of FIG. 22 may be executed on at least one processor such as the example processor 2412 of FIG. 24. In other examples, the memory interfacing means is implemented by hardware logic, hardware implemented state machines, logic circuitry, and/or any other combination of hardware, software, and/or firmware.

In the example illustrated in FIG. 10, the memory manager 1004 is configured to store the binary vector row-wise in a stochastic associative memory. For example, the memory manager 1004 is configured to store e.g., insert) the transformed sparse-binary vector row-wise in the memory media 110 of FIG. 1. In addition, the memory manager 1004 is configured to store (e.g., insert) the transformed, transposed database update vector row-wise in a stochastic associative memory. For example, the memory manager 1004 is configured to store (e.g., insert) the transformed, transposed database update vector row-wise in the memory media 110 of FIG. 1.

In the illustrated example of FIG. 10, the memory manager 1004 additionally is configured to identify, determine, and/or compute the number of hash codes associated to each cluster in memory. For example, in response to receiving an instruction to analyze the cluster sizes in memory, the memory manager 1004 generates a list of values corresponding to a number of hash codes associated with each cluster.

In the illustrated example of FIG. 10, the example memory manager 1004 of the illustrated example of FIG. 10 is implemented by a logic circuit such as, for example, a hardware processor. How-ever, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field. programmable logic device(s) (FPLD(s)), digital signal processor(s) (DSP(s)), etc.

In some examples, the example memory manager 1004 implements example means for managing memory, or example memory management means. The memory management means is implemented by executable instructions such as that implemented by at least block 2104 and 2108 of FIG. 21 and/or at least block 2220 of FIG. 22. The executable instructions of blocks 2104 and 2108 of FIG. 21 and/or block 2220 of FIG. 22 may be executed on at least one processor such as the example processor 2412 of FIG. 24. In other examples, the memory management means is implemented by hardware logic, hardware implemented state machines, logic circuitry, and/or any other combination of hardware, software, and/or firmware.

In the illustrated example of FIG. 10, the distance meter 1006 determines the distance between a hash code of data and the hash codes of centroids of clusters in the stochastic associative memory. For example, the distance meter 1006 determines the Hamming distance between the index data and/or the query data and the centroids. In additional or alternative examples, other measures of distance can be utilized.

In the illustrated example of FIG. 10, the example distance meter 1006 additionally determines the distance between each hash codes in an unbalanced cluster and the centroid of the unbalanced cluster. For example, the distance meter 1006 determines the Hamming distance between the hash codes in the cluster and the centroid of that cluster. In such an example, the distance meter 1006 is not determining the distance between one hash code and all of the centroids in memory, but instead determining the distances between the hash codes in a cluster and the centroid of that cluster.

In the illustrated example of FIG. 10, in response to receiving an indication of the selected clusters from the memory interface 1002, the distance meter 1006 determines the distance between the hash code of the query data and the hash codes of the data in the selected clusters. For example, the distance meter 1006 takes the union of the hash codes in the data in the selected clusters and retrieving the most similar elements in this set. For example, the distance meter 1006 determines the Hamming distance between the query data and the hash codes of the data in the selected clusters. In additional or alternative examples, the other measures of distance can be utilized.

In the illustrated example of FIG. 10, the example distance meter 1006 of the illustrated example of FIG. 10 is implemented by a logic circuit such as, for example, a hardware processor. How-ever, any other type of circuitry may additionally or alternatively be used such as, for example, one or more analog or digital circuit(s), logic circuits, programmable processor(s), ASIC(s), PLD(s), FPLD(s), DSP(s), etc.

In some examples, the example distance meter 1006 implements example means for determining distances, or example distance determining means. The distance determining means is implemented by executable instructions such as that implemented by at least blocks 2206 and 2212 of FIG. 22. The executable instructions of blocks 2206 and 2212 of FIG. 22 may be executed on at least one processor such as the example processor 2412 of FIG. 24. In other examples, the distance determining means is implemented by hardware logic, hardware implemented state machines, logic circuitry, and/or any other combination of hardware, software, and/or firmware.

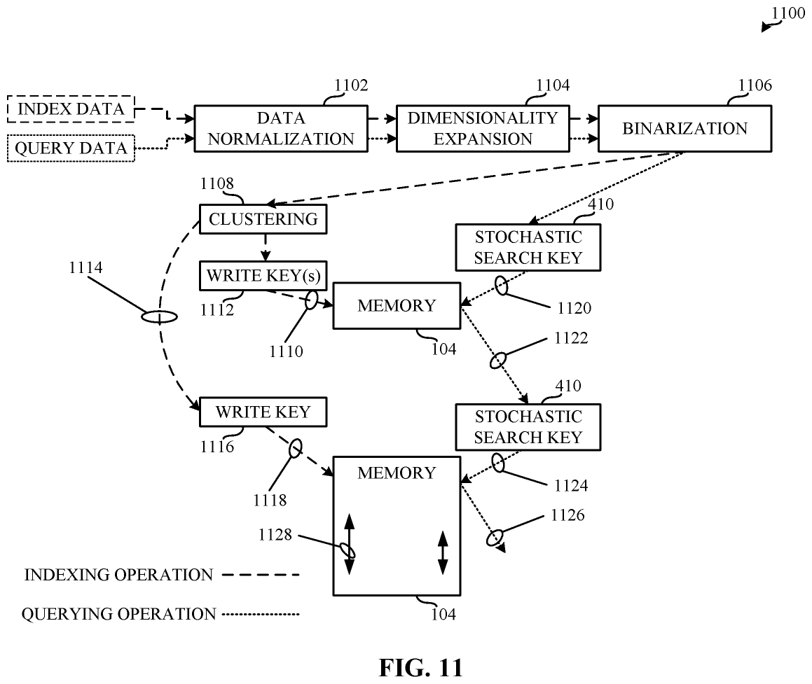

FIG. 11 is a diagram of an RSL data and control flow similarity search pipeline 1100 with clustering that may be implemented using the memory 104 of the compute device 100 of FIG. 1. The pipeline 1100 begins at operation 1102 where the hash code generator 906 performs data normalization. In doing so, the hash code generator 906 normalizes input data to add invariance to specific deformations e.g., translations, rotations, sheer stress, etc.). For example, the hash code generator 906 may determine the mean of the values in input data (e.g., in an input data vector) and remove (e.g., subtract) the mean from the values. In the example of FIG. 11, the input data can be index data and/or query data.

In the illustrated example of FIG. 11, at operation 1104, the hash code generator 906 performs dimensionality expansion. In doing so, the hash code generator 906 randomly projects the normalized input data to a higher dimensional space D where D is greater than d (e.g., 20 to 40-fold increase in dimensionality). By randomly projecting the normalized input data to a higher dimensional space, hash code generator 906 ensures that each element in the higher- dimensional projection vector receives and sums relatively few elements from the input vector, as shown in FIG. 6. The procedure can be formalized as matrix multiplication of input vector x and a binary sparse projection matrix \V of dimension (D×d). In the case of an indexing operation, the hash code generator 906 provides instructions to the memory controller 106 to store the random sparse projection matrix W (also referred to as the model parameter) in memory (e.g., the memory 104 and/or the data storage device 114) to be used for subsequent queries.

In the illustrated example of FIG. 11, at operation 1106, the hash code generator 906 binarizes the projection vector to produce a hash code using a WTA strategy in which only a small fraction of top entries (e.g., largest values) in the projection vector (e.g., 5% of D) are set to one and the rest are set to zero. In the case of an indexing operation, the hash code generator 906 provides instructions to the memory controller 106 to store the hash code in memory (e.g., the memory 104 and/or the data storage device 114) to be used for subsequent queries. In the case of a querying operation, the hash code generator 906 provides instructions to the memory controller 106 to search for the hash code in memory (e.g., the memory 104 and/or the data storage device 114).

In the illustrated example of FIG. 11, during an indexing operation, the memory management controller 140 executes operations 1108, 1110, 1114, and 1118. For example, at operation 1108, the aggregation manager 904 generates one or more clusters of the memory 104 by virtually partitioning the data in the memory 104. That is, based on the data identified in the memory by the communication processor 902, the aggregation manager 904 determines groupings of the data in the memory 104. For example, the aggregation manager 904 virtually partitions the memory into clusters according to the clustering algorithm discussed in connection with FIG. 9.

In the illustrated example of FIG. 11, at operation 1110, the aggregation manager 904 determines the centroids for clusters and stores the centroids (e.g., hash values (e.g., one or more example write keys 1112 similar to the search key 410)) in the memory 104. At operation 1114, the hash code comparison manager 908 transmits the hash code of the data (e.g., an example write key 1116 similar to the search key 410) to the memory 104 where the memory controller 106 is to determine the distances between the hash code of the data and the hash codes of the centroids. In response to such a determination, the hash code comparison manager 908 selects the cluster correspond to the centroid that is closest to the hash code of the index data.

In the illustrated example of FIG. 11, at operation 1118, the aggregation manager 904 associates the hash code of the index data with the cluster. For example, the aggregation manager 904 applies an aggregator operator to the hash codes of the data associated with the cluster including the newly indexed data. Additionally at operation 1118, the data writing controller 910 writes the index data to the selected cluster in the memory 104. For example, the data writing controller 910 indicates to the memory controller 106 to store the index data in the memory media 110.

In the illustrated example of FIG. 11, during a querying operation, the memory management controller 140 executes operations 1120, 1122, 1124, and 1126. For example, at operation 1120, the hash code comparison manager 908 transmits the hash code of the data (e.g., the search key 410) to the memory 104 where the memory controller 106 is to determine the distances between the hash code of the data and the hash codes of the centroids.

In the illustrated example of FIG. 11, at operation 1122, in response to such a determination, the hash code comparison manager 908 selects the cluster(s) corresponding to the centroids that is/are within a threshold of the hash code of the query data. At operation 1124, the hash code comparison manager 908 transmits the hash code of the query data (e.g., the search key 410) to the memory 104 where the memory controller 106 is to determine the distances between the hash code of the query data and the hash codes of the data in the selected clusters. At operation 1126, the communication processor 902 returns the results (e.g., similar data to the query) to the querying device (e.g., the querier).

In the illustrated example of FIG. 11, at operation 1128, the cluster threshold controller 912 determines that a cluster in memory 104 is unbalanced. For example, after the operation 1118, the aggregation manager 904 and the data writing controller 910 caused a cluster to be unbalanced by associating the hash code of the index data with a cluster of a previously balanced nature. In general, clustering algorithms produce unbalanced clusters (e.g., clusters with different numbers of hash codes). The time that it takes to explore any given cluster in a stochastic associative memory is linearly proportional to the size of cluster. The overall system latency (e.g., the time it takes to search) thus depends on the size of the largest cluster explored.

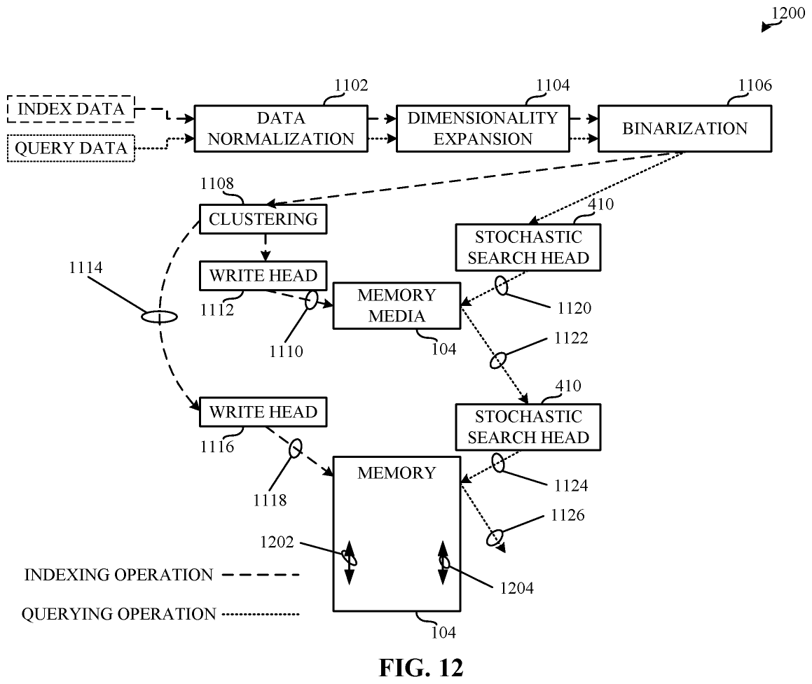

Therefore, turning to FIG. 12, a diagram of the RSL data and control flow similarity search pipeline 1200 with clustering and cluster balancing that may be implemented using the memory 104 of the compute device 100 of FIG. 1 is illustrated to bound the cluster sizes in Hamming space. The pipeline 1200 begins in a same manner as the pipeline 1100 of FIG. 11 such that the operations of 1102, 1104, 1106, 1108, 1110, 1112, 1114, 1116, and 1118 are described above in connection with FIG. 11.

In the illustrated example of FIG. 12, during an indexing operation, the memory management controller 140 executes operations 1202 and 1204. For example, at operation 1202, the example cluster threshold controller 912 monitors the sizes of the clusters in memory 104. In such an example, the cluster threshold controller 912 determines that a cluster was unbalanced and performs a re-balancing operation.

In the illustrated example of FIG. 12, at operation 1204, the example cluster threshold controller 912 achieves a balanced memory 104. For example, the cluster threshold controller 912 evens the clusters with the same number of indexing hash codes during the re-balancing operation performed at operation 1202. In this manner, the re-balancing operation performed by the cluster threshold controller 912 reduces the latency of the similarity search system (e.g., the RSL pipeline 1200) by reducing and/or eliminating the unbalanced clusters explored during a querying operation executed by operations 1120, 1122, 1124, and 1126.

While an example manner of implementing the example memory management controller 140 of FIG. 1, the example memory management controller 140A of FIG. 8, and/or the example memory management controller 140B of FIG. 9 is illustrated in FIGS. 1, 8, and/or 9, one or more of the elements, processes and/or devices illustrated in FIGS. 1, 8, and/or 9 may be combined, divided, re-arranged, omitted, eliminated and/or implemented in any other way. Further, the example vector interface 802, the example transform generator 804. the example update manager 806, the example transpose generator 808, the example query interface 810, the example hash code generator 812, the example query manager 814, the example communication processor 902, the example aggregation manager 904, the example hash code generator 906, the example hash code comparison manager 908, the example data writing controller 910, the example cluster threshold controller 912, and/or, more generally, the example memory management controller 140 of FIG. 1, the example memory management controller 140A of FIG. 8, and/or the example memory management controller 140B of FIG. 9 may be implemented by hardware, software, firmware and/or any combination of hardware, software and/or firmware. Thus, for example, any of the example vector interface 802, the example transform generator 804, the example update manager 806, the example transpose generator 808, the example query interface 810, the example hash code generator 812, the example query manager 814, the example communication processor 902, the example aggregation manager 904, the example hash code generator 906, the example hash code comparison manager 908, the example data writing controller 910, the example cluster threshold controller 912, and/or, more generally, the example memory management controller 140 of FIG. 1, the example memory management controller 1404 of FIG. 8, and/or the example memory management controller 140B of FIG. 9 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example vector interface 802, the example transform generator 804, the example update manager 806, the example transpose generator 808, the example query interface 810, the example hash code generator 812, the example query manager 814, the example communication processor 902, the example aggregation manager 904, the example hash code generator 906, the example hash code comparison manager 908, the example data writing controller 910, and/or the example cluster threshold controller 912 is/are hereby expressly defined to include a non-transitory computer readable storage device or storage disk such as a memory, a digital versatile disk (DVD), a compact disk (CD), a Blu-ray disk, etc. including the software and/or firmware. Further still, the example memory management controller 140 of FIG. 1, the example memory management controller 1404 of FIG. 8, and/or the example memory management controller 140B of FIG. 9 may include one or more elements, processes and/or devices in addition to, or instead of, those illustrated in FIGS. 1, 8, and/or 9, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

Flowcharts representative of example hardware logic, machine readable instructions, hardware implemented state machines, and/or any combination thereof for implementing the example memory management controller 140 of FIG. 1, the example memory management controller 140A of FIG. 8, and/or the example memory management controller 140B of FIG. 9 are shown in FIGS. 13, 14, 15, 16, 17, 18, 19, and/or 20. The machine readable instructions may be one or more executable programs or portion(s) of an executable program for execution by a computer processor and/or processor circuitry, such as the processor 2312 shown in the example processor platform 2300 discussed below in connection with FIG. 23. The program may be embodied in software stored on a non-transitory computer readable storage medium such as a CD-ROM, a floppy disk, a hard drive, a DVD, a Blu-ray disk, or a memory associated with the processor 2312, but the entire program and/or parts thereof could alternatively be executed by a device other than the processor 2312 and/or embodied in firmware or dedicated hardware. Further, although the example programs are described with reference to the flowcharts illustrated in FIGS. 13, 14, 15, 16, 17, 18, 19, and/or 20 many other methods of implementing the example memory management controller 140 of FIG. 1. the example memory management controller 140A of FIG. 8, and/or the example memory management controller 140B of FIG. 9 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.)

FIG. 13 is a flowchart representative of machine-readable instructions 1300 which may be executed to implement the memory management controller 140 of FIG. 1 and/or the memory management controller 140A of FIG. 8 to execute read and/or write instructions from the processor 102 of FIG. 1.

At block 1302, the memory management controller 140A stores the sparse projection matrix, W, used in transforming the database vector. (Block 1302). In examples disclosed herein, the transform generator 804 may store the sparse projection matrix, W, in the data store 816.

In the example illustrated in FIG. 13, the memory management controller 140A is configured to obtain a database vector. (Block 1304). In examples disclosed herein, the vector interface 802 of FIG. 8 may communicate with the processor 102 to obtain a database vector for storage in the memory 104 and/or the memory media 110 of FIG. 1.

At block 1306, the memory management controller 140A transforms the database vector into a binary vector (e.g., a sparse binary vector, a dense binary vector). (Block 1306). In examples disclosed herein, the example transform generator 804 of FIG. 8 performs a transformation on the database vector to transform the database vector into a binary vector (e.g., a sparse binary vector, a dense binary vector). For example, the transform generator 804 may use a binarization method such as Random Sparse Lifting to transform the database vector into a binary vector (e.g., a sparse binary vector, a dense binary vector).

At block 1308, the memory management controller 140A transmits an instruction to store (e.g., insert) the resulting binary vector (e.g., the sparse binary vector, the dense binary vector, the transformed database vector) in a stochastic associative memory. (Block 1308). In examples disclosed herein, transform generator 804 may transmit an instruction to the memory controller 106 of FIG. 1 to store (e.g., insert) the resulting binary vector (e.g., the sparse binary vector, the dense binary vector, the transformed database vector) in a stochastic associative memory. For example, the transform generator 804 may transmit an instruction to the memory controller 106 to store (e.g., insert) the resulting binary vector (e.g., the sparse binary vector, the dense binary vector, the transformed database vector) in the memory media 110 of FIG. 1 in a row-wise manner.

At block 1310, the memory management controller 140A determines whether a database update vector is available. (Block 1310). In examples disclosed herein, the update manager 806 of FIG. 8 may determine whether a database vector is obtained from the processor 102. For example, the update manager 806 is configured to determine whether an update to the memory media 110 (e.g., an update and/or otherwise subsequent database vector) is obtained from the processor 102,

In the event the memory management controller 140A and, more specifically, the update manager 806, determines an update to the memory media 110 (e.g., an update and/or otherwise subsequent database vector) is obtained (e.g., the control of block 1310 returns a result of YES), the memory management controller 140A uses the stored sparse projection matrix, W, to transform the database vector associated with the update to the memory media 110 into a binary vector (e.g., a sparse binary vector, a dense binary vector), (Block 131.2). In examples disclosed herein, the transform generator 804 may use the stored sparse projection matrix, W. to transform the database vector associated with the update to the memory media 110 into a binary vector (e.g., a sparse binary vector, a dense binary vector),

In response to the execution of the control in block 1312, the memory management controller 140A transmits an instruction to store (e.g., insert) the binary vector (e.g., the sparse binary vector, the dense binary vector, the transformed database update vector) into a stochastic associative memory, (Block 1314). In examples disclosed herein, the transform generator 804 may transmit an instruction to the memory controller 106 to store (e.g., insert) the binary vector (e.g., the sparse binary vector, the dense binary vector, the transformed database update vector) into the memory media 110 in a row-wise manner.

In response to either the execution of the control illustrated in block 1314, or in the event the memory management controller 140A and, more specifically, the update manager 806, determines an update to the memory media 110 (e.g., an update and/or otherwise subsequent database vector) is not obtained (e.g., the control of block 1310 returns a result of NO), the memory management controller 140A determines whether a query- request is available. (Block 1316). In examples disclosed herein, the query interface 810 may determine whether a query request is available. For example, the processor 102 may transmit a query (e.g., a read request) to the memory management controller 140A to identify bit(s) and/or byte(s) of data currently stored in the memory media 110. In the event the memory management controller 140A and, more specifically, the query interface 810 determines that query request (e.g., a read request) is obtained and/or otherwise available (e.g., the control of block 1316 returns a result of YES), control proceeds to block 1706 of FIG. 17. In examples disclosed herein, in the event the memory management controller 140A and, more specifically, the query interface 810 determines that query request (e.g.. a read request) is obtained and/or otherwise available (e.g., the control of block 1316 returns a result of YES), the memory management controller 140A may execute the machine-readable instructions of FIG. 17.

Alternatively, in the event the memory management controller 140A and, more specifically, the query interface 810 determines that query request (e.g., a read request) is not obtained and/or otherwise available (e.g., the control of block 1316 returns a result of NO), the memory management controller 140A determines whether to continue operating. (Block 1318).

In the event the memory management controller 140A determines to continue operating (e.g., the control of block 1318) returns a result of YES, the process returns to block 1304. Alternatively, in the event the memory management controller 140A determines not to continue operating (e.g., the control of block 1318 returns a result of NO), the process stops. In examples disclosed herein, the memory management controller 140A may determine to continue operating in the event additional database vectors are obtained from the processor 102. In examples disclosed herein, the memory management controller 140A may determine not to continue operating in the event no additional database vectors are available, a loss of power event occurs, etc.

FIG. 14 is a flowchart representative of machine-readable instructions 1400 which may be executed to implement the memory management controller 140 of FIG. 1 and/or the memory management controller 140A of FIG. 8 to execute read and/or write instructions from the processor 102 of FIG. 1.

At block 1402, the memory management controller 140A stores the sparse projection matrix, W, used in transforming the transposed database vector. (Block 1402). In examples disclosed herein, the transform generator 804 may store resulting sparse projection matrix, W, used in transforming the transposed database vector in the data store 816.

In the example illustrated in FIG. 14, the memory management controller 140A is configured to obtain a database vector. (Block 1404). In examples disclosed herein, the vector interface 802 of FIG. 8 may communicate with the processor 102 to obtain a database vector for storage in the memory 104 and/or the memory media 110 of FIG. 1.

At block 1406, the memory management controller 140A transforms the database vector into a binary vector (e.g., a sparse binary vector, a dense binary vector). (Block 1406), In examples disclosed herein, the example transform generator 804 of FIG. 8 performs a transformation on the database vector to transform the database vector into a binary vector (e.g., a sparse binary vector, a dense binary vector). For example, the transform generator 804 may use a binarization method such as Random Sparse Lifting to transform the transposed database vector into a binary vector (e.g., a sparse binary vector, a dense binary vector).

At block 1408, the memory management controller 140A transposes the binary vector (e.g., the sparse binary vector, the dense binary vector). (Block 1408). In examples disclosed herein, the example transpose generator 808 of FIG. 8 is configured to transpose the binary vector (e.g., the sparse binary vector, the dense binary vector). For example, the transpose generator 808 may invoke logic circuity to adjust a data structure of the binary vector (e.g., the sparse binary vector, the dense binary vector),

At block 1410, the memory management controller 140A transmits an instruction to store (e.g., insert) the resulting transposed binary vector (e.g., the sparse binary vector, the dense binary vector, the transformed transposed database vector) in a stochastic associative memory. (Block 1410). in examples disclosed herein, transform generator 804 may transmit an instruction to the memory controller 106 of FIG. 1 to store (e.g., inset) the resulting transposed binary vector (e.g., the sparse binary vector, the dense binary vector, the transformed transposed database vector) in a stochastic associative memory. For example, the transform generator 804 may transmit an instruction to the memory controller 106 of FIG. 1 to store (e.g., insert) the resulting transposed binary vector (e.g., the sparse -binary vector, the dense binary vector, the transformed transposed database vector) in the memory media 110 of FIG. 1 in a column-wise manner.

At block 1412, the memory management controller 140A determines whether a database update vector is available. (Block 1412). In examples disclosed herein, the update manager 806 of FIG. 8 may determine whether a database vector is obtained from the processor 102. For example, the update manager 806 is configured to determine whether an update to the memory media 110 (e.g., an update and/or otherwise subsequent database vector) is obtained from the processor 102.

In the event the memory management controller 140A and, more specifically, the update manager 806, determines an update to the memory media 110 (e.g., an update and/or otherwise subsequent database vector) is obtained (e.g., the control of block 1412 returns a result of YES), the memory management controller 140A uses the stored sparse projection matrix, W, to transform the database vector associated with the update to the memory media 110 into a binary vector (e.g., a sparse binary vector, a dense binary vector), (Block 1414). In examples disclosed herein, the transform generator 804 may use the stored sparse projection matrix, W, to transform the database vector associated with the update to the memory media 110 into a binary vector (e.g., a sparse binary vector, a dense binary vector),

In response to the execution of the control illustrated in block 1414, the memory controller transposes the binary vector (e.g., the sparse binary vector, the dense binary vector) corresponding to the update to the memory media 110. (Block 1416). In examples disclosed herein, the transpose generator 808 transposes the binary vector (e.g., the sparse binary vector, the dense binary vector) corresponding to the update to the memory media 110,

In response to the execution of the control in block 1416, the memory management controller 140A transmits an instruction to store (e.g., insert) the transformed, transposed sparse binary update vector into a stochastic associative memory. (Block 1418), In examples disclosed herein, the transform generator 804 may transmit an instruction to the memory controller 106 to store (e.g., insert) the transformed, transposed binary vector (e.g., the sparse binary vector, the dense binary vector) into the memory media 110 in a column-wise manner.

In response to either the execution of the control illustrated in block 1418, or in the event the memory management controller 140A and, more specifically, the update manager 806, determines an update to the memory media 110 (e.g., an update and/or otherwise subsequent database vector) is not obtained (e.g., the control of block 1412 returns a result of NO), the memory management controller 140A determines whether a query request is available. (Block 1420). In examples disclosed herein, the query interface 810 may determine whether a query request is available. For example, the processor 102 may transmit a query (e.g., a read request) to the memory management controller 140A to identify bit(s) and/or byte(s) of data currently stored in the memory media 110. In the event the memory management controller 140A and, more specifically, the query interface 810 determines that query request (e.g., a read request) is obtained and/or otherwise available (e.g., the control of block 1420 returns a result of YES), control proceeds to block 1.502 of FIG. 1.5. Alternatively, in the event the memory management controller 140A and, more specifically, the query interface 810 determines that query request (e.g., a read request) is not obtained and/or otherwise available (e.g., the control of block 1420 returns a result of NO), the memory management controller 1404 determines whether to continue operating, (Block 1422).

In the event the memory management controller 140A determines to continue operating (e.g., the control of block 1422) returns a result of YES, the process returns to block 1404. Alternatively, in the event the memory management controller 140A determines not to continue operating (e.g., the control of block 1422 returns a result of NO), the process stops. In examples disclosed herein, the memory management controller 140A may determine to continue operating in the event additional database vectors are obtained from the processor 102. In examples disclosed herein, the memory management controller 140A may determine not to continue operating in the event no additional database vectors are available, a loss of power event occurs, etc.

FIG. 15 is a flowchart representative of machine-readable instructions 1500 which may be executed to implement the memory management controller 140 of FIG. 1 and/or the memory management controller 140A of FIG. 8 to execute a query request.

At block 1502, the memory management controller 140A of FIG. 8 obtains the query vector. (Block 1502). In examples disclosed herein, the hash code generator 812 of FIG. 8 obtains the query vector.

At block 1504, the memory management controller 140A transforms the query vector into a binary vector (e.g., a sparse binary vector, a dense binary vector), (Block 1504). In examples disclosed herein, the hash code generator 812 transforms the query vector into a binary vector (e.g., a sparse binary vector, a dense binary vector). In examples disclosed herein, the hash code generator 812 may use the stored sparse projection matrix, W, to transform the query vector associated with the query request into a binary vector (e.g., a sparse binary vector, a dense binary vector).

At block 1506, the memory management controller 140A determines the distance between the hash code of the query vector (e.g., a vector obtained in the query request) and the database vector (e.g., the rows in the media memory 110 that correspond to the set bits in the query vector). (Block 1506). In examples disclosed herein, the query manager 814 of FIG. 8 determines the distance between the hash code of the query vector (e.g., a vector obtained in the query request) and the database vector (e.g., the rows in the media memory 110 that correspond to the set bits in the query vector). For example, the query manager 814 may calculate the Hamming distance between the hash code of the query vector (e.g., a vector obtained in the query request) and the database vector the rows in the media memory 110 that correspond to the set bits in the query vector).

At block 1508, the memory controller returns such a result to the processor 102. (Block 1508). In examples disclosed herein, the query manager 814 returns such a resulting cluster to the processor 102.

FIG. 16 is a flowchart representative of machine-readable instructions 1600 which may be executed to implement the memory management controller 140 of FIG. 1 and/or the memory management controller 140B of 9 to store data in the memory media 110 of FIG. 1 with clustering. The machine-readable instructions 1600 begin at block 1602 where the communication processor 902 identifies data in a memory (e.g., the memory media 110, the memory media 120, etc.). (Block 1602). For example, the communication processor 902 queries the memory controller 106 regarding the amount of data stored in the memory media 110. At block 1604, the aggregation manager 904 virtually partitions the data in the memory (e.g., the memory media 110, the memory media 120, etc.). (Block 1604), For example, the aggregation manager 904 virtually partitions the memory into clusters according to the clustering algorithm discussed in connection with FIG. 9.

In the illustrated example of FIG. 16, at block 1606, the aggregation manager 904 determines a centroid for each cluster. (Block 1606). For example, the aggregation manager 904 determines a centroid for a cluster by applying an aggregation operator to hash codes of data assigned to the cluster. For example, the aggregation manager 904 determines the mean, the medium, the center of mass, and/or any other measure of center of the hash codes of data assigned to a cluster to determine the centroid of the cluster. At block 1608, the communication processor 902 monitors for data to be stored in the memory. (Block 1608).

In the illustrated example of FIG. 16, at block 1610, the communication processor 902 determines whether input data to index has been received and/or otherwise obtained by the communication processor 902. (Block 1610). In response to the communication processor 902 determining, based on querying information, that query data to be searched for in the memory has not been received (e.g., the control of block 1610 returns a result of NO), the process proceeds to block 1622. In response to the communication processor 902 determining, based on indexing information, that index data to be stored in the memory has been received (e.g., the control of block 1610 returns a result of YES), the process proceeds to block 1612. At block 1612, the hash code generator 906 generates a hash code for index data to be stored in memory (e.g., the memory media 110, the memory media 120, etc.). (Block 1612). For example, the hash code generator 906 generates hash codes for data by transforming index data and/or query data in floating-point format into binary hash codes such that the Hamming distance between hash codes reflects their similarity in the input space.

In the illustrated example of FIG. 16, at block 1614, the hash code comparison manager 908 transmits the hash code of the data to the memory (e.g., the memory 104, the data storage device 114, etc.) where it is to be compared to the hash codes of the centroids. (Block 1614). At block 1616, the hash code comparison manager 908 selects the cluster correspond to the centroid that is closest to the hash code of the index data (Block 1616). For example, the hash code comparison manager 908 selects the centroid according to a k-nearest-neighbor function.

In the illustrated example of FIG. 16, at block 1618, the aggregation manager 904 associates the hash code of the index data with the cluster. (Block 1618). For example, the aggregation manager 904 applies an aggregator operator to the hash codes of the data associated with the cluster including the newly indexed data. At block 1620, the data writing controller 910 writes the index data to the selected cluster in memory (e.g., the memory 104, the data storage device 114), (Block 1620). For example, the data writing controller 910 indicates to the memory controller 106 to store the index data in the memory media 110.

In the illustrated example of FIG. 16, at block 1622, the communication processor 902 determines whether to continue operating, (Block 1622). For example, the communication processor 902 determines not to continue operating if there is no additional data to be stored in the memory (e.g., convergence, no change in the set of representatives is observed, etc.). Alternatively, the communication processor 902 determines to continue operating if there is additional data to be stored in the memory, in response to the communication processor 902 determining to continue operating (e.g., the control of block 1622 returns a result of YES), the process returns to block 1608. In response to the communication processor 902 determining not to continue operating (e, 2., the control of block 1622 returns a result of NO), the process terminates.

FIG. 17 is a flowchart representative of machine-readable instructions 1700 which may be executed to implement the memory management controller 140 of FIG. 1 and/or the memory management controller 140B of 9 to search for data in the memory media 110 of FIG. 1 with clustering. The machine-readable instructions 1700 begin at block 1702 where the communication processor 902 monitors for data to be searched for in the memory. (Block 1702).

At block 1704, the communication processor 902 determines whether input data to search for has been received and/or otherwise obtained by the communication processor 902. (Block 1704).

In the illustrated example of FIG. 17, in response to the communication processor 902 determining, based on indexing information, that index data to be stored in the memory has not been received (e.g., the control of block 1704 returns a result of NO), the process proceeds to block 1716. In response to the communication processor 902 determining, based on querying information, that query data to be searched for in the memory has been received (e.g., the control of block 1704 returns a result of YES), the process proceeds to block 1606. At block 1706, the hash code generator 906 generates a hash code for index data to be stored in memory (e.g., the memory media 110, the memory media 120, etc.). (Block 1706). For example, the hash code generator 906 generates hash codes for data by transforming index data and/or query data in floating-point format into binary hash codes such that the Hamming distance between hash codes reflects their similarity in the input space.

In the illustrated example of FIG. 17, at block 1708, the hash code comparison manager 908 transmits the hash code of the data to the memory (e.g., the memory 104, the data storage device 114, etc.) where it is to be compared to the hash codes of the centroids. (Block 1708). At block 1710, the hash code comparison manager 908 selects the cluster(s) corresponding to the centroids that is/are within a threshold of the hash code of the query data (Block 1710). For example, the hash code comparison manager 908 selects a small set of the closest centroids. The memory controller 106 searches the clusters corresponding to the selected centroids the memory media 110 (e.g., a stochastic associative memory). At block 1712, the hash code comparison manager 908 transmits the hash codes of the selected centroids to the memory to indicate that the hash code of the query data is to be compared to the hash codes of the data in the selected clusters. (Block 1712).

In the illustrated example, of FIG. 17, at block 1714, the communication processor 902 returns the results (e.g., similar data to the query) to the querying device (e.g., the querier). (Block 1714). At block 1716, the communication processor 902 determines whether to continue operating. (Block 1716). For example, the communication processor 902 determines not to continue operating if there is no additional data to be searched for in the memory. Alternatively, the communication processor 902 determines to continue operating if there is additional data to be searched for in the memory. In response to the communication processor 902 determining to continue operating (e.g., the control of block 1716 returns a result of YES), the process returns to block 1702. In response to the communication processor 902 determining not to continue operating (e.g., the control of block 1.716 returns a result of NO), the process terminates.

FIG. 18 is a flowchart representative of machine-readable instructions 1800 which may be executed to implement the memory management controller 140 of FIG. 1 and/or the memory management controller 140B of FIG. 9 to re-balance clusters of the memory media 110 of FIG. 1. In the example illustrated in FIG. 18, the cluster threshold controller 912 is configured to initialize a hash code counter to zero. (Block 1802). For example, the cluster threshold controller 912 resets a counter that counts the number of hash codes generated by the hash code generator 906. In some examples, the hash code counter counts the number of write operations received by the communication processor 902.

The example cluster threshold controller 912 monitors hash codes generated. (Block 1804). For example, the cluster threshold controller 912 is notified when the hash code generator 906 generates an input hash code for indexing. The example cluster threshold controller 912 determines if a hash code was generated. (Block 1806). For example, the cluster threshold controller 912 waits for a notification from the hash code generator 906 and/or the communication processor 902 corresponding to a new hash code to be stored in the memory media 110.

If the example cluster threshold controller 912 determines a hash code was not generated (e.g., block 1806 returns a value NO), the example cluster threshold controller 912 continues monitoring for hash codes. (Block 1804). If the example cluster -threshold controller 912 determines a hash code was generated (e.g., block 1806 returns a value YES), the example cluster threshold controller increments the hash code counter. (Block 1808). For example, the cluster threshold controller 912 counts the hash code generated.

The example cluster threshold controller 912 determines if the hash code counter exceeds a re-balance threshold. (Block 1810). For example, the cluster threshold controller 912 determines if the number of hash codes generated exceeds the threshold number of hash codes corresponding to a re-balance operation. The re-balance threshold is indicative of the maximum number input data (e.g., hash codes) the memory 104 stores before the re-balance operation is to be triggered. For example, after a certain amount of input data is obtained, the cluster threshold controller 912 determines that the memory media 110 is to be checked to ensure the clusters of input data (e.g., hash codes) are balanced.

If the example cluster threshold controller 912 determines the hash code counter has not exceeded the re-balance threshold (e.g., block 1810 returns a value NO), the example cluster threshold controller 912 continues monitoring for hash codes generated. (Block 1804). If the example cluster threshold controller 912 determines the hash code counter has exceeded the re-balance threshold (e.g., block 1810 returns a value YES), the example cluster threshold controller 912 causes the memory controller 106 to analyze the clusters. (Block 1812). For example, the cluster threshold controller 912 sends instructions to the memory controller 106 via the communication processor 902 that cause the memory controller 106 to return values corresponding to numbers of hash codes per cluster in the memory media 110.

The example cluster threshold controller 912 obtains sizes of clusters. (Block 1814). For example, the cluster threshold controller 912 obtains the values from the memory controller 106 via the communication processor 902. The example cluster threshold controller 912 determines if one or more of the clusters are unbalanced. (Block 1816). For example, the cluster threshold controller 912 determines if any of the returned sizes are greater than a balanced size. The balanced size is indicative of a number of hash codes that each cluster in the memory media 110 should have based on the number of clusters and the number of input data. For example, if there are 100 entries (e.g., input data, hash codes, etc.) stored in the memory media 110 and there are 10 clusters, then each cluster should contain and/or include 10 entries.

If the example cluster threshold controller 912 determines all of the clusters in the memory media 110 are balanced (e.g., block 1816 returns a value NO), the example cluster threshold controller 912 determines to continue operation. (Block 1824). If the example cluster threshold controller 912 determines one or more clusters are unbalanced (e.g., block 1816 returns a value YES), the example cluster threshold controller 912 selects an unbalanced cluster, (Block 1818). For example, the cluster threshold controller 912 identifies one of the clusters corresponding to an unbalanced cluster size.

The example cluster threshold controller 912 re-balances the unbalanced cluster. (Block 1820). For example, the cluster threshold controller 912 re-associates hash code(s) to different cluster(s) in order to maintain the balanced nature of the memory media 110. A more detailed description of the manner in which the operations of block 1820 are performed is provided in connection with FIG. 19 below.

The example cluster threshold controller 912 determines if there is another unbalanced cluster. (Block 1822). For example, the cluster threshold controller 912 determines if any of the other returned sizes corresponds to an unbalanced cluster. If the example cluster threshold controller 912 determines there is another unbalanced cluster (e.g., block 1822 returns a value YES), control returns to block 1818. If the example cluster threshold controller 912 determines there is not another unbalanced cluster (e.g., block 1822 returns a value NO), the example cluster threshold controller 912 determines whether to continue operation. (Block 1824).

If the example cluster threshold controller 912 determines operation is to continue (e.g., block 1824 returns a value YES), control returns to block 1802. If the example cluster threshold controller 912 determines operation is not to continue (e.g., block 1824 returns a value NO), the machine-readable instructions 1800 end.

FIG. 19 depicts machine-readable instructions 1900 that may be performed by the memory management controller 140/140B or, more particularly, the cluster threshold controller 912 to implement the operations of block 1820 of FIG. 18. With reference to FIGS. 1, 9, and 18, the example cluster threshold controller 912 determines n number of hash code(s) to be re- associated to different cluster(s). (Block 1902). For example, the cluster threshold controller 912 identifies the number of hash codes that exceed the balanced size (e.g., the number of hash codes that the cluster should have). In such an example, the n number of hash codes that exceed the balanced size is also the n number of hash codes that are to be re-associated to a new centroid in order to balance the unbalanced cluster.

The example cluster threshold controller 912 causes the memory controller 106 to compare hash codes of the unbalanced cluster to the centroid of the cluster. (Block 1904). For example, the cluster threshold controller 912 sends an instruction to the memory controller 106 via the communication processor 902 that causes the memory controller 106 to generate the distances of the hash codes to the centroid. Additionally and/or alternatively, the hash code comparison manager 908 causes the memory controller 106 to compare hash codes of the unbalanced cluster to the centroid of the unbalanced cluster. (Block 1904).

The example cluster threshold controller 912 determines the n number of hash code(s) that include the farthest distance from the centroid. (Block 1906). For example, the cluster threshold controller 912 identifies n hash codes having the farthest Hamming distance from the centroid of the unbalanced cluster. For example, the cluster threshold controller 912 selects, from all hash codes of the unbalanced cluster, those n hash codes that have the farthest Hamming distance from the centroid of the unbalanced cluster. In such an example, the n hash codes are the best candidates to be re-assigned to a new cluster to maintain the balanced nature of the memory media 110.

The example cluster threshold controller 912 causes the memory controller 106 to compare the n hash code(s) to the hash codes of the centroids. (Block 1908). For example, the cluster threshold controller 912 sends an instruction to the memory controller 106 to return Hamming distances of then hash codes from the centroids in the memory media 110. Additionally and/or alternatively, the example hash code comparison manager 908 causes the memory controller 106 to compare the n hash code(s) to the hash codes of the centroids. (Block 1908).

The example cluster threshold controller 912 selects the cluster(s), different than the unbalanced cluster, that is closest to n hash code(s). (Block 1910). For example, the cluster threshold controller 912 analyzes the returned list of distances and determines the centroid that is closest to each of the n hash codes. In some examples, if the closest centroid corresponds to the unbalanced cluster, the example cluster threshold controller 912 determines the second closest (e.g., different than the unbalanced cluster) centroid. Additionally and/or alternatively, the example hash code comparison manager 908 selects the cluster(s), different than the unbalanced cluster, that is closest to n hash code(s). (Block 1910).

The example cluster threshold controller 912 associates then number of hash code(s) of the unbalanced cluster with the selected cluster(s). (Block 1912). For example, the cluster threshold controller 912 groups, assigns, moves, etc., the n hash codes to the closest selected cluster(s) to re-balance the unbalanced cluster. Additionally and/or alternatively, the example aggregation manager 904 associates the n number of hash code(s) of the unbalanced cluster with the selected cluster(s), (Block 1912). For example, the aggregation manager 904. applies an aggregator operator to the hash codes associated with the selected cluster including the n hash codes.

The example re-balance operation 1900 ends (e.g., returns control) when the example cluster threshold controller 912 associated then hash code(s) of the unbalanced cluster to a/the different cluster(s).

FIG. 20 is a flowchart representative of machine-readable instructions 2000 which may be executed to implement the memory management controller 140 of FIG. 1 and/or the memory management controller 140B of FIG. 9 to re-balance clusters of the memory media 110 of FIG. 1. The machine-readable instructions 2000 may correspond to a second example to re- balance the memory media 110. In the example illustrated in FIG. 20, the cluster threshold controller 912 is configured to determine the number of hash codes that equal a balanced cluster size. (Block 2002). For example, the cluster threshold controller 912 is to identify how many hash codes are to be associated with each cluster in the memory media l 10 based on the number of clusters and the number of input data stored in the memory media 110.

The example cluster threshold controller 912 monitors the cluster sizes in the memory 104. (Block 2004). For example, the cluster threshold controller 912 queries the memory controller 106 via the communication processor 902 to return cluster sizes. In some examples, the querying occurs periodically, aperiodically, etc.

The example cluster threshold controller 912 determines if one of more clusters exceed the balanced size. (Block 2006). For example, the cluster threshold controller 912 determines, based on the returned sizes from the memory controller 106, whether any of the clusters include numbers of hash codes exceeding the balanced size. In some examples, if the clusters are not unbalanced (e.g., block 2006 returns a value NO), control returns to block 2004.

In some examples, if the cluster threshold controller 912 determines one or more of the clusters are unbalanced (e.g., block 2006 returns a value YES), the example cluster threshold controller 912 selects an unbalanced cluster for further processing. (Block 2008). For example, the cluster threshold controller 912 identifies one of the clusters corresponding to an unbalanced cluster size.

The example cluster threshold controller 912 re-balances the unbalanced cluster. (Block 2010). For example, the cluster threshold controller 912 re-associates hash code(s) to different cluster(s) in order to maintain the balanced nature of the memory media 110. A more detailed description of the manner in which the operations of block 2010 are performed is provided in connection with FIG. 19 above.

The example cluster threshold controller 912 determines if there is another unbalanced cluster. (Block 2012). For example, the cluster threshold controller 912 determines if any of the other returned sizes corresponds to an unbalanced cluster. If the example cluster threshold controller 912 determines there is another unbalanced cluster (e.g., block 2012 returns a value YES), control returns to block 2008, If the example cluster threshold controller 912 determines there is not another unbalanced cluster (e.g., block 2012 returns a value NO), the example cluster threshold controller 912 determines whether to continue operation. (Block 2014).

If the example cluster threshold controller 912 determines operation is to continue (e.g., block 2014 returns a value YES), control returns to block 2004. If the example cluster threshold controller 912 determines operation is not to continue (e.g., block 2014 returns a value NO), the machine-readable instructions 2000 end.

While an example manner of implementing the memory controller 106 and/or 116 of FIG. 1 is illustrated in FIG. 10, one or more of the elements, processes and/or devices illustrated in FIG. 10 may be combined, divided, re-arranged, omitted, eliminated and/or implemented in any other way. Further, the example memory interface 1002, the example memory manager 1004, the example distance meter 1006 and/or, more generally, the example memory controller 106 and/or 116 of FIG. 1 may be implemented by hardware, software, firmware and/or any combination of hardware, software and/or firmware. Thus, for example, any of the example memory interface 1002, the example memory manager 1004, the example distance meter 1006 and/or, more generally, the example memory controller 106 and/or 116 of FIGS. 1 and/or 10 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example memory interface 1002, the example memory manager 1004, and/or the example distance meter 1006 is/are hereby expressly defined to include a non-transitory computer readable storage device or storage disk such as a memory, a digital versatile disk (DVD), a compact disk (CD), a Blu-ray disk, etc. including the software and/or firmware. Further still, the example memory controller 106 and/or 116 of FIG. 1 may include one or more elements, processes and/or devices in addition to, or instead of, those illustrated in FIG. 10, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

Flowcharts representative of example hardware logic, machine readable instructions, hardware implemented state machines, and/or any combination thereof for implementing the memory controller 106 and/or 116 of FIG. 1 are shown in FIGS. 21 and/or 22. The machine readable instructions may be one or more executable programs or portion(s) of an executable program for execution by a computer processor and/or processor circuitry, such as the processor 2412 shown in the example processor platform 2400 discussed below in connection with FIG. 24. The program may be embodied in software stored on a non-transitory computer readable storage medium such as a CD-ROM, a floppy disk, a hard drive, a DVI), a Blu-ray disk, or a memory associated with the processor 2412, but the entire program and/or parts thereof could alternatively be executed by a device other than the processor 2412 and/or embodied in firmware or dedicated hardware. Further, although the example programs are described with reference to the flowcharts illustrated in FIGS. 21 and/or 22 many other methods of implementing the example memory controller 106 and/or 116 of FIG. 1 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational- amplifier (op-amp), a logic circuit, etc. structured to perform the corresponding operation without executing software or firmware. The processor circuitry may be distributed in different network locations and/or local to one or more devices (e.g., a multi-core processor in a single machine, multiple processors distributed across a server rack, etc.).

The machine-readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, where the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, Python, JavaScript, HyperText Markup Language (HTML), Structured Query Language (SQL), Swift, etc.

As mentioned above, the example processes of FIGS. 13, 14, 15, 16, 17, 18, 19, 20, 21, and 22 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B, Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 21 is a flowchart representative of machine-readable instructions 2100 which may be executed to implement the memory controller 106 of FIG. 1 and/or FIG. 10 to store data in the memory media 110 of FIG. 1. At block 2102, the memory controller 106 determines whether an instruction to store a binary vector is obtained. (Block 2102). In examples disclosed herein, the example memory interface 1002 of FIG. 10 is configured to determine whether an instruction to store a binary vector is obtained from the memory management controller 140. For example, the memory interface 1002 is configured to determine whether an instruction to store a binary vector resulting from the transform generator 804 of FIG. 8 is obtained from the memory management controller 140A of FIG. 8. In the event the memory interface 1002 determines an instruction to store a binary vector is not obtained from the memory management controller 140 (e.g., the control of block 2102 returns a result of NO), the process waits.

Alternatively, in the event the memory interface 1002 determines an instruction to store a binary vector is obtained from the memory management controller 140 (e.g., the control of block 2102 returns a result of YES), the memory controller 106 stores (e.g., inserts) the binary vector into a stochastic associative memory (e.g., the memory media 110 of FIG. 1). (Block 2104). In examples disclosed herein, the memory manager 1004 stores (e.g., inserts) the binary vector into a stochastic associative memory (e.g., the memory media 110 of FIG. 1).

At block 2106, the memory controller 106 determines whether an instruction to insert a transformed, transposed database update vector is obtained from the memory management controller 140. (Block 2106). In examples disclosed herein, the example memory interface 1002 is configured to determine whether an instruction to insert a transformed, transposed database update vector is obtained from the memory management controller 140. For example, the memory interface 1002 is configured to determine whether an instruction to insert a transformed, transposed database update vector resulting from the transform generator 804 of FIG. 8 is obtained from the memory management controller 140A of FIG. 8.

In the event the memory interface 1002 determines an instruction to store a transformed, transposed database update vector is not obtained from the memory management controller 140 (e.g., the control of block 2106 returns a result of NO), the process waits.

Alternatively, in the event the memory interface 1002 determines an instruction to insert a transformed, transposed sparse binary update vector obtained is obtained from the memory management controller 140 (e.g., control of block 2106 returns a result of YES), the memory controller 106 stores (e.g., inserts) the transformed, transposed sparse binary update vector row-wise in the stochastic associative memory (e.g., the memory media 110). (Block 2108). In examples disclosed herein, the memory manager 1004 stores (e.g., inserts) the transformed, transposed sparse binary update vector into a stochastic associative memory (e.g., the memory media 110 of FIG. 1).

FIG. 22 is a flowchart representative of machine-readable instructions 2200 which may be executed to implement the memory controller 106 of FIGS. 1 and/or 10 to handle hash code comparisons offloaded from the memory management controller 140. The machine- readable instructions 2200 begin at block 2202 where the memory interface 1002 monitors for one or more hash codes of data (Block 2202). At block 2204, the memory interface 1002 determines whether hash codes have been received and/or otherwise obtained, (Block 2204),

In the illustrated example of FIG. 22, at block 2206, the distance meter 1006 determines the distance between a hash code of data and the hash codes of centroids of clusters in the memory media 110 (e.g., a stochastic associative memory), (Block 2206), For example, the distance meter 1006 determines the Hamming distance between the index data and/or the query data and the centroids. In additional or alternative examples, other measures of distance can be utilized. At block 2208, the memory interface 1002 transmits the distances between the one or more hash codes of data and the hash codes of the centroids to the memory management controller 140 (e.g., the memory management controller 1409). (Block 2208).

In the illustrated example of FIG. 22, at block 2210, the memory interface 1002 determines whether the memory controller 106 has received a selection of clusters within which to search for query data (e.g., indicative of a querying operation), (Block 2210). In response to the memory interface 1002 receiving no selection (e.g., the control of block 2210 returns a result of NO), the process proceeds to block 2216. In response to the memory interface 1002 receiving a selection of clusters (e.g., the control of block 2210 returns a result of YES), the process proceeds to block 2 1 . At block 2212, the distance meter 1006 determines the distance between the hash code of the query data and the hash codes of the data in the selected clusters. (Block 2212). For example, the distance meter 1006 takes the union of the hash codes in the data in the selected clusters and retrieving the most similar elements in this set. For example, the distance meter 1006 determines the Hamming distance between the query data and the hash codes of the data in the selected clusters.

In the illustrated example of FIG. 22, at block 2214, the memory interface 1002 transmits the distance between the one or more hash codes of the query data and the hash codes of the data in the selected clusters, to the memory management controller 140 (e.g., the memory management controller 140B). (Block 2214). At block 2216, the memory interface 1002 monitors for an instruction to store index data (Block 2216). At block 2218, the memory interface 1002 determines whether the memory controller 106 has received an instruction to store index data (Block 2218). In response to the memory interface 1002 receiving no instruction to store index data (e.g., the control of block 2218 returns a result of NO), the process returns to block 2216. In response to the memory interface 1002 receiving an instruction to store index data (e.g., the control of block 2218 returns a result of YES), the process proceeds to block 2220.

102421 In the illustrated example of FIG. 22, at block 2220, the memory manager 1004 stores (e.g., inserts) the index data in the memory media 110 of FIG. 1 (e.g., a stochastic associative memory). (Block 2220). At block 2222, the memory interface 1002 determines whether to continue operating. (Block 2222). For example, the memory interface 1002 determines not to continue operating if there is no additional data to be indexed into and/or searched for in the stochastic associative memory. Alternatively, the memory interface 1002 determines to continue operating if there is additional data to be indexed into and/or searched for in the stochastic associative memory. In response to the memory interface 1002 determining to continue operating (e.g., the control of block 2222 returns a result of YES), the process returns to block 2202. In response to determining to memory interface 1002 determining not to continue operating (e.g., the control of block 2222 returns a result of NO), the process terminates.

FIG. 23 is a block diagram of an example processor platform 2300 structured to execute the instructions of FIGS. 13, 14, 15, 16, 17, 18, 19, and/or 20 to implement the example memory management controller 140 of FIG. 1, the example memory management controller 140A of FIG. 8, and/or the example memory management controller 140B of FIG. 9. The processor platform 2300 can be, for example, a server, a personal computer, a workstation, a self- learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Btu-ray player, a gaming console, a personal video recorder, a set top box, a headset or other wearable device, or any other type of computing device.

The processor platform 2300 of the illustrated example includes a processor 2312. The processor 2312 of the illustrated example is hardware. For example, the processor 2312 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example vector interface 802, the example transform generator 804, the example update manager 806, the example transpose generator 808, the example query interface 810, the example hash code generator 812, the example query manager 814, the example communication processor 902, the example aggregation manager 904, the example hash code generator 906, the example hash code comparison manager 908, the example data writing controller 910, and/or the example cluster threshold controller 912.

The processor 2312 of the illustrated example includes a local memory 2313 (e.g., a cache). The processor 2312 of the illustrated example is in communication with a main memory including a volatile memory 2314 and a non-volatile memory 2316 via a bus 2318. The volatile memory 2314 may be implemented by Synchronous Dynamic Random-Access Memory (SDRAM), Dynamic Random-Access Memory (DRAM), RAMBUS® Dynamic Random-Access Memory (RDRAM®) and/or any other type of random-access memory device. The non-volatile memory 2316 may be implemented by flash memory and/or any other desired type of memory device. Access to the main memory 2314, 2316 is controlled by a memory controller.

The processor platform 2300 of the illustrated example also includes an interface circuit 2320. The interface circuit 2320 may be implemented by any type of interface standard, such as an Ethernet interface, a universal serial bus (USB), a Bluetooth® interface, a near field communication (NFC) interface, and/or a PCI express interface.

In the illustrated example, one or more input devices 2322 are connected to the interface circuit 2320. The input device(s) 2322 permit(s) a user to enter data and/or commands into the processor 2312. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 2324 are also connected to the interface circuit 2320 of the illustrated example. The output devices 2324 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 232.0 of the illustrated example, thus, typically includes a graphics driver card, a graphics driver chip, and/or a graphics driver processor.

The interface circuit 2320 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 2326. The communication can be via, for example, an Ethernet connection, a digital subscriber line (DSL) connection, a telephone line connection, a coaxial cable system, a satellite system, a line-of-site wireless system, a cellular telephone system, etc.

The processor platform 2300 of the illustrated example also includes one or more mass storage devices 2328 for storing software and/or data. Examples of such mass storage devices 2328 include floppy disk drives, hard drive disks, compact disk drives, Blu-ray disk drives, redundant array of independent disks (RAID) systems, and digital versatile disk (DVD) drives.

The machine executable instructions 2332 of FIGS. 13, 14, 15, 16, 17, 18, 19, and/or 20 may be stored in the mass storage device 2328, in the volatile memory 2314, in the non-volatile memory 2316, and/or on a removable non-transitory computer readable storage medium such as a CD or DVD.

FIG. 24 is a block diagram of an example processor platform 2400 structured to execute the instructions of FIGS. 21 and/or 22 to implement the example memory controller 106 and/or 116 of FIGS. 1 and/or 10. The processor platform 2400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 2400 of the illustrated example includes a processor 2412. The processor 2412 of the illustrated example is hardware. For example, the processor 2412 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example memory interface 1002, the example memory manager 1004, the example distance meter 1006.

The processor 2412 of the illustrated example includes a local memory 2413 (e.g., a cache). The processor 2412 of the illustrated example is in communication with a main memory including a volatile memory 2414 and a non-volatile memory 2416 via a bus 2418. The volatile memory 2414 may be implemented by Synchronous Dynamic Random-Access Memory (SDRAM), Dynamic Random-Access Memory (DRAM), RAMBUS® Dynamic Random-Access Memory (RDRAM) and/or any other type of random-access memory device. The non-volatile memory 2416 may be implemented by flash memory and/or any other desired type of memory device. Access to the main memory 2414, 2416 is controlled by a memory controller.

The processor platform 2400 of the illustrated example also includes an interface circuit 2420. The interface circuit 2420 may be implemented by any type of interface standard, such as an Ethernet interface, a universal serial bus (USB), a Bluetooth® interface, a near field communication (NFC) interface, and/or a PCI express interface.

In the illustrated example, one or more input devices 2422 are connected to the interface circuit 2420. The input device(s) 2422 permit(s) a user to enter data and/or commands into the processor 2412. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 2424 are also connected to the interface circuit 2420 of the illustrated example. The output devices 2424 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 2420 of the illustrated example, thus, typically includes a graphics driver card, a graphics driver chip, and/or a graphics driver processor.

The interface circuit 2420 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 2426. The communication can be via, for example, an Ethernet connection, a digital subscriber line (DSL) connection, a telephone line connection, a coaxial cable system, a satellite system, a line-of-site wireless system, a cellular telephone system, etc.

The processor platform 2400 of the illustrated example also includes one or more mass storage devices 2428 for storing software and/or data. Examples of such mass storage devices 2428 include floppy disk drives, hard drive disks, compact disk drives, Blu-ray disk drives, redundant array of independent disks (RAID) systems, and digital versatile disk (DVD) drives.

The machine executable instructions 2432 of FIGS. 21 and/or 22 may be stored in the mass storage device 2428, in the volatile memory 2414, in the non-volatile memory 2416, and/or on a removable non-transitory computer readable storage medium such as a CD or DVD.

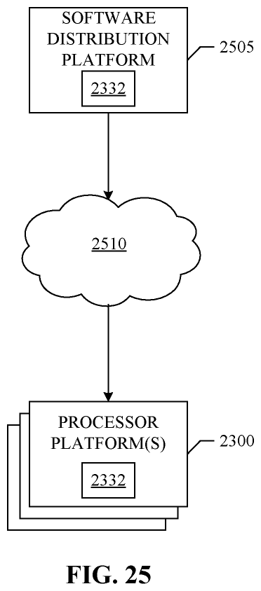

A block diagram illustrating an example software distribution platform 2505 to distribute software such as the example computer readable instructions 2332 of FIG. 23 to devices owned and/or operated by third parties is illustrated in FIG. 25. The example software distribution platform 2505 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 2332 of FIG. 23. The third parties may be consumers, users, retailers, OEMs, etc., who purchase and/or license the software for use and./or re-sale and/or sub-licensing. In the illustrated example, the software distribution platform 2505 includes one or more servers and one or more storage devices. The storage devices store the computer readable instructions 2332, which may correspond to the example computer readable instructions 1300, 1400, 1500, 1600, 1700, 1800, 1900, and/or 2000 of FIGS. 13, 14, 15, 16, 17, 18, 19, and/or 20, as described above. The one or more servers of the example software distribution platform 2505 are in communication with a network 2510, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers, licensors, and/or licensees to download the computer readable instructions 2332 from the software distribution platform 2505 to one or more devices owned and/or operated by the purchasers and/or licensees. For example, the software, which may correspond to the example computer readable instructions 1300, 1400, 1500, 1600, 1700, 1800, 1900, and/or 2000 of FIGS. 13, 14, 15, 16, 17, 18, 19, and/or 20, may be downloaded to the example processor platform 2300, which is to execute the computer readable instructions 2332 to implement the example memory management controller 140 of FIG. 1, the example memory management controller 140A of FIG. 8, and/or the example memory management controller 1403 of FIG. 9. In some examples, one or more servers of the software distribution platform 2505 periodically offer, transmit, and/or force updates to the software (e.g., the example computer readable instructions 2332 of FIG. 23) to ensure improvements, patches, updates, etc. are distributed and applied to the software at the end user devices.

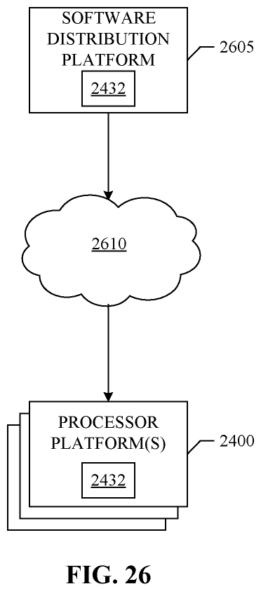

A block diagram illustrating an example software distribution platform 2605 to distribute software such as the example computer readable instructions 2432 of FIG. 24 to devices owned and/or operated by third parties is illustrated in FIG. 26. The example software distribution platform 2605 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 2432 of FIG. 24. The third parties may be consumers, users, retailers, OEMs, etc., who purchase and/or license the software for use and/or re-sale and/or sub-licensing. In the illustrated example, the software distribution platform 2605 includes one or more servers and one or more storage devices. The storage devices store the computer readable instructions 2432, which may correspond to the example computer readable instructions 2100 and/or 2200 of FIGS. 21 and/or 22 as described above. The one or more servers of the example software distribution platform 2605 are in communication with a network 2610, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers, licensors, and/or licensees to download the computer readable instructions 2432 from the software distribution platform 2605 to one or more devices owned and/or operated by the purchasers and/or licensees. For example, the software, which may correspond to the example computer readable instructions 2100 and/or 2200 of FIGS. 21 and/or 22, may be downloaded to the example processor platform 2400, which is to execute the computer readable instructions 2432 to implement the example memory controller 106 and/or 116 of FIGS. 1 and/or 10. In some examples, one or more servers of the software distribution plat-form 2605 periodically offer, transmit, and/or force updates to the software (e.g., the example computer readable instructions 2432 of FIG. 24) to ensure improvements, patches, updates, etc. are distributed and applied to the software at the end user devices.

From the foregoing, it will be appreciated that example methods, apparatus and articles of manufacture have been disclosed that facilitate improved use of stochastic associative memory. Examples disclosed herein facilitate vastly improved algorithms for databases, similarity search, genomics, among others. The example column access disclosed herein facilitate new algorithms that access 1/1000^{th} of the data as those using conventional memory (e.g., conventional DRAM). Examples disclosed herein improve the performance of computing devices by an order of magnitude over conventional techniques.

Additionally, examples disclosed herein do not require two sets of data (e.g., one normal and the other transposed) thus improving memory capacity by two times and reducing latency of memory related operations. Examples disclosed herein accelerate clustering-related operations and introduce new algorithms that work in conjunction with a stochastic associative memory to accelerate both indexing and searching.

Examples disclosed herein control the latency of a computing system and ensure a consistent performance across different queries, Because the query performance of stochastic associative memory-related operations depends linearly on the size of the clusters, examples disclosed herein ensure that no cluster in the database exceeds a prescribed size, ensuring a consistently fast latency.

Examples disclosed herein accelerate similarity search systems and ensure that latency does not drop below a pre-specified level. Examples disclosed herein optimize the amount data being transferred from memory to the host, enabling state-of-the-art performance (e.g., 10-100 of thousands of queries per second), The disclosed methods, apparatus and articles of manufacture improve the efficiency of using a computing device by at least improving memory capacity, indexing operations, querying operations, and the balancing of cluster sizes to reduce latency in searching. The disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

Example methods, apparatus, systems, and articles of manufacture to facilitate improved use of stochastic associative memory are disclosed herein. Further examples and combinations thereof include the following:

Example 1 includes an apparatus to facilitate a search of a memory, the apparatus comprising a vector interface to obtain a first database vector, a transform generator to in response to obtaining the first database vector, use a stored sparse projection matrix to transform the database vector into a first binary vector, and transmit a first instruction to a memory controller to store the first binary vector in the memory in a row-wise manner,

In Example 2, the subject matter of Example 1 can optionally include that the transform generator is to, in response to obtaining a database update vector, transform the database update vector into a second binary vector using the stored sparse projection matrix.

In Example 3, the subject matter of Examples 1-2 can optionally include that the transform generator is to transmit a second instruction to store the second binary vector in the memory in the row-wise manner.

In Example 4, the subject matter of Examples 1-3 can optionally include a transpose generator to transpose the first binary vector into a transposed binary vector.

In Example 5, the subject matter of Examples 1-4 can optionally include that the transform generator is to transmit a second instruction to the memory controller to store the transposed binary vector in the memory in a column-wise manner.

In Example 6, the subject matter of Examples 1-5 can optionally include that the memory is a stochastic associative memory.

In Example 7, the subject matter of Examples 1-6 can optionally include that the transform generator uses random sparse lifting to transform the first database vector into the first binary vector.

Example 8 includes a non-transitory computer readable medium comprising instructions that, when executed, cause at least one processor to obtain a first database vector, in response to obtaining the first database vector, transform the first database vector into a first binary vector using a stored sparse projection matrix, and transmit a first instruction to a memory controller to store the binary vector in a memory in a row-wise manner.

In Example 9, the subject matter of Example 8 can optionally include that the instructions, when executed, cause the at least one processor to, in response to obtaining a database update vector, transform the database update vector into a second binary vector using the stored sparse projection matrix.

In Example 10, the subject matter of Examples 8-9 can optionally include that the instructions, when executed, cause the at least one processor to transmit a second instruction to store the second binary vector in the memory in the row-wise manner,

In Example 11, the subject matter of Examples 8-10 can optionally include that the instructions, when executed, cause the at least one processor to transpose the first binary vector into a transposed binary vector.

In Example 12, the subject matter of Examples 8-11 can optionally include that the instructions, when executed, cause the at least one processor to transmit a second instruction to the memory controller to store the transposed binary vector in the memory in a column-wise manner.

In Example 13, the subject matter of Examples 8-12 can optionally include that the memory is a stochastic associative memory.

In Example 14, the subject matter of Examples 8-13 can optionally include that the instructions, when executed, cause the at least one processor to use random sparse lifting to transform the first database vector into the first binary vector.

Example 15 includes a method to facilitate a search of a memory, the method comprising obtaining a first database vector, in response to obtaining the first database vector, transforming the first database vector into a first binary vector using a stored sparse projection matrix, and transmitting a first instruction to a memory controller to store the first binary vector in the memory in a row-wise manner.

In Example 16, the subject matter of Example 15 can optionally include, in response to obtaining a database update vector, transforming the database update vector into a second binary vector using the stored sparse projection matrix.

In Example 17, the subject matter of Examples 15-16 can optionally include transmitting a second instruction to store the second binary vector in the memory in the row-wise manner.

In Example 18, the subject matter of Examples 15-17 can optionally include transposing the first binary vector into a transposed binary vector.

In Example 19, the subject matter of Examples 15-18 can optionally include transmitting a second instruction to the memory controller to store the transposed binary vector in the memory in a column-wise manner.

In Example 20, the subject matter of Examples 15-19 can optionally include that the memory is a stochastic associative memory.

In Example 21, the subject matter of Examples 15-20 can optionally include transforming the first database vector into the first binary vector using random sparse lifting.

Example 22 includes an apparatus to facilitate a search of a memory, the apparatus comprising means for obtaining a first database vector, means for transforming to in response to obtaining the first database vector, transform the first database vector into a first binary vector using a stored sparse projection matrix, and transmit a first instruction to a memory controller to store the first binary vector in the memory in a row-wise manner.

In Example 23, the subject matter of Example 22 can optionally include that the means for transforming is to, in response to obtaining a database update vector, transform the database update vector into a second binary vector using the stored sparse projection matrix.

In Example 24, the subject matter of Examples 22-23 can optionally include that the means for transforming is to transmit a second instruction to store the second binary vector in the memory in the row-wise manner.

In Example 25, the subject matter of Examples 22-24 can optionally include means for transposing the first binary vector into a transposed binary vector.

In Example 26, the subject matter of Examples 22-25 can optionally include that the means for transforming is to transmit a second instruction to the memory controller to store the transposed binary vector in the memory in a column-wise manner.

In Example 27, the subject matter of Examples 22-26 can optionally include that the memory is a stochastic associative memory.

In Example 28, the subject matter of Examples 22-27 can optionally include that the means for transforming is to transform the first database vector into the first binary vector using random sparse

Example 29 includes a server to distribute first instructions on a network, the server comprising at least one storage device including second instructions, and at least one processor to execute the second instructions to transmit the first instructions over the network, the first instructions, when executed, to cause at least one device to obtain a first database vector, in response to obtaining the first database vector, transform the first database vector into a first binary vector using a stored sparse projection matrix, and transmit a third instruction to a memory controller to store the first binary vector in a memory in a row-wise manner.

In Example 30, the subject matter of Example 29 can optionally include that the first instructions, when executed, cause the at least one device to, in response to obtaining a database update vector, transform the database update vector into a second binary vector using the stored sparse projection matrix.

In Example 31, the subject matter of Examples 29-30 can optionally include that the first instructions, when executed, cause the at least one device to transmit a fourth instruction to store the second binary vector in the memory in the row-wise manner.

In Example 32, the subject matter of Examples 29-31 can optionally include that the first instructions, when executed, cause the at least one device to transpose the first binary vector into a transposed binary vector.

In Example 33, the subject matter of Examples 29-32 can optionally include that the first instructions, when executed, cause the at least one device to transmit a second instruction to the memory controller to store the transposed binary vector in the memory in a column-wise manner.

In Example 34, the subject matter of Examples 29-33 can optionally include that the memory is a stochastic associative memory.

In Example 35, the subject matter of Examples 29-34 can optionally include that the first instructions, when executed, cause the at least one device to use random sparse lifting to transform the first database vector into the first binary vector.

Example 36 includes an apparatus to facilitate storage of data in memory, the apparatus comprising a hash code generator to determine a hash code of input data to be stored in the memory, a hash code comparison manager to transmit the hash code to a memory controller associated with the memory to be compared with centroids of clusters of data stored in the memory, and select a first one of the clusters corresponding to a first one of the centroids that is closest to the hash code, and an aggregation manager to associate the hash code with the first one of the clusters.

In Example 37, the subject matter of Example 36 can optionally include that the centroids correspond to hash codes representative of the clusters.

In Example 38, the subject matter of Examples 36-37 can optionally include that the clusters correspond to representative groupings of the data stored in the memory.

In Example 39, the subject matter of Examples 36-38 can optionally include that the hash code comparison manager is to transmit the hash code to the memory controller to cause the memory controller to determine distances between the hash code and the centroids of the clusters of the data stored in the memory.

In Example 40, the subject matter of Examples 36-39 can optionally include that the aggregation manager is to apply an aggregator operator to the hash code and hash codes of data associated with the -first one of the clusters.

In Example 41, the subject matter of Examples 36-40 can optionally include that the hash code generator is to select the first one of the clusters according to a k-nearest-neighbor function.

In Example 42, the subject matter of Examples 36-41 can optionally include a data writing controller to indicate to the memory controller to store the input data in the memory.

Example 43 includes a non-transitory computer readable medium comprising instructions that, when executed, cause at least one processor to determine a hash code of input data to be stored in memory, transmit the hash code to a memory controller associated with the memory to be compared with centroids of clusters of data stored in the memory, and select a first one of the clusters corresponding to a first one of the centroids that is closest to the hash code, and associate the hash code with the first one of the clusters.

In Example 44, the subject matter of Example 43 can optionally include that the centroids correspond to hash codes representative of the clusters.

In Example 45, the subject matter of Examples 43-44 can optionally include that the clusters correspond to representative groupings of the data stored in the memory.

In Example 46, the subject matter of Examples 43-45 can optionally include that the instructions, when executed, cause the at least one processor to transmit the hash code to the memory controller to cause the memory controller to determine distances between the hash code and the centroids of the clusters of the data stored in the memory.

In Example 47, the subject matter of Examples 43-46 can optionally include that the instructions, when executed, cause the at least one processor to apply an aggregator operator to the hash code and hash codes of data associated with the first one of the clusters.

In Example 48, the subject matter of Examples 43-47 can optionally include that the instructions, when executed, cause the at least one processor to select the first one of the clusters according to a k-nearest-neighbor function.

In Example 49, the subject matter of Examples 43-48 can optionally include that the instructions, when executed, cause the at least one processor to indicate to the memory controller to store the input data in the memory.

Example 50 includes a method to facilitate storage of data in memory, the method comprising determining a hash code of input data to be stored in the memory, transmitting the hash code to a memory controller associated with the memory to be compared with centroids of clusters of data stored in the memory, and selecting a first one of the clusters corresponding to a first one of the centroids that is closest to the hash code, and associating the hash code with the first one of the clusters,

In Example 51, the subject matter of Example 50 can optionally include that the centroids correspond to hash codes representative of the clusters.

In Example 52, the subject matter of Examples 50-51 can optionally include that the clusters correspond to representative groupings of the data stored in the memory.

In Example 53, the subject matter of Examples 50-52 can optionally include transmitting the hash code to the memory controller to cause the memory controller to determine distances between the hash code and the centroids of the clusters of the data stored in the memory.

In Example 54, the subject matter of Examples 50-53 can optionally include applying an aggregator operator to the hash code and hash codes of data associated with the first one of the clusters.

In Example 55, the subject matter of Examples 50-54 can optionally include selecting the first one of the clusters according to a k-nearest-neighbor function.

In Example 56, the subject matter of Examples 50-55 can optionally include indicating to the memory controller to store the input data in the memory.

Example 57 includes an apparatus to facilitate storage of data in memory, the apparatus comprising means for generating hash codes to determine a hash code of input data to be stored in the memory, means for managing hash code comparisons to transmit the hash code to a memory controller associated with the memory to be compared with centroids of clusters of data stored in the memory, and select a first one of the clusters corresponding to a first one of the centroids that is closest to the hash code, and means for aggregating to associate the hash code with the first one of the clusters.

In Example 58, the subject matter of Example 57 can optionally include that the centroids correspond to hash codes representative of the clusters.

In Example 59, the subject matter of Examples 57-58 can optionally include that the clusters correspond to representative groupings of the data stored in the memory.

In Example 60, the subject matter of Examples 57-59 can optionally include that the means for managing hash code comparisons are to transmit the hash code to the memory controller to cause the memory controller to determine distances between the hash code and the centroids of the clusters of the data stored in the memory.

In Example 61, the subject matter of Examples 57-60 can optionally include that the means for aggregating are to apply an aggregator operator to the hash code and hash codes of data associated with the -first one of the clusters.

In Example 62, the subject matter of Examples 57-61 can optionally include that the means for generating hash codes are to select the first one of the clusters according to a k- nearest-neighbor function.

In Example 63, the subject matter of Examples 57-62 can optionally include means for writing data to indicate to the memory controller to store the input data in the memory.

Example 64 includes a server to distribute first instructions on a network, the server comprising at least one storage device including second instructions, and at least one processor to execute the second instructions to transmit the first instructions over the network, the first instructions, when executed, to cause at least one device to determine a hash code of input data to be stored in memory, transmit the hash code to a memory controller associated with the memory to be compared with centroids of clusters of data stored in the memory, and select a first one of the clusters corresponding to a first one of the centroids that is closest to the hash code, and associate the hash code with the first one of the clusters.

In Example 65, the subject matter of Example 64 can optionally include that the centroids correspond to hash codes representative of the clusters.

In Example 66, the subject matter of Examples 64-65 can optionally include that the clusters correspond to representative groupings of the data stored in the memory.

In Example 67, the subject matter of Examples 64-66 can optionally include that the first instructions, when executed, cause the at least one device to transmit the hash code to the memory controller to cause the memory controller to determine distances between the hash code and the centroids of the clusters of the data stored in the memory.

In Example 68, the subject matter of Examples 64-67 can optionally include that the first instructions, when executed, cause the at least one device to apply an aggregator operator to the hash code and hash codes of data associated with the first one of the clusters.

In Example 69, the subject matter of Examples 64-68 can optionally include that the first instructions, when executed, cause the at least one device to select the first one of the clusters according to a k-nearest-neighbor function.

In Example 70, the subject matter of Examples 64-69 can optionally include that the first instructions, when executed, cause the at least one device to indicate to the memory controller to store the input data in the memory.

Example 71 includes an apparatus to bound data in a memory, the apparatus comprising a cluster threshold controller to determine that a first number of hash codes stored in the memory exceeds a threshold, in response to the first number of hash codes exceeding the threshold, query a memory controller for sizes of clusters in the memory, and determine, based on the query, that a first cluster includes an unbalanced size and a hash code comparison manager to select second clusters to associate with second hash codes corresponding to the first cluster based on a proximity of centroids of the second clusters to the second hash codes, the association of the second hash codes to bound hash codes stored in the memory,

In Example 72, the subject matter of Example 71 can optionally include that the hash code comparison manager is to cause the memory controller to compare the second hash codes corresponding to the first cluster with centroids of data stored in the memory.

In Example 73, the subject matter of Examples 71-72 can optionally include that the hash code comparison manager is to determine to select the second clusters based on the centroids of the second clusters being closest to the second hash codes.

In Example 74, the subject matter of Examples 71-73 can optionally include that the cluster threshold controller is to determine a balanced size of clusters in the memory indicative of a balanced number of hash codes per cluster in the memory, and determine a second number, indicative of a number of the second hash codes, to be re-associated to a different cluster than the first cluster based on a difference between a total number of hash codes associated with the first cluster and the balanced size.

In Example 75, the subject matter of Examples 71-74 can optionally include that the hash code comparison manager is to cause the memory controller to compare hash codes associated with the first cluster to a centroid of the first cluster.

In Example 76, the subject matter of Examples 71-75 can optionally include that the cluster threshold controller is to determine values of the second hash codes corresponding to the first cluster that include a farthest distance from the centroid of the first cluster.

In Example 77, the subject matter of Examples 71-76 can optionally include an aggregation manager to assign values of the second hash codes to the second clusters to re- balance the first cluster and apply an aggregator operator to the values of the second hash codes and hash codes of data associated with the second clusters.

Example 78 includes a non-transitory computer readable medium comprising instructions that, when executed, cause at least one processor to determine that a first number of hash codes stored in a memory exceeds a threshold, in response to the first number of hash codes exceeding the threshold, query a memory controller for sizes of clusters in the memory, and determine, based on the query, that a first cluster includes an unbalanced size, select second clusters to associate with second hash codes corresponding to the first cluster based on a proximity of centroids of the second clusters to the second hash codes, the association of the second hash codes to bound hash codes stored in the memory.

In Example 79, the subject matter of Example 78 can optionally include that the instructions, when executed, cause the at least one processor to cause the memory controller to compare the second hash codes corresponding to the first cluster with centroids od data stored in the memory.

In Example 80, the subject matter of Examples 78-79 can optionally include that the instructions, when executed, cause the at least one processor to determine to select the second clusters based on the centroids of the second clusters being closest to the second hash codes.

In Example 81, the subject matter of Examples 78-80 can optionally include that the instructions, when executed, cause the at least one processor to determine a balanced size of clusters in the memory indicative of a balanced number of hash codes per cluster in the memory, and determine a second number, indicative of a number of the second hash codes, to be re-associated to a different cluster than the first cluster based on a difference between a total number of hash codes associated with the first cluster and the balanced size.

In Example 82, the subject matter of Examples 78-81 can optionally include that the instructions; when executed; cause the at least one processor to cause the memory controller to compare hash codes associated with the first cluster to a centroid of the first cluster.

In Example 83, the subject matter of Examples 78-82 can optionally include that the instructions, when executed, cause the at least one processor to determine values of the second hash codes corresponding to the first cluster that include a farthest distance from the centroid of the first cluster.

In Example 84, the subject matter of Examples 78-83 can optionally include that the instructions; when executed; cause the at least one processor to assign values of the second hash codes to the second clusters to re-balance the first cluster.

Example 85 includes a method to bound data in a memory, the method comprising determining that a first number of hash codes stored in the memory exceeds a threshold, in response to the first number of hash codes exceeding the threshold, querying a memory controller for sizes of clusters in the memory, and determining, based on the query, that a first cluster includes an unbalanced size, selecting second clusters to associate with second hash codes corresponding to the first cluster based on a proximity of centroids of the second clusters to the second hash codes, the association of the second hash codes to bound hash codes stored in the memory.

In Example 86, the subject matter of Example 85 can optionally include causing the memory controller to compare the second hash codes corresponding to the first cluster with centroids od. data stored in the memory.

In Example 87, the subject matter of Examples 85-86 can optionally include determining to select the second clusters based on the centroids of the second clusters being closest to the second hash codes.

In Example 88, the subject matter of Examples 85-87 can optionally include determining a balanced size of clusters in the memory indicative of a balanced number of hash codes per cluster in the memory; and determining a second number, indicative of a number of the second hash codes, to hash codes to be re-associated to a different cluster than the first cluster based on a difference between a total number of hash codes associated with the first cluster and the balanced size.

In Example 89, the subject matter of Examples 85-88 can optionally include causing the memory controller to compare hash codes associated with the first cluster to a centroid of the first cluster.

In Example 90, the subject matter of Examples 85-89 can optionally include determining values of the second hash codes corresponding to the first cluster that include a farthest distance from the centroid of the first cluster.

In Example 91, the subject matter of Examples 85-90 can optionally include assigning values of the second hash codes to the second clusters to re-balance the first cluster, wherein assigning values of the second hash codes to the second clusters includes applying an aggregator operator to the values of the second hash codes and hash codes of data associated with the second clusters.

Example 92 includes an apparatus to bound data in a memory, the apparatus comprising means for controlling cluster sizes to: determine that a first number of hash codes stored in the memory exceeds a threshold; and in response to the first number of hash codes exceeding the threshold: query a memory controller for sizes of clusters in the memory; and determine, based on the query, that a first cluster includes an unbalanced size; means for managing hash code comparisons to select second clusters to associate with second hash codes corresponding to the first cluster based on a proximity of centroids of the second clusters to the second hash codes, the association of the second hash codes to bound hash codes stored in the memory.

In Example 93, the subject matter of Example 92 can optionally include that the means for managing hash code comparisons is to cause the memory controller to compare the second hash codes corresponding to the first cluster with centroids of data stored in the memory,

In Example 94, the subject matter of Examples 92-93 can optionally include that means for managing hash code comparisons is to determine to select the second clusters based on the centroids of the second clusters being closest to the second hash codes.

In Example 95, the subject matter of Examples 92-94 can optionally include that the means for controlling cluster sizes is to determine a balanced size of clusters in the memory indicative of a balanced number of hash codes per cluster in the memory; and determine a second number, indicative of a number of the second hash codes, to be re-associated to a different cluster than the first cluster based on a difference between a total number of hash codes associated with the first cluster and the balanced size.

In Example 96, the subject matter of Examples 92-95 can optionally include that the means for managing hash code comparisons is to cause the memory controller to compare hash codes associated with the first cluster to a centroid of the first cluster.

In Example 97, the subject matter of Examples 92-96 can optionally include that the means for controlling cluster sizes is to determine values of the second hash codes corresponding to the first cluster that include a farthest distance from the centroid of the first cluster.

In Example 98, the subject matter of Examples 92-97 can optionally include means for aggregating to assign values of the second hash codes to the second clusters to re- balance the first cluster and apply an aggregator operator to the values of the second hash codes and hash codes of data associated with the second clusters.

Example 99 includes a server to distribute first instructions on a network, the server comprising at least one storage device including second instructions, and at least one processor to execute the second instructions to transmit the first instructions over the network, the first instructions, when executed, to cause at least one device to determine that a first number of hash codes stored in a memory exceeds a threshold; in response to the first number of hash codes exceeding the threshold: query a memory controller for sizes of clusters in the memory; and determine, based on the query, that a first cluster includes an unbalanced size; select second clusters to associate with second hash codes corresponding to the first cluster based on a proximity of centroids of the second clusters to the second hash codes, the association of the second hash codes to bound hash codes stored in the memory.

In Example 100, the subject matter of Example 99 can optionally include that the first instructions, when executed, cause the at least one device to cause the memory controller to compare the second hash codes corresponding to the first cluster with centroids od data stored in the memory.

In Example 101, the subject matter of Examples 99-100 can optionally include that the first instructions, when executed, cause the at least one device to determine to select the second clusters based on the centroids of the second clusters being closest to the second hash codes.

In Example 102, the subject matter of Examples 99-101 can optionally include that the -first instructions, when executed, cause the at least one device to determine a balanced size of clusters in the memory indicative of a balanced number of hash codes per cluster in the memory; and determine a second number, indicative of a number of the second hash codes, to be re-associated to a different cluster than the first cluster based on a difference between a total number of hash codes associated with the first cluster and the balanced size.

In Example 103, the subject matter of Examples 99-102 can optionally include that the first instructions, when executed, cause the at least one device to cause the memory controller to compare hash codes associated with the first cluster to a centroid of the first cluster.

In Example 104, the subject matter of Examples 99-103 can optionally include that the first instructions, when executed, cause the at least one device to determine values of the second hash codes corresponding to the first cluster that include a farthest distance from the centroid of the first cluster.

In Example 105, the subject matter of Examples 99-104 can optionally include that the first instructions, when executed, cause the at least one device to assign values of the second hash codes to the second clusters to re-balance the first cluster and apply an aggregator operator to the values of the second hash codes and hash codes of data associated with the second clusters.

Example 106 is an edge computing gateway, comprising processing circuitry to perform any of Examples 15-21.

Example 107 is a base station, comprising a network interface card and processing circuitry to perform any of Examples 15-21.

Example 108 is a computer-readable medium comprising instructions to perform any of Examples 15-21.

Example 109 is an edge computing gateway, comprising processing circuitry to perform any of Examples 50-56.

Example 110 is a base station, comprising a network interface card and processing circuitry to perform any of Examples 50-56.

Example 111 is a computer-readable medium comprising instructions to perform any of Examples 50-56.

Example 112 is an edge computing gateway, comprising processing circuitry to perform any of Examples 85-91.

Example 113 is a base station, comprising a network interface card and processing circuitry to perform any of Examples 85-91.

Example 114 is a computer-readable medium comprising instructions to perform any of Examples 85-91.

Example 115 includes an apparatus to improve computational operations of a stochastic associative memory, the apparatus comprising a hash code generator to generate a hash code for input data to be stored in the stochastic associative memory, the stochastic associative memory including one or more database vectors, a hash code comparison manager to compare the hash code with centroids of clusters of data stored in the stochastic associative memory, and select a first one of the clusters corresponding to a first one of the centroids that is closest to the hash code, a cluster threshold controller to determine whether a selected first number of hash codes stored in the stochastic associative memory exceeds a threshold, in response to the selected first number of hash codes exceeding the threshold query a memory controller for sizes of the clusters, and determine, based on the query, that a second one of the clusters includes an unbalanced size, and wherein the hash code comparison manager is to select a third one of the clusters to associate with a second number of hash codes corresponding to the second one of the clusters.

In Example 116, the subject matter of Example 115 can optionally include an interface to obtain a first database vector corresponding to the input data, and a transform generator to transform the first database vector into a first binary vector using a sparse projection matrix stored in the stochastic associative memory, and store the first binary vector in the stochastic associative memory in a row-wise manner.

In Example 117, the subject matter of Examples 115-116 can optionally include wherein the transform generator is to in response to receiving a database update vector corresponding to additional input data for updating the stochastic associative memory transform the database update vector into a second binary vector using the sparse projection matrix, and store the second binary vector in the stochastic associative memory in a column-wise manner.

In Example 118, the subject matter of Examples 115-117 can optionally include a transpose generator to transpose the first binary vector into a transposed binary vector.

In Example 119, the subject matter of Examples 115-118 can optionally include wherein the transform generator is to store the transposed binary vector in the memory in a column-wise manner.

In Example 120, the subject matter of Examples 115-119 can optionally include wherein the transform generator it to use random sparse lifting to transform the first database vector into the first binary vector.

In Example 121, the subject matter of Examples 115-120 can optionally include wherein the cluster threshold controller is to determine a balanced size of the clusters of data stored in the stochastic associative memory, the balanced size indicative of a balanced number of hash codes per cluster of data stored in the stochastic associative memory, and determine a selected second number of hash codes to be re-associated to a different cluster than the first cluster based on a difference between a total number of hash codes associated with the second one of the clusters and the balanced size of the clusters of data stored in the stochastic associative memory, the selected second number of hash codes indicative of a number of the second hash codes.

In Example 122, the subject matter of Examples 115-121 can optionally include wherein the hash code comparison manager is to cause the memory controller to compare hash codes associated with the second one of the clusters of data to a second one of the centroids of the second one of the clusters of data.

In Example 123, the subject matter of Examples 115-122 can optionally include wherein the cluster threshold controller is to determine values of a selected second number of hash codes corresponding to the second one of the clusters of data that include a farthest distance from the second one of the centroids of the second one of the clusters of data, wherein the values of the selected second number of hash codes having the farthest distance from the second one of the centroids of the second one of the clusters are to be associated with the third one of the clusters of data to re-balance the second one of the clusters of data.

In Example 124, the subject matter of Examples 115-123 can optionally include an aggregation manager to associate the hash code with the first one of the clusters.

In Example 125, the subject matter of Examples 115-124 can optionally include wherein the aggregation manager is to apply an aggregation operator to the hash code and hash codes of the data associated with the first one of the clusters, the aggregation operator including at least one of mean, medium, or center of mass of the hash code and the hash codes of data associated with the first one of the clusters.

In Example 126. the subject matter of Examples 115-125 can optionally include wherein the hash code comparison manager is to transmit the hash code to the memory controller to cause the memory controller to determine distances between the hash code and the centroids of the clusters of the data stored in the stochastic associative memory.

In Example 127, the subject matter of Examples 115-126 can optionally include wherein the centroids correspond to hash codes representative of the clusters.

Example 128 includes a non-transitory computer readable medium comprising instructions that, when executed, cause at least one processor generate a hash code for input data to be stored in a stochastic associative memory, the stochastic associative memory including one or more database vectors, compare the hash code with centroids of clusters of data stored in the stochastic associative memory, select a first one of the clusters corresponding to a first one of the centroids that is closest to the hash code, determine whether a selected first number of hash codes stored in the stochastic associative memory exceeds a threshold, in response to the selected first number of hash codes exceeding the threshold query a memory controller for sizes of the clusters, and determine, based on the query, that a second one of the clusters includes an unbalanced size, and select a third one of the clusters to associate with a second number of hash codes corresponding to the second one of the clusters.

In Example 129, the subject matter of Example 128 can optionally include wherein the instructions cause the at least one processor to obtain a first database vector corresponding to the input data, transform the first database vector into a first binary vector using a sparse projection matrix stored in the stochastic associative memory, and store the first binary vector in the stochastic associative memory in a row-wise manner.

In Example 130, the subject matter of Examples 128-129 can optionally include wherein the instructions cause the at least one processor to in response to receiving a database update vector corresponding to additional input data for updating the stochastic associative memory transform the database update vector into a second binary vector using the sparse projection matrix, and store the second binary vector in the stochastic associative memory in a column-wise manner.

In Example 131, the subject matter of Examples 128-130 can optionally include wherein the instructions cause the at least one processor to transpose the first binary vector into a transposed binary vector.

In Example 132, the subject matter of Examples 128-131 can optionally include wherein the instructions cause the at least one processor to store the transposed binary vector in the memory in a column-wise manner.

In Example 133, the subject matter of Examples 128-132 can optionally include wherein the instructions cause the at least one processor to use random sparse lifting to transform the first database vector into the first binary vector.

In Example 134, the subject matter of Examples 128-133 can optionally include wherein the instructions cause the at least one processor to determine a balanced size of the clusters of data stored in the stochastic associative memory, the balanced size indicative of a balanced number of hash codes per cluster of data stored in the stochastic associative memory, and determine a selected second number of hash codes to be re-associated to a different cluster than the first cluster based on a difference between a total number of hash codes associated with the second one of the clusters and the balanced size of the clusters of data stored in the stochastic associative memory, the selected second number of hash codes indicative of a number of the second hash codes.

In Example 135, the subject matter of Examples 128-134 can optionally include wherein the instructions cause the at least one processor to cause the memory controller to compare hash codes associated with the second one of the clusters of data to a second one of the centroids of the second one of the clusters of data.

In Example 136, the subject matter of Examples 128-135 can optionally include wherein the instructions cause the at least one processor to determine values of a selected second number of hash codes corresponding to the second one of the clusters of data that include a farthest distance from the second one of the centroids of the second one of the clusters of data, wherein the values of the selected second number of hash codes having the farthest distance from the second one of the centroids of the second one of the clusters are to be associated with the third one of the clusters of data to re-balance the second one of the clusters of data.

In Example 137, the subject matter of Examples 128-136 can optionally include wherein the instructions cause the at least one processor to associate the hash code with the first one of the clusters.

In Example 138, the subject matter of Examples 128-137 can optionally include wherein the instructions cause the at least one processor to apply an aggregation operator to the hash code and hash codes of the data associated with the first one of the clusters, the aggregation operator including at least one of mean, medium, or center of mass of the hash code and the hash codes of data associated with the first one of the clusters.

In Example 139, the subject matter of Examples 128-138 can optionally include wherein the instructions cause the at least one processor to transmit the hash code to the memory controller to cause the memory controller to determine distances between the hash code and the centroids of the clusters of the data stored in the stochastic associative memory.

In Example 140, the subject matter of Examples 128-139 can optionally include wherein the centroids correspond to hash codes representative of the clusters.

Example 141 is an edge computing gateway, comprising processing circuitry to perform any of Examples 115-127.

Example 142 is a base station, comprising a network interface card and processing circuitry to perform any of Examples 115-127.

Example 143 is a computer-readable medium comprising instructions to perform any of Examples 115-127.

Example 144 is an edge computing gateway, comprising processing circuitry to perform any of Examples 128-140.

Example 145 is a base station, comprising a network interface card and processing circuitry to perform any of Examples 128-140.

Example 146 is a computer-readable medium comprising instructions to perform any of Examples 128-140.

The following claims are hereby incorporated into this Detailed Description by this reference, with each claim standing on its own as a separate embodiment of the present disclosure.

1. An apparatus to improve computational operations of a stochastic associative memory, the apparatus comprising:
at least one non-transitory computer readable medium;
machine readable instructions; and
processor circuitry to execute the machine readable instructions to at least:
generate a hash code for input data to be stored in the stochastic associative memory, the stochastic associative memory including one or more database vectors;
compare the hash code with centroids of clusters of data stored in the stochastic associative memory;
select a first one of the clusters corresponding to a first one of the centroids that is closest to the hash code;
determine whether a selected first number of hash codes stored in the stochastic associative memory exceeds a threshold;
based on the selected first number of hash codes exceeding the threshold:
query a memory controller for sizes of the clusters; and
determine, based on the query, that a second one of the clusters includes an unbalanced size; and
select a third one of the clusters to associate with a second number of hash codes corresponding to the second one of the clusters.

2. The apparatus of claim 1, wherein the processor circuitry is to:
transform a first database vector into a first binary vector using a sparse projection matrix stored in the stochastic associative memory, the first database vector corresponding to the input data; and
cause storage of the first binary vector in the stochastic associative memory in a row-wise manner.

3. The apparatus of claim 2, wherein the processor circuitry is to, based on receiving a database update vector corresponding to additional input data for updating the stochastic associative memory:
transform the database update vector into a second binary vector using the sparse projection matrix; and
cause storage of the second binary vector in the stochastic associative memory in a column-wise manner.

4. The apparatus of claim 2, wherein the processor circuitry is to transpose the first binary vector into a transposed binary vector.

5. The apparatus of claim 4, wherein the processor circuitry is to cause storage of the transposed binary vector in the stochastic associative memory in a column-wise manner.

6. The apparatus of claim 2, wherein the processor circuitry is to use random sparse lifting to transform the first database vector into the first binary vector.

7. The apparatus of claim 1, wherein the processor circuitry is to:
determine a balanced size of the clusters of data stored in the stochastic associative memory, the balanced size indicative of a balanced number of hash codes per cluster of data stored in the stochastic associative memory; and
determine a selected second number of hash codes to be re-associated to a different cluster than the first one of the clusters based on a difference between a total number of hash codes associated with the second one of the clusters and the balanced size of the clusters of data stored in the stochastic associative memory, the selected second number of hash codes indicative of a number of the second hash codes.

8. The apparatus of claim 1, wherein the processor circuitry is to cause the memory controller to compare hash codes associated with the second one of the clusters of data to a second one of the centroids of the second one of the clusters of data.

9. The apparatus of claim 8, wherein:
the processor circuitry is to determine values of a selected second number of hash codes corresponding to the second one of the clusters of data that include a farthest distance from the second one of the centroids of the second one of the clusters of data and
the values of the selected second number of hash codes having the farthest distance from the second one of the centroids of the second one of the clusters are to be associated with the third one of the clusters of data to re-balance the second one of the clusters of data.

10. The apparatus of claim 1, wherein the processor circuitry is to associate the hash code with the first one of the clusters.

11. The apparatus of claim 10, wherein the processor circuitry is to apply an aggregation operator to the hash code and hash codes of the data associated with the first one of the clusters, the aggregation operator including at least one of mean, medium, or center of mass of the hash code and the hash codes of data associated with the first one of the clusters.

12. The apparatus of claim 1, wherein the processor circuitry is to cause transmission of the hash code to the memory controller to cause the memory controller to determine distances between the hash code and the centroids of the clusters of data stored in the stochastic associative memory.

13. The apparatus of claim 1, wherein the centroids correspond to hash codes representative of the clusters.

14. A non-transitory computer readable medium comprising instructions that, when executed, cause at least one processor:
generate a hash code for input data to be stored in a stochastic associative memory, the stochastic associative memory including one or more database vectors;
compare the hash code with centroids of clusters of data stored in the stochastic associative memory;
select a first one of the clusters corresponding to a first one of the centroids that is closest to the hash code;
determine whether a selected first number of hash codes stored in the stochastic associative memory exceeds a threshold;
based on the selected first number of hash codes exceeding the threshold:
query a memory controller for sizes of the clusters; and
determine, based on the query, that a second one of the clusters includes an unbalanced size; and
select a third one of the clusters to associate with a second number of hash codes corresponding to the second one of the clusters.

15. The non-transitory computer readable medium of claim 14, wherein the instructions cause the at least one processor to:
transform a first database vector into a first binary vector using a sparse projection matrix stored in the stochastic associative memory, the first database vector corresponding to the input data; and
cause storage of the first binary vector in the stochastic associative memory in a row-wise manner.

16. The non-transitory computer readable medium of claim 15, wherein the instructions cause the at least one processor to, based on receiving a database update vector corresponding to additional input data for updating the stochastic associative memory:
transform the database update vector into a second binary vector using the sparse projection matrix; and
cause storage of the second binary vector in the stochastic associative memory in a column-wise manner.

17. The non-transitory computer readable medium of claim 15, wherein the instructions cause the at least one processor to transpose the first binary vector into a transposed binary vector.

18. The non-transitory computer readable medium of claim 17, wherein the instructions cause the at least one processor to cause storage of the transposed binary vector in the stochastic associative memory in a column-wise manner.

19. The non-transitory computer readable medium of claim 15, wherein the instructions cause the at least one processor to use random sparse lifting to transform the first database vector into the first binary vector.

20. The non-transitory computer readable medium of claim 14, wherein the instructions cause the at least one processor to:
determine a balanced size of the clusters of data stored in the stochastic associative memory, the balanced size indicative of a balanced number of hash codes per cluster of data stored in the stochastic associative memory; and
determine a selected second number of hash codes to be re-associated to a different cluster than the first one of the clusters based on a difference between a total number of hash codes associated with the second one of the clusters and the balanced size of the clusters of data stored in the stochastic associative memory, the selected second number of hash codes indicative of a number of the second hash codes.

21. The non-transitory computer readable medium of claim 14, wherein the instructions cause the at least one processor to cause the memory controller to compare hash codes associated with the second one of the clusters of data to a second one of the centroids of the second one of the clusters of data.

22. The non-transitory computer readable medium of claim 21, wherein:
the instructions cause the at least one processor to determine values of a selected second number of hash codes corresponding to the second one of the clusters of data that include a farthest distance from the second one of the centroids of the second one of the clusters of data; and
the values of the selected second number of hash codes having the farthest distance from the second one of the centroids of the second one of the clusters are to be associated with the third one of the clusters of data to re-balance the second one of the clusters of data.

23. The non-transitory computer readable medium of claim 14, wherein the instructions cause the at least one processor to associate the hash code with the first one of the clusters.

24. The non-transitory computer readable medium of claim 23, wherein the instructions cause the at least one processor to apply an aggregation operator to the hash code and hash codes of the data associated with the first one of the clusters, the aggregation operator including at least one of mean, medium, or center of mass of the hash code and the hash codes of data associated with the first one of the clusters.

25. The non-transitory computer readable medium of claim 14, wherein the instructions cause the at least one processor to cause transmission of the hash code to the memory controller to cause the memory controller to determine distances between the hash code and the centroids of the clusters of data stored in the stochastic associative memory.

26. The non-transitory computer readable medium of claim 14, wherein the centroids correspond to hash codes representative of the clusters.
